(19) United States
(12) Patent Application Publication
(10) Pub. No.: US 2026/0225070 A1
(43) Pub. Date: Aug. 6, 2026

(54) HIGHLY POROUS POLYMER NANOFILMS

(71) Applicant: MASSACHUSETTS INSTITUTE OF TECHNOLOGY, Cambridge, MA (US)

(72) Inventors: Zachary Smith, Belmont, MA (US); Taehoon Lee, Cambridge, MA (US)

(73) Assignee: MASSACHUSETTS INSTITUTE OF TECHNOLOGY, Cambridge, MA (US)

(21) Appl. No.: 19/152,211

(22) PCT Filed: Jan. 30, 2024
(86) PCT No.: PCT/US2024/013607

§ 371 Date: Jul. 30, 2025

Related U.S. Application Data
(60) Provisional application No. 63/482,454, filed on Jan. 31, 2023.

(51) Int. Cl. B01J 20/26; B01D 61/02; B01D 69/12; B01D 71/56; B01J 20/28; B01J 20/30; C08G 69/28; C08G 69/32

(52) U.S. Cl. CPC B01J 20/262; B01D 61/025; B01D 61/027; B01D 69/1251; B01D 71/56; B01J 20/28033; B01J 20/28061; B01J 20/3085; C08G 69/28; C08G 69/32

(57) ABSTRACT

According to certain embodiments, a composition comprising a polymer of intrinsic microporosity (PIM) is described. In some embodiments, the PIM comprises a polyamide comprising a first micropore-generating moiety (e.g., a spirobifluorene moiety) crosslinked with at least one second micropore-generating moiety (e.g., a Tröger's base moiety) via an amide bond. The first moiety and the second moiety may be substantially rigid such that neither moiety contains any carbon-carbon or carbon-heteroatom single bonds. The resulting rigid polyamides formed from the micropore-generating units have advantageous properties, including, for example, sufficiently small pore sizes, large fractional free volumes, and high surface areas. Furthermore, the pore sizes, fractional free volumes, and surface areas of the polyamides may advantageously be tuned depending on the choice of the first moiety and the second moiety.

### RELATED APPLICATIONS

This application claims priority under 35 U.S.C. § 119(e) to U.S. Provisional Patent Application No. 63/482,454, filed Jan. 31, 2023, and entitled “Highly Microporous Polymer Nanofilms by Interfacial Polymerization of Rigid Units for Ultrafast Organic Solvent Nanofiltration,” which is incorporated herein by reference in its entirety for all purposes.

### TECHNICAL FIELD

Compositions, articles, and methods related to polymers of intrinsic microporosity (PIMs) are described herein.

### BACKGROUND

Many conventional separation and purification processes in the oil and gas, chemical, and pharmaceutical industries utilize large amounts of organic solvents and entail high energy consumption. Such processes could be replaced by membrane technologies, with an order of magnitude lower energy consumption. For example, membranes for organic solvent nanofiltration (OSN), which can efficiently separate molecules of 200-1000 g/mol from organic solvents, have great potential for solvent recovery, separation of crude-oil mixtures, fractionation, separation of catalysts, and the purification of active pharmaceutical ingredients (APIs). To process large solvent volumes with a viable area and in a viable timeframe, membranes need to be both chemically resistant to the solvents involved and provide high flux. One strategy being followed to this end is to design the polymer structure at the molecular level to provide greater interconnected microporosity, and another approach is to reduce the thickness of the separating layer to the nanometer scale.

Polymers of intrinsic microporosity (PIMs) are an emerging group of solution-processible amorphous microporous materials (pore size <2 nm, by the International Union of Pure and Applied Chemistry (IUPAC) definition) gaining significant attention in membrane-based separations due to their ability to transcend the conventional permeability/selectivity trade-off relationships. Such materials exhibit exceptionally high free volumes induced by bulky functional groups with a site of contortion, high rigidity, and internal free volumes that disrupt efficient packing in polymer chains or provide additional free volume elements. Representative PIM units include spirobisindane, spirobifluorene, ethanoanthracene, methanopentacene, Tröger's base, and triptycene.

To date, technical challenges associated with fabricating defect-free, inexpensive, thin-film composite (TFC) membranes as well as stability issues have severely limited the industrial use of PIM-based membrane materials. For example, their solubility in common solvents restricts their applications in OSN applications. In addition, it has been shown that decreasing the thickness of solution-cast films of the polymer PIM-1 below 100 nm unexpectedly resulted in a decrease, rather than an increase, in heptane permeance, which was attributed to structural relaxation of the polymer molecules in the thin films. This effect has also been observed in gas separation (i.e., physical aging), and suggests that linear macromolecules may not be suitable for ultrathin nanofilms.

Alternatively, thin-film fabrication using in-situ interfacial polymerization (IP) offers a promising method to produce highly crosslinked (i.e., solvent-resistant), reproducible, ultrathin PIM-derived membranes employing an industrially scalable, low-cost, roll-to-roll process. It has been demonstrated that IP-based ultrathin (<50 nm) polyarylate TFCs can be successfully produced from PIM-motifs, e.g., spirobisindane-derived biscatechol sodium salts reacted with trimesoyl chloride (TMC) proposed for use in OSN. Compared to the conventional m-phenylenediamine (MPD)-TMC polyamide TFC membranes, the resulting membranes demonstrated improved organic solvent permeances (e.g., acetone permeance=~8 LMH/bar) due to their microporous texture with a moderate molecular weight cutoff (MWCO) (~400 g/mol). This result suggests that the reaction between rigid units would result in highly microporous and permeable polyamide TFC membranes. However, further enhancements in solvent permeance have been limited by the relatively low microporosity (surface area <100 m²/g) resulting from intermolecular hydrogen bonding between amide bonds.

### SUMMARY

Compositions, articles, and methods related to polymers of intrinsic microporosity (PIMs) are described herein. The subject matter of the present invention involves, in some cases, interrelated products, alternative solutions to a particular problem, and/or a plurality of different uses of one or more systems and/or articles.

This Summary introduces a selection of concepts in simplified form that are described further below in the Detailed Description. This Summary neither identifies key or essential features, nor limits the scope, of the claimed subject matter.

According to certain embodiments, a composition is described. In some embodiments, the composition comprises a PIM, wherein the PIM comprises a polyamide comprising: (i) a first moiety comprising a spiro group; and (ii) a second moiety comprising a Tröger's base moiety.

In some embodiments, a composition comprises a PIM, wherein the PIM comprises a polyamide comprising: (i) a first moiety comprising a spirobifluorene moiety and/or a spirobisindane moiety; and (ii) a plurality of second moieties, wherein the first moiety comprises more than one functional group, and wherein each functional group of the first moiety is crosslinked with a functional group of the second moiety such that the first moiety and each of the second moieties are crosslinked via an amide group.

According to some embodiments, a method is described. In certain embodiments, the method comprises: (i) passing a mixture of species through a membrane and/or filter, wherein the membrane and/or filter comprises a polymer comprising a first moiety and a second moiety crosslinked via an amide bond, wherein the first moiety comprises a spiro group and the second moiety comprises a Tröger's base moiety; and (ii) separating at least one species from the mixture of species.

One aspect of the disclosure herein is a composition comprising PIMs, wherein the PIMs comprise covalent linkages of a Tröger's base diamine (TBD) and a spirobifluorene acyl chloride (SBF-COCl):

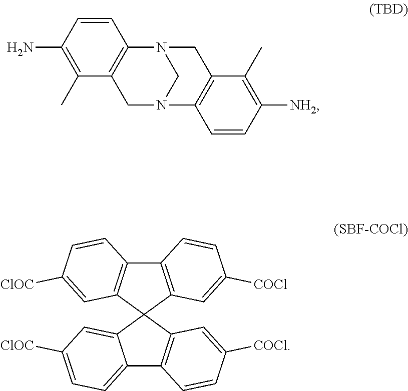

One aspect of the disclosure herein is a membrane comprising PIMs, wherein the PIMs comprise covalent linkages between a TBD and a SBF-COCl:

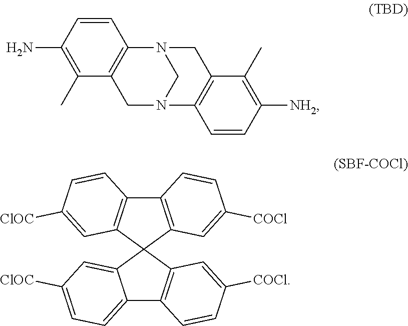

In one embodiment, the disclosed membrane further comprises a porous solid support.

In one embodiment of the disclosed membrane, the porous solid support is a porous polyacrylonitrile (PAN) support. In one embodiment, the PAN support has a pore size of 10 to 100 nm.

In one embodiment of the disclosed membrane, the ratio of TBD:SBF is 2:1 to 1:1.

In one embodiment, the disclosed membrane further comprises crosslinking between TBD and SBF, thereby providing a polyamide of the form:

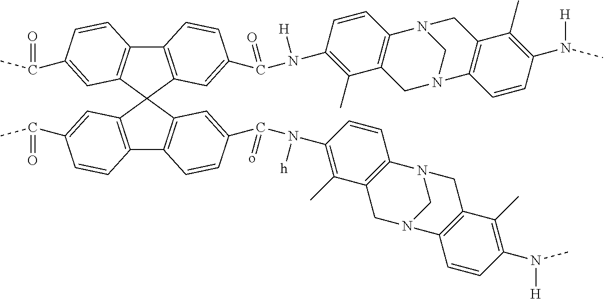

In one embodiment, the extent of the crosslinking between TBD and SBF is sufficient to limit or eliminate physical aging.

In one embodiment of the disclosed membrane, the membrane is solvent resistant. In one embodiment, the membrane is resistant to organic solvents.

In one embodiment of the disclosed membrane, the membrane has a thickness greater than 50 nm, greater than 100 nm, greater than 150 nm, greater than 250 nm, or greater than 500 nm.

In one embodiment of the disclosed membrane, the membrane has a high flux permeance at 20 bar and room temperature.

In one embodiment of the disclosed membrane, the membrane has an acetone permeance of ~100 LMH/bar.

In one embodiment of the disclosed membrane, the membrane has a toluene permeance of ~21 LMH/bar.

In one embodiment of the disclosed membrane, the membrane has a molecular weight cutoff in acetone of less than 100 g/mol, less than 200 g/mol, less than 300 g/mol, less than 500 g/mol, or less than 1000 g/mol.

In one embodiment of the disclosed membrane, the membrane has a porosity of less than 1 nm, less than 2 nm, less than 4 nm, or less than 10 nm.

In one embodiment of the disclosed membrane, the membrane is microporous (pore size <2 nm, by IUPAC definition).

One aspect of the disclosed membrane is a use for organic solvent nanofiltration (OSN).

One aspect of the disclosed membrane is a use in efficiently separating molecules of 200-1000 g/mol from an organic solvent.

One aspect of the disclosed membrane is a use in solvent recovery, separation of crude-oil mixtures, fractionation of molecules, separation of catalysts, and/or the purification of active pharmaceutical ingredients (APIs).

One aspect of the disclosure is a method of synthesis comprising:
(a) providing a TBD and SBF-COCl; and

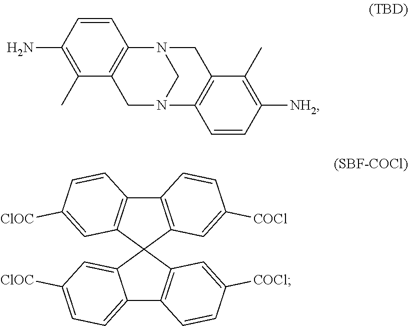

and
(b) performing thin-film fabrication using in-situ interfacial polymerization, whereby PIMs are produced.

In one embodiment, the disclosed method further comprises derivatizing free carboxyl groups of the polymer to limit the number of free carboxylic acid units.

The following Detailed Description references the accompanying drawings which form a part this application, and which show, by way of illustration, specific example implementations. Other implementations may be made without departing from the scope of the disclosure. Other advantages and novel features of the present invention will become apparent from the following Detailed Description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A shows, in accordance with certain embodiments, a perspective view schematic diagram of an article comprising a membrane and/or filter, wherein the membrane and/or filter comprises a polymer of intrinsic microporosity (PIM).

FIG. 1B shows, in accordance with certain embodiments, a cross-sectional view schematic diagram of the article shown in FIG. 1A.

FIG. 2A shows, in accordance with certain embodiments, a perspective view schematic diagram of an article comprising a membrane and/or filter disposed on a substrate, wherein the membrane and/or filter comprises a PIM.

FIG. 2B shows, in accordance with certain embodiments, a cross-sectional view schematic diagram of the article shown in FIG. 2A.

FIGS. 3A-3C show, in accordance with certain embodiments, schematic diagrams representing a method of synthesizing a PIM.

FIGS. 4A-4B show, in accordance with certain embodiments, schematic diagrams representing a method of separating at least one species from a mixture of species using a membrane and/or filter.

FIGS. 5A-5B show, in accordance with certain embodiments, schematic diagrams representing a method of separating at least one species from a mixture of species using a membrane and/or filter disposed on a substrate.

FIG. 6 shows, in accordance with certain embodiments, a synthetic scheme for Tröger's base diamine (TBD).

FIG. 7 shows, in accordance with certain embodiments, a synthetic scheme for spirobifluorene acyl chloride (SBF-COCl).

FIG. 8A shows, in accordance with certain embodiments, Fourier-transform infrared (FT-IR) spectra of synthesized molecules 2-methyl-3-nitroaniline (2M3N), Tröger's base containing nitro groups (TBN), and TBD.

FIG. 8B shows, in accordance with certain embodiments, FT-IR spectra of synthesized spirobifluorene (SBF) molecules.

FIG. 9 shows, in accordance with certain embodiments, exemplary chemical structures of monomers used for interfacial polymerization (IP).

FIG. 10A shows, in accordance with certain embodiments, a scanning electron microscopy (SEM) surface image of a polyacrylonitrile (PAN) support (scale bar=0.4 micrometers).

FIG. 10B shows, in accordance with certain embodiments, a SEM surface image of a m-phenylenediamine (MPD)-trimesoyl chloride (TMC) membrane formed onto a PAN support (scale bar=1 micrometer).

FIG. 10C shows, in accordance with certain embodiments, a SEM surface image of a TBD-TMC membrane formed onto a PAN support (scale bar=1 micrometer).

FIG. 10D shows, in accordance with certain embodiments, a SEM surface image of a MPD-SBF membrane formed onto a PAN support (scale bar=1 micrometer).

FIG. 10E shows, in accordance with certain embodiments, a SEM surface image of a TBD-SBF membrane formed onto a PAN support (scale bar=0.4 micrometers).

FIG. 11 shows, in accordance with certain embodiments, X-ray diffraction (XRD) patterns of TBD-SBF, TBD-TMC, MPD-SBF, and MPD-TMC bulk powders with average d-spacing calculated from Bragg's law.

FIG. 12A shows, in accordance with certain embodiments, pure solvent permeance depending on combined parameters (δₚηdₘ, δₚ: solubility parameter (polar), η: viscosity, and dₘ: molar diameter).

FIG. 12B shows, in accordance with certain embodiments, dye rejection of MPD-TMC, MPD-SBF, TBD-TMC, and TBD-SBF membranes versus the molecular weight of the dyes chrysoidine G (CG, 248 g/mol), methyl orange (MO, 327 g/mol), acid fuchsin (AF, 586 g/mol), and brilliant blue R (BB, 826 g/mol) (see also FIG. 44).

FIG. 13 shows, in accordance with certain embodiments, acetone permeance versus molecular weight cutoff (MWCO) of general solutes in acetone for thin-film composite (TFC) membranes described herein as compared to previously reported organic solvent nanofiltration (OSN) membranes (see also FIG. 45).

FIG. 14 shows, in accordance with certain embodiments, chemical structures of organic phase monomers TMC and SBF (top), chemical structures of aqueous phase monomers MPD, PPD, PIP, and TBD (bottom), and chemical structures of polyamides MPD-TMC and TBD-SBF and a schematic diagram representing the interfacial polymerization of polyamide nanofilms (center).

FIG. 15A shows, in accordance with certain embodiments, simulated energy-minimized 3D amorphous cells of MPD and TBD-based polyamides, wherein light gray represents the polymer chains, dark grey represents the accessible free volume at a probe radius of 1 Å, and black represents the periodic cell (cell size: 35 Å×35 Å×35 Å).

FIG. 15B shows, in accordance with certain embodiments, degree of torsional freedom calculated about the spiro, amide, and TB bonds in the repeat units of TBD-SBF shown in FIG. 14.

FIG. 15C shows, in accordance with certain embodiments, CO₂ adsorption-desorption isotherms of polyamide powders at 273 K up to 1 bar.

FIG. 15D shows, in accordance with certain embodiments, isosteric heat of adsorption for polyamides obtained from CO₂ sorption isotherms at 273 and 298 K (see also FIG. 31).

FIG. 15E shows, in accordance with certain embodiments, the CO₂ sorption capacity at 273 K and 1 bar and the surface area of polyamide powders described herein as compared to previously reported polymers prepared by interfacial polymerization.

FIG. 16A shows, in accordance with certain embodiments, a cross-sectional SEM image of TBD-SBF formed onto a PAN support (scale bar=0.1 micrometer).

FIG. 16B shows, in accordance with certain embodiments, a freestanding TBD-SBF nanofilm captured by a wire loop (scale bar=1 cm).

FIG. 16C shows, in accordance with certain embodiments, an atomic force microscopy (AFM) height image of a TBD-SBF nanofilm transferred onto a silicon wafer (scale bar=0.4 micrometers).

FIG. 16D shows, in accordance with certain embodiments, the height profile corresponding to the dashed square in FIG. 16C.

FIG. 16E shows, in accordance with certain embodiments, C 1s and N 1s X-ray photoelectron spectra (XPS) of a TBD-SBF membrane.

FIG. 16F shows, in accordance with certain embodiments, permeance enhancement of TFC membranes relative to a MPD-TMC membrane depending on the molar diameter of solvents.

FIG. 16G shows, in accordance with certain embodiments, methanol permeance of TFC membranes described herein versus the reciprocal membrane thickness as compared to previously reported interfacially polymerized TFC membranes.

FIG. 16H shows, in accordance with certain embodiments, UV-vis absorption spectra of a feed solution containing mixed dyes in acetone and the permeate obtained by filtration experiment through a TBD-SBF membrane.

FIG. 17A shows, in accordance with certain embodiments, simulated energy-minimized 3D amorphous cells of PPD and PIP-based polyamides, wherein light grey represents the polymer chains, dark grey represents the accessible free volume at a probe radius of 1 Å, and black represents the periodic cell (cell size: 35 Å×35 Å×35 Å).

FIG. 17B shows, in accordance with certain embodiments, changes in d-spacing (Δd-spacing) and surface area enhancement (ΔSurface area) by replacing TMC with SBF in polyamides.

FIG. 17C shows, in accordance with certain embodiments, a SEM surface image of a PPD-SBF membrane formed onto a PAN support (scale bar=1 micrometer)

FIG. 17D shows, in accordance with certain embodiments, an AFM image of a PPD-SBF membrane formed onto a PAN support (scale bar=0.2 micrometers)

FIG. 17E shows, in accordance with certain embodiments, a cross-sectional SEM image of a PPD-SBF membrane formed onto a PAN support (scale bar=0.2 micrometers).

FIG. 17F shows, in accordance with certain embodiments, solvent permeance of PPD-TMC and PPD-SBF membranes against the reciprocal solvent viscosity.

FIG. 17G shows, in accordance with certain embodiments, rejection behavior of PPD-TMC and PPD-SBF membranes versus the molecular weight of solutes.

FIG. 18 shows, in accordance with certain embodiments, a trade-off plot for the separation of toluene and 1,3,5-triisopropylbenzene (TIPB) of the membranes described herein compared to previously reported membranes (see also FIG. 71).

FIG. 19 shows, in accordance with certain embodiments, a photograph of an aqueous TBD solution (2 w/v %, pH=~2.3).

FIG. 20 shows, in accordance with certain embodiments, XPS spectra of SBF molecules with different functional groups.

FIG. 21 shows, in accordance with certain embodiments, elemental compositions of SBF molecules with different functional groups determined by the XPS spectra in FIG. 20.

FIGS. 22A-22D show, in accordance with certain embodiments, molecular structures of polyamides.

FIG. 23 shows, in accordance with certain embodiments, simulated structural properties of polyamides.

FIG. 24 shows, in accordance with certain embodiments, simulated pore size distributions of polyamides.

FIGS. 25A-25D show, in accordance with certain embodiments, SEM images of MPD-TMC powders, MPD-SBF powders, TBD-TMC powders, and TBD-SBF powders, respectively (scale bar=10 micrometers).

FIG. 26 shows, in accordance with certain embodiments, XPS spectra of MPD-TMC powders, MPD-SBF powders, TBD-TMC powders, and TBD-SBF powders.

FIG. 27 shows, in accordance with certain embodiments, elemental compositions of the polyamide powders determined by the XPS spectra in FIG. 26.

FIG. 28 shows, in accordance with certain embodiments, thermogravimetric analysis (TGA) curves of TBD-TMC, TBD-SBF, MPD-TMC, and MPD-SBF polyamide powders.

FIG. 29 shows, in accordance with certain embodiments, chemical compositions and XRD peaks of polyamides determined by experimental and simulation studies.

FIG. 30 shows, in accordance with certain embodiments, Langmuir surface areas of TBD-TMC, TBD-SB, MPD-TMC, and MPD-SBF polyamides calculated from CO₂ adsorption isotherms at 273 K.

FIG. 31 shows, in accordance with certain embodiments, CO₂ adsorption-desorption isotherms at 298 K up to 1 bar of TBD-TMC, TBD-SBF, MPD-TMC, and MPD-SBF polyamide powders.

FIG. 32 shows, in accordance with certain embodiments, CO₂ sorption capacity at 1 bar and 273 K and the surface area calculated from the corresponding CO₂ sorption isotherms for the membranes described herein as compared to previously reported membranes.

FIGS. 33A-33D show, in accordance with certain embodiments, AFM images of a MPD-TMC membrane formed onto a PAN support, a MPD-SBF membrane formed onto a PAN support, a TBD-TMC membrane formed onto a PAN support, and a TBD-SBF membrane formed onto a PAN support, respectively (scale bar=0.2 micrometers), wherein Rₐ and SAD represent the average roughness and the surface area difference, respectively.

FIGS. 34A-34D show, in accordance with certain embodiments, cross-sectional SEM images of a MPD-TMC membrane formed onto a PAN support, a MPD-SBF membrane formed onto a PAN support, a TBD-TMC membrane formed onto a PAN support, and a TBD-SBF membrane formed onto a PAN support, respectively (scale bar=0.1 micrometers).

FIGS. 35-36 show, in accordance with certain embodiments, calibration curves for MPD and TBD monomers in hexane and toluene, respectively.

FIGS. 37A-37B show, in accordance with certain embodiments, diffusion behavior of MPD monomers and TBD monomers, respectively, into organic solvents.

FIG. 38 shows, in accordance with certain embodiments, XPS spectra of polyamide TFC membranes.

FIG. 39 shows, in accordance with certain embodiments, elemental compositions of polyamide TFC membranes determined by the XPS spectra in FIG. 38.

FIG. 40 shows, in accordance with certain embodiments, physical properties of solvents.

FIGS. 41A-41D show, in accordance with certain embodiments, solvent permeance of a MPD-TMC membrane, a MPD-SBF membrane, a TBD-TMC membrane, and a TBD-SBF membrane, respectively, against the combined parameters (viscosity, molar diameter, and solubility).

FIGS. 42A-42B show, in accordance with certain embodiments, solvent permeance of a TBD-TMC membrane and a TBD-SBF membrane, respectively, against the reciprocal solvent viscosity.

FIG. 43 shows, in accordance with certain embodiments, methanol permeance and membrane thickness of TFC membranes described herein as compared to previously reported interfacially polymerized TFC membranes.

FIG. 44 shows, in accordance with certain embodiments, properties and structures of dyes used as a solute for organic solvent nanofiltration tests.

FIG. 45 shows, in accordance with certain embodiments, acetone permeance and MWCO of polymeric membranes described herein as compared to previously reported membranes.

FIG. 46 shows, in accordance with certain embodiments, acid fuchsin (AF, 586 g/mol) rejection of MPD-TMC and TBD-SBF membranes in various solvents.

FIG. 47 shows, in accordance with certain embodiments, acetone flux of a TBD-SBF membrane depending on applied pressures.

FIG. 48 shows, in accordance with certain embodiments, long-term stability of a TBD-SBF membrane at an applied pressure of 20 bar.

FIG. 49 shows, in accordance with certain embodiments, simulated structural properties of TMC-based and SBF-based polyamides.

FIGS. 50A-50C show, in accordance with certain embodiments, simulated pore size distributions of MPD-based polyamides, PPD-based polyamides, and PIP-based polyamides, respectively.

FIG. 51 shows, in accordance with certain embodiments, chemical compositions and XRD peaks of TMC-based and SBF-based polyamides determined by experimental and simulation studies.

FIGS. 52A-52F show, in accordance with certain embodiments, SEM images of MPD-TMC powders, MPD-SBF powders, PPD-TMC powders, PPD-SBF powders, PIP-TMC powders, and PIP-SBF powders, respectively (scale bar=10 micrometers).

FIG. 53 shows, in accordance with certain embodiments, XPS spectra of TMC-based and SBF-based polyamide powders.

FIG. 54 shows, in accordance with certain embodiments, elemental compositions of polyamide powders determined by the XPS spectra in FIG. 53.

FIG. 55 shows, in accordance with certain embodiments, TGA curves of TMC-based and SBF-based polyamide powders.

FIG. 56 shows, in accordance with certain embodiments, XRD spectra of TMC-based and SBF-based polyamide powders.

FIG. 57 shows, in accordance with certain embodiments, CO₂ adsorption-desorption isotherms of polyamide powders at 273 K up to 1 bar.

FIG. 58 shows, in accordance with certain embodiments, Langmuir surface area of TMC-based and SBF-based polyamides calculated from CO₂ adsorption isotherms at 273 K.

FIG. 59A shows, in accordance with certain embodiments, CO₂ adsorption-desorption isotherms of polyamide powders at 298 K up to 1 bar.

FIG. 59B shows, in accordance with certain embodiments, isosteric heat of sorption of TMC-based and SBF-based polyamide powders obtained from CO₂ sorption isotherms at 273 and 298 K.

FIGS. 60A-60F show, in accordance with certain embodiments, SEM surface images of a MPD-TMC membrane coated onto a PAN support, a MPD-SBF membrane coated onto a PAN support, a PPD-TMC membrane coated onto a PAN support, a PPD-SBF membrane coated onto a PAN support, a PIP-TMC membrane coated onto a PAN support, and a PIP-SBF membrane coated onto a PAN support, respectively (scale bar=1 micrometer).

FIGS. 61A-61F show, in accordance with certain embodiments, AFM images of MPD-TMC coated onto a PAN support, MPD-SBF coated onto a PAN support, PPD-TMC coated onto a PAN support, PPD-SBF coated onto a PAN support, PIP-TMC coated onto a PAN support, and PIP-SBF coated onto a PAN support, respectively (scale bar=0.2 micrometers), wherein Rₐ and SAD represent the average roughness and the surface area difference, respectively.

FIGS. 62A-62F show, in accordance with certain embodiments, cross-sectional SEM images of MPD-TMC coated onto a PAN support, MPD-SBF coated onto a PAN support, PPD-TMC coated onto a PAN support, PPD-SBF coated onto a PAN support, PIP-TMC coated onto a PAN support, and PIP-SBF coated onto a PAN support, respectively (scale bar=0.2 micrometers).

FIG. 63 shows, in accordance with certain embodiments, XPS spectra of TMC-based and SBF-based polyamide TFC membranes.

FIG. 64 shows, in accordance with certain embodiments, elemental compositions of TMC-based and SBF-based polyamide TFC membranes determined by the XPS spectra in FIG. 63.

FIGS. 65A-65B show, in accordance with certain embodiments, solvent permeance of a MPD-based polyamide TFC membrane and a PIP-based polyamide TFC membrane, respectively, against the reciprocal solvent viscosity.

FIGS. 66A-66B show, in accordance with certain embodiments, rejection behavior of a MPD-based polyamide TFC membrane and a PIP-based polyamide TFC membrane, respectively, versus molecular weight of solutes.

FIG. 67 shows, in accordance with certain embodiments, acetone permeance versus MWCO of solutes in acetone for TMC-based and SBF-based polyamide TFC membranes described herein as compared to previously reported polymeric membranes.

FIG. 68 shows, in accordance with certain embodiments, methyl orange (MO, 327 g/mol) rejection of MPD-TMC and PPD-SBF membranes in various solvents.

FIG. 69 shows, in accordance with certain embodiments, acetone flux of a PPD-SBF membrane depending on applied pressures.

FIG. 70 shows, in accordance with certain embodiments, long-term stability of a PPD-SBF membrane at an applied pressure of 20 bar.

FIG. 71 shows, in accordance with certain embodiments, toluene permeance and toluene/1,3,5-triisopropylbenzene (TIPB) separation factor of the membranes described herein as compared to previously reported membranes.

### DETAILED DESCRIPTION

According to certain embodiments, a composition comprising a polymer of intrinsic microporosity (PIM) is described. In some embodiments, the PIM comprises a polyamide comprising a first micropore-generating moiety (e.g., a spirobifluorene moiety) crosslinked with at least one second micropore-generating moiety (e.g., a Tröger's base moiety) via an amide bond. The first moiety and the second moiety may be substantially rigid such that neither moiety contains any carbon-carbon or carbon-heteroatom single bonds. The resulting rigid polyamides formed from the micropore-generating units have advantageous properties, including, for example, sufficiently small pore sizes, large fractional free volumes, and high surface areas. Furthermore, the pore sizes, fractional free volumes, and surface areas of the polyamides may advantageously be tuned depending on the choice of the first moiety and the second moiety.

In some embodiments, the polyamides may be formed by interfacial polymerization of a first monomer and a second monomer. In certain embodiments, the first monomer is soluble in an organic phase and the second monomer is soluble in an aqueous phase, thereby facilitating a dual-phase fabrication technique to provide the PIM. Conventional PIM units are generally hydrophobic and insoluble in water since they are mostly comprised of aromatic rings. In certain embodiments described herein, however, Tröger's base micropore-generating units that are soluble in water may be utilized in the interfacial polymerization method, thereby providing a scalable and straightforward synthetic route to PIMs with desirable properties that avoid the trade-off relationship between solvent permeance and solute rejection observed in conventional polymers formed by interfacial polymerization.

The polyamide may be formed as a thin-film composite (TFC) (e.g., a nanofilm) that may be used as a porous filter and/or membrane. The intrinsic microporosity of the polyamide may advantageously provide high organic solvent (e.g., toluene, methanol, and/or acetone) permeances and/or high solute (e.g., dye) rejection percentages, rendering the filter and/or membrane suitable for use in any of a variety of suitable applications, including, for example, organic solvent nanofiltration (OSN) and/or organic solvent reverse osmosis (OSRO).

As used herein, the term “polymer of intrinsic microporosity” is given its ordinary meaning in the art and refers to a polymer composed of a fully (or predominantly) fused-ring macromolecular chain that is fixed in a two-dimensional (2D) or three-dimensional (3D) random coil conformation due to sites of contortion (e.g., such as bridged bicyclic or spirocyclic units), so that they pack space inefficiently in the solid state.

In certain embodiments the PIM comprises a polyamide. As used herein, the term “polyamide” is given its ordinary meaning in the art and refers to a polymer in which a repeating unit in the polymer contains at least one amide bond. As used herein, the term “amide bond” is given its ordinary meaning in the art and refers to a functional group with the general formula R—C(═O)—NR^{I}R^{II}, wherein R, R^{I}, and R^{II} are the same or different and independently comprise an organic group and/or hydrogen. According to some embodiments, an amide bond is formed by a reaction between an acyl group-containing molecule and an amine group-containing molecule, as shown, for example, in Equation 1 (Eq. 1).

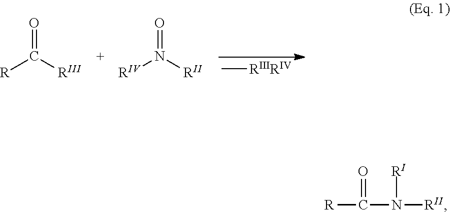

wherein:
R, R^{I}, and R_{II} are the same or different and independently comprise an organic group and/or hydrogen,
R^{III} comprises a hydroxy (—OH) group and/or a halogen group, and
R^{IV} comprises hydrogen.

According to certain embodiments, the polyamide comprises a first moiety and a second moiety. As described herein in greater detail, the first moiety may be bonded to the second moiety. In some embodiments, for example, the first moiety and the second moiety are crosslinked (e.g., via an amide bond). In certain embodiments, the first moiety comprises at least one functional group (e.g., an acyl group) that is crosslinked with a functional group of the second moiety (e.g., an amine group).

According to some embodiments, the first moiety is intrinsically microporous. For example, in some embodiments, the first moiety comprises one or more moieties that are micropore-generating units. In certain embodiments, the first moiety is substantially rigid. For example, in some embodiments, the first moiety comprises no carbon-carbon or carbon-heteroatom single bonds that are capable of free rotation. In certain embodiments, employing a first moiety that is intrinsically microporous and/or substantially rigid may advantageously provide a polyamide with intrinsic microporosity properties (e.g. small pore sizes, large fractional free volumes, high surface areas, etc.).

In some embodiments, the first moiety comprises a spiro group. As used herein, the term “spiro group” is given its ordinary meaning in the art and refers to a functional group comprising at least two molecular rings with only one common atom that offers at least one site of contortion. The spiro group may advantageously be a micropore-generating unit, in accordance with certain embodiments.

The first moiety may comprise any of a variety of suitable spiro group-containing moieties. In some embodiments, for example, the first moiety comprises a spirobifluorene moiety and/or an analogue or a derivative thereof. In certain embodiments, the first moiety comprises a spirobisindane moiety and/or an analogue or a derivative thereof. Other spiro group-containing moieties are also possible.

According to some embodiments, the first moiety comprises the structure shown in (1a):

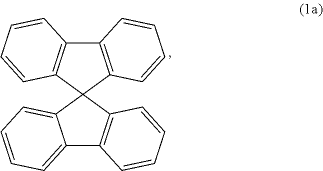 [SMILES: c1ccc2c(c1)-c1ccccc1C21c2ccccc2-c2ccccc21]

wherein at least one aromatic ring is functionalized with at least one functional group that is crosslinked with a functional group of a second moiety.

In some embodiments, one or more positions of one or more aromatic rings in (1a) are independently optionally substituted, for example, with a —C₁-C₁₀ alkyl group, a —C₂-C₁₀ alkenyl group, a —C₃-C₁₀ alkynyl group, an aryl group, a halogen (e.g., a fluorine (F) atom, a chlorine (Cl) atom, a bromine (Br) atom, or the like), an acyl group, an acyl halide, and/or combinations thereof.

According to certain embodiments wherein the first moiety comprises the structure shown in (1a), more than one aromatic ring may be functionalized with at least one functional group that is crosslinked with a functional group of a second moiety. In some embodiments, for example, the first moiety comprises the structure shown in (1a), and two aromatic rings are functionalized with at least one functional group, each functional group crosslinked with a functional group of a second moiety. In certain other embodiments, the first moiety comprises the structure shown in (1a), and three aromatic rings are functionalized with at least one functional group, each functional group crosslinked with a functional group of a second moiety. In yet some other embodiments, the first moiety comprises the structure shown in (1a), and all four aromatic rings are functionalized with at least one functional group, each functional group crosslinked with a functional group of a second moiety.

In certain embodiments, the first moiety comprises the structure shown in (1b):

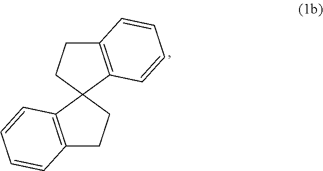 [SMILES: c1ccc2c(c1)CCC21CCc2ccccc21]

wherein at least one aromatic ring is functionalized with at least one functional group that is crosslinked with a functional group of a second moiety.

In some embodiments, one or more positions of one or more aromatic rings and/or one or more positions of one or more carbocyclic rings in (1b) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an acyl group, an acyl halide, and/or combinations thereof.

According to certain embodiments wherein the first moiety comprises the structure shown in (1b), more than one aromatic ring may be functionalized with at least one functional group that is crosslinked with a functional group of a second moiety. In some embodiments, for example, the first moiety comprises the structure shown in (1b), and both aromatic rings are functionalized with at least one functional group, each functional group crosslinked with a functional group of a second moiety.

In some embodiments, as described herein, the first moiety comprises at least one functional group. In certain embodiments, the at least one functional group of the first moiety is crosslinked with a functional group of a second moiety. The first moiety may comprise any of a variety of suitable functional groups. In some embodiments, for example, the at least one functional group of the first moiety is an acyl group. Other functional groups are also possible.

In certain embodiments, the first moiety comprises the structure shown in (2a):

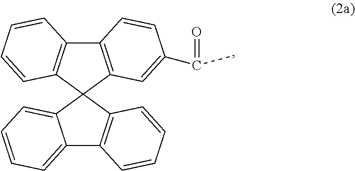

wherein the dotted line represents a crosslinking bond to a functional group of a second moiety.

In some embodiments, one or more positions of one or more aromatic rings in (2a) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an acyl group, an acyl halide, and/or combinations thereof.

According to some embodiments, the first moiety comprises the structure shown in (2b):

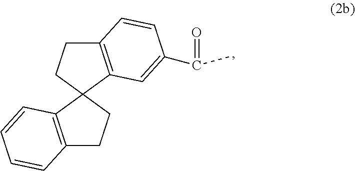

wherein the dotted line represents a crosslinking bond to a functional group of a second moiety.

In some embodiments, one or more positions of one or more aromatic rings and/or one or more positions of one or more carbocyclic rings in (2b) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an acyl group, an acyl halide, and/or combinations thereof.

In certain embodiments, as described herein, the first moiety comprises more than one functional group (e.g., two functional groups, three functional groups, four functional groups, etc.). According to some embodiments, each of the more than one functional group is crosslinked with a functional group of a second moiety. In some embodiments, for example, the first moiety comprises two functional groups, and each functional group is crosslinked with a functional group of a second moiety. In certain other embodiments, the first moiety comprises three functional groups, and each functional group is crosslinked with a functional group of a second moiety. In yet some other embodiments, the first moiety comprises four functional groups, and each functional group is crosslinked with a functional group of a second moiety.

According to some embodiments, the first moiety comprises the structure shown in (2c),

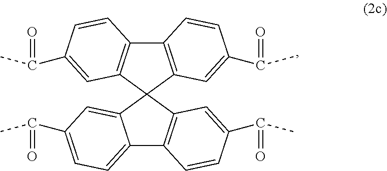

wherein each dotted line independently represents a crosslinking bond to a functional group of a second moiety or a bond to an atom or a functional group that is a terminal end of the PIM, provided that at least one dotted line is a crosslinking bond to a functional group of a second moiety.

In some embodiments, one or more positions of one or more aromatic rings in (2c) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), and/or combinations thereof.

In certain embodiments, the first moiety comprises the structure shown in (2d):

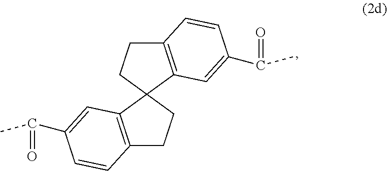

wherein each dotted line independently represents a crosslinking bond to a functional group of a second moiety or a bond to an atom or a functional group that is a terminal end of the PIM, provided that at least one dotted line is a crosslinking bond to a functional group of a second moiety.

In some embodiments, one or more positions of one or more aromatic rings and/or one or more positions of one or more carbocyclic rings in (2d) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), and/or combinations thereof.

In certain embodiments wherein a dotted line in (2c) and/or (2d) represents a bond to an atom or a functional group that is a terminal end of the PIM, the atom or the functional group that is the terminal end of the PIM may be any of a variety of suitable atoms and/or functional groups. In certain embodiments, for example, the atom that is the terminal end of the PIM is hydrogen or a halogen (e.g., a F atom, a Cl atom, a Br atom, or the like). In some embodiments, the functional group that is the terminal end of the PIM is a —C₁-C₁₀ alkyl group, a —C₂-C₁₀ alkenyl group, a —C₃-C₁₀ alkynyl group, or an aryl group. Other atoms and/or functional groups are also possible.

In accordance with certain embodiments, the first moiety may be chosen based upon the teachings of this specification to provide a polyamide with a desired pore size, fractional free volume, and/or surface area, depending on the particular application.

According to some embodiments, the second moiety is intrinsically microporous. For example, in some embodiments, the second moiety comprises one or more moieties that are micropore-generating units. In some embodiments, the second moiety is substantially rigid. For example, in some embodiments, the second moiety comprises no carbon-carbon or carbon-heteroatom single bonds that are capable of free rotation. In certain embodiments, employing a second moiety that is intrinsically microporous and/or substantially rigid may advantageously provide a polyamide with intrinsic microporosity properties (e.g., small pore sizes, large fractional free volumes, high surface areas, etc.).

According to some embodiments, the second moiety comprises a Tröger's base moiety and/or an analogue or a derivative thereof. In certain embodiments, one or more heterocyclic rings in the Tröger's base moiety and/or the analogue or the derivative thereof may advantageously be a micropore-generating unit.

In some embodiments, the second moiety comprises the structure shown in (3a):

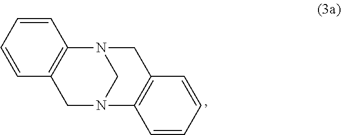 [SMILES: c1ccc2c(c1)CN1CN2Cc2ccccc21]

wherein at least one aromatic ring is functionalized with at least one functional group that is crosslinked with a functional group of a first moiety.

In some embodiments, one or more positions of one or more aromatic rings and/or one or more positions of one or more heterocyclic rings in (3a) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an amine group, and/or combinations thereof.

According to certain embodiments wherein the second moiety comprises the structure shown in (3a), more than one aromatic ring may be functionalized with at least one functional group that is crosslinked with a functional group of a first moiety. In some embodiments, for example, the second moiety comprises the structure shown in (3a), and both aromatic rings are functionalized with at least one functional group, each functional group crosslinked with a functional group of a first moiety.

According to some embodiments, the second moiety comprises the structure shown in (3b):

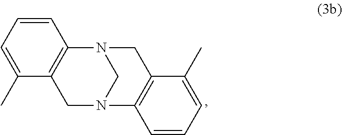 [SMILES: Cc1cccc2c1CN1CN2Cc2c(C)cccc21]

wherein at least one aromatic ring is functionalized with at least one functional group that is crosslinked with a functional group of a first moiety.

In some embodiments, one or more positions of one or more aromatic rings and/or one or more positions of one or more heterocyclic rings in (3b) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an amine group, and/or combinations thereof.

According to certain embodiments wherein the second moiety comprises the structure shown in (3b), more than one aromatic ring may be functionalized with at least one functional group that is crosslinked with a functional group of a first moiety. In some embodiments, for example, the second moiety comprises the structure shown in (3b), and both aromatic rings are functionalized with at least one functional group, each functional group crosslinked with a functional group of a first moiety.

In some embodiments, as described herein, the second moiety comprises at least one functional group. In certain embodiments, the at least one functional group of the second moiety is crosslinked with a functional group of a first moiety. The second moiety may comprise any of a variety of suitable functional groups. In some embodiments, for example, the at least one functional group of the second moiety is an amine group. Other functional groups are also possible.

According to some embodiments, the second moiety comprises the structure shown in (4a):

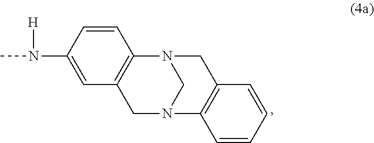

wherein the dotted line represents a crosslinking bond to a functional group of a first moiety.

In some embodiments, one or more positions of one or more aromatic rings and/or one or more positions of one or more heterocyclic rings in (4a) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an amine group, and/or combinations thereof.

According to certain embodiments, the second moiety comprises the structure shown in (4b):

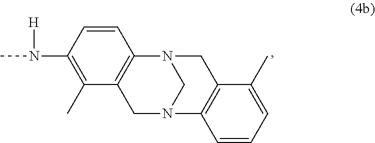

wherein the dotted line represents a crosslinking bond to a functional group of a first moiety.

In some embodiments, one or more positions of one or more aromatic rings and/or one or more positions of one or more heterocyclic rings in (4b) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an amine group, and/or combinations thereof.

In certain embodiments, the second moiety comprises an amine-functionalized aromatic hydrocarbon and/or a nitrogen-containing heterocyclic ring. In certain embodiments, for example, the second moiety comprises the structure shown in (4c):

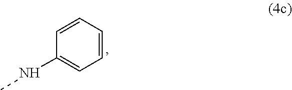

wherein the dotted line represents a crosslinking bond to a functional group of a first moiety.

In some embodiments, one or more positions of the aromatic ring in (4c) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an amine group, and/or combinations thereof.

In certain embodiments, the second moiety comprises the structure shown in (4d):

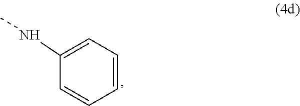

wherein the dotted line represents a crosslinking bond to a functional group of a first moiety.

In some embodiments, one or more positions of the aromatic ring in (4d) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an amine group, and/or combinations thereof.

In certain embodiments, the second moiety comprises the structure shown in (4e):

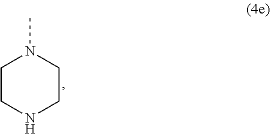

wherein the dotted line represents a crosslinking bond to a functional group of a first moiety.

In some embodiments, one or more positions of the heterocyclic ring in (4e) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), and/or combinations thereof.

In certain embodiments, as described herein, the second moiety comprises more than one functional group (e.g., two functional groups). According to some embodiments, each of the more than one functional group is crosslinked with a functional group of a first moiety. According to some embodiments, for example, the second moiety comprises two functional groups, and each functional group is crosslinked with a functional group of a first moiety.

According to some embodiments, the second moiety comprises the structure shown in (5a):

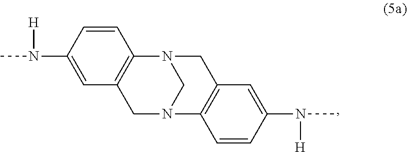

wherein each dotted line independently represents a crosslinking bond to a first moiety or a bond to an atom that is a terminal end of the PIM, provided that at least one dotted line is a crosslinking bond to a functional group of a first moiety.

In some embodiments, one or more positions of one or more aromatic rings and/or one or more positions of one or more heterocyclic rings in (5a) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an amine group, and/or combinations thereof.

In certain embodiments, the second moiety comprises the structure shown in (5b):

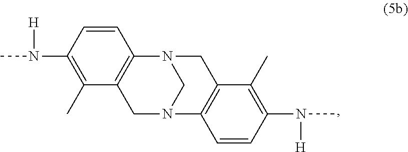

wherein each dotted line independently represents a crosslinking bond to a first moiety or a bond to an atom that is a terminal end of the PIM, provided that at least one dotted line is a crosslinking bond to a functional group of a first moiety.

In some embodiments, one or more positions of one or more aromatic rings and/or one or more positions of one or more heterocyclic rings in (5b) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an amine group, and/or combinations thereof.

In certain embodiments, the second moiety comprises the structure shown in (5c):

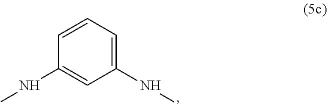

wherein each dotted line independently represents a crosslinking bond to a first moiety or a bond to an atom that is a terminal end of the PIM, provided that at least one dotted line is a crosslinking bond to a functional group of a first moiety.

In some embodiments, one or more positions of the aromatic ring in (5c) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an amine group, and/or combinations thereof.

In some embodiments, the second moiety comprises the structure shown in (5d):

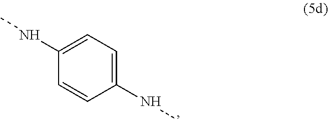

wherein each dotted line independently represents a crosslinking bond to a first moiety or a bond to an atom that is a terminal end of the PIM, provided that at least one dotted line is a crosslinking bond to a functional group of a first moiety.

In some embodiments, one or more positions of the aromatic ring in (5d) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an amine group, and/or combinations thereof.

According to some embodiments, the second moiety comprises the structure shown in (5e):

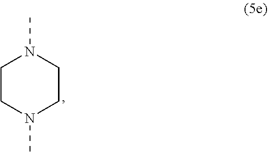

wherein each dotted line independently represents a crosslinking bond to a first moiety or a bond to an atom that is a terminal end of the PIM, provided that at least one dotted line is a crosslinking bond to a functional group of a first moiety.

In some embodiments, one or more positions of the heterocyclic ring in (5e) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an amine group, and/or combinations thereof.

In certain embodiments wherein a dotted line in (5a)-(5e) represents a bond to an atom or a functional group that is a terminal end of the PIM, the atom or the functional group that is the terminal end of the PIM may be any of a variety of suitable atoms and/or functional groups. In certain embodiments, for example, the atom that is the terminal end of the PIM is a hydrogen or a halogen (e.g., a F atom, a Cl atom, a Br atom, or the like). In some embodiments, the functional group that is the terminal end of the PIM is a —C₁-C₁₀ alkyl group, a —C₂-C₁₀ alkenyl group, a —C₃-C₁₀ alkynyl group, or an aryl group. Other atoms and/or functional groups are also possible.

In accordance with certain embodiments, the second moiety may be chosen based upon the teachings of this specification to provide a polyamide with a desired pore size, fractional free volume, and/or surface area, depending on the particular application.

The polyamide may comprise any of a variety of suitable structures. In certain embodiments, the polyamide is intrinsically microporous. For example, in some embodiments, the polyamide comprises a first moiety and a second moiety that are micro-pore generating units. In certain embodiments, the polyamide is substantially rigid. In some embodiments, for example, the polyamide comprises no carbon-carbon or carbon-heteroatom single bonds that are capable of free rotation other than an amide bond. In certain embodiments, employing a polyamide that is intrinsically microporous and/or substantially rigid may advantageously provide a polymer with intrinsic microporosity properties (e.g. small pore sizes, large fractional free volumes, high surface areas etc.).

According to some embodiments, the first moiety and the second moiety are crosslinked via an amide bond. In certain embodiments, for example, the PIM comprises a polyamide comprising the structure shown in (6a):

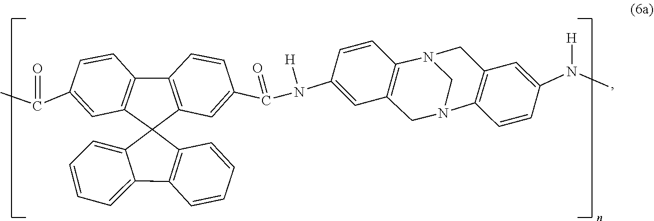

wherein n is greater than or equal to 2 and less than or equal to 100,000.

In some embodiments, one or more positions of one or more aromatic rings and/or one or more positions of one or more heterocyclic rings in (6a) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an amine group, an acyl group, an acyl halide, and/or combinations thereof.

In certain embodiments, the PIM comprises a polyamide comprising the structure shown in (6b):

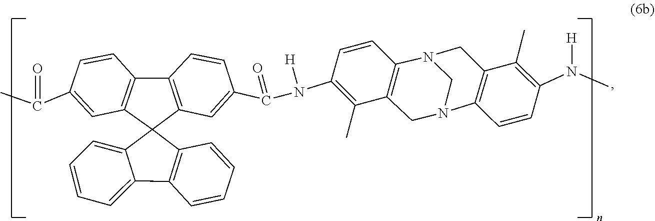

wherein n is greater than or equal to 2 and less than or equal to 100,000.

In some embodiments, one or more positions of one or more aromatic rings and/or one or more positions of one or more heterocyclic rings in (6b) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an amine group, an acyl group, an acyl halide, and/or combinations thereof.

According to some embodiments, the PIM comprises a polyamide comprising the structure shown in (6c):

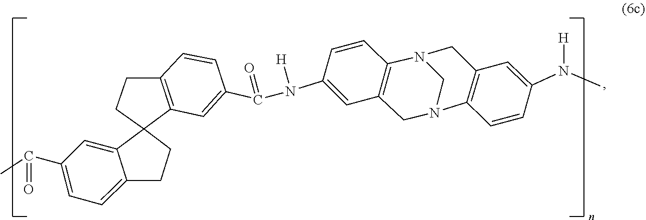

wherein n is greater than or equal to 2 and less than or equal to 100,000.

In some embodiments, one or more positions of one or more aromatic rings, one or more positions of one or more carbocyclic rings, and/or one or more positions of one or more heterocyclic rings in (6c) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an amine group, an acyl group, an acyl halide, and/or combinations thereof.

In certain embodiments, the PIM comprises a polyamide comprising the structure shown in (6d):

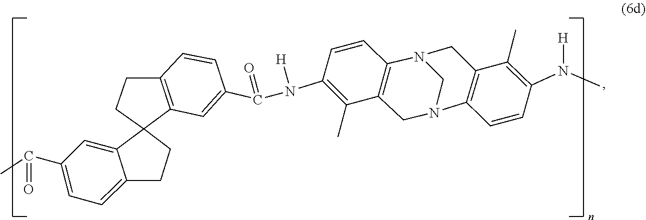

wherein n is greater than or equal to 2 and less than or equal to 100,000.

In some embodiments, one or more positions of one or more aromatic rings, one or more positions of one or more carbocyclic rings, and/or one or more positions of one or more heterocyclic rings in (6d) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an amine group, an acyl group, an acyl halide, and/or combinations thereof.

In some embodiments, the PIM comprises the structure shown in (6e):

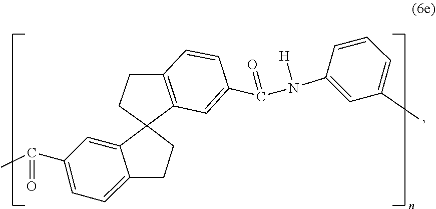

wherein n is greater than or equal to 2 and less than or equal to 100,000.

In some embodiments, one or more positions of one or more aromatic rings and/or one or more carbocyclic rings in (6e) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an amine group, an acyl group, an acyl halide, and/or combinations thereof.

In certain embodiments, the PIM comprises the structure shown in (6f):

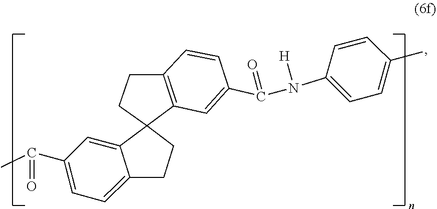

wherein n is greater than or equal to 2 and less than or equal to 100,000.

In some embodiments, one or more positions of one or more aromatic rings and/or one or more carbocyclic rings in (6f) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an amine group, an acyl group, an acyl halide, and/or combinations thereof.

According to certain embodiments, the PIM comprises the structure shown in (6g):

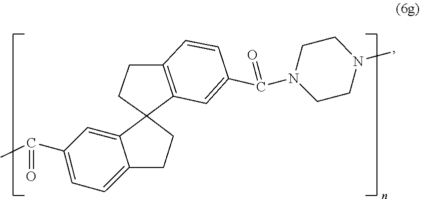

wherein n is greater than or equal to 2 and less than or equal to 100,000.

In some embodiments, one or more positions of one or more aromatic rings, one or more carbocyclic rings, and/or one or more heterocyclic rings in (6g) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an amine group, an acyl group, an acyl halide, and/or combinations thereof.

In certain embodiments, the PIM comprises a polyamide comprising a plurality of second moieties (e.g., two second moieties, three second moieties, four second moieties, etc.). In some such embodiments, the first moiety and each of the second moieties are crosslinked via an amide bond. In certain embodiments, for example, the PIM comprises the structure shown in (7a):

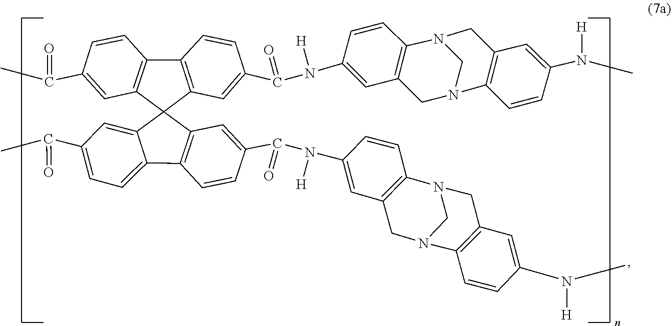

wherein n is greater than or equal to 2 and less than or equal to 100,000.

In some embodiments, one or more positions of one or more aromatic rings and/or one or more positions of one or more heterocyclic rings in (7a) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an amine group, an acyl group, an acyl halide, and/or combinations thereof.

According to some embodiments, the PIM comprises the structure shown in (7b):

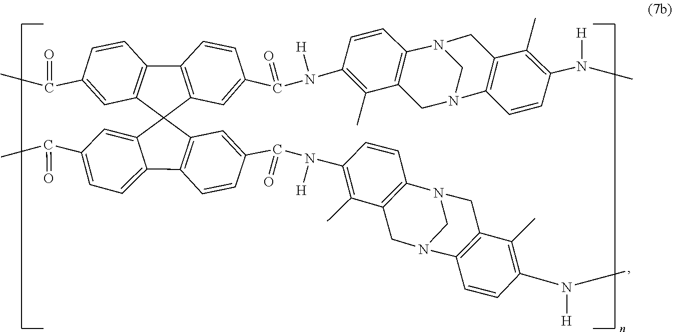

wherein n is greater than or equal to 2 and less than or equal to 100,000.

In some embodiments, one or more positions of one or more aromatic rings and/or one or more positions of one or more heterocyclic rings in (7b) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an amine group, an acyl group, an acyl halide, and/or combinations thereof.

In some embodiments, the PIM comprises the structure shown in (7c):

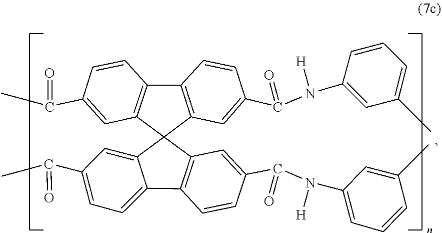

wherein n is greater than or equal to 2 and less than or equal to 100,000.

In some embodiments, one or more positions of one or more aromatic rings in (7c) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an amine group, an acyl group, an acyl halide, and/or combinations thereof.

In certain embodiments, the PIM comprises the structure shown in (7d):

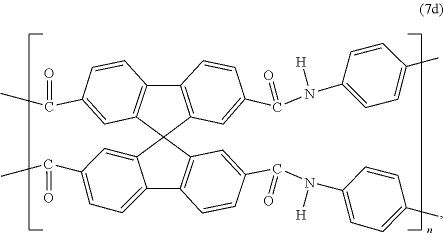

wherein n is greater than or equal to 2 and less than or equal to 100,000.

In some embodiments, one or more positions of one or more aromatic rings in (7d) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an amine group, an acyl group, an acyl halide, and/or combinations thereof.

According to some embodiments, the PIM comprises the structure shown in (7e):

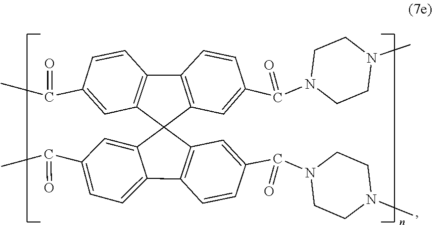

wherein n is greater than or equal to 2 and less than or equal to 100,000.

In some embodiments, one or more positions of one or more aromatic rings and/or one or more heterocyclic rings in (7e) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an amine group, an acyl group, an acyl halide, and/or combinations thereof.

The value of “n” in the structures shown in (6a)-(7e) may be any of a variety of suitable values. In some embodiments, the value of “n” is greater than or equal to 2, greater than or equal to 5, greater than or equal to 10, greater than or equal to 50, greater than or equal to 100, greater than or equal to 500, greater than or equal to 1,000, greater than or equal to 5,000, greater than or equal to 10,000, or greater than or equal to 50,000. In some embodiments, the value of “n” is less than or equal to 100,000, less than or equal to 50,000, less than or equal to 10,000, less than or equal to 5,000, less than or equal to 1,000, less than or equal to 500, less than or equal to 100, less than or equal to 50, less than or equal to 10, or less than or equal to 5. Combinations of the above recited ranges are possible (e.g., the value of “n” is greater than or equal to 2 and less than or equal to 100,000, the value of “n” is greater than or equal to 500 and less than or equal to 1,000). Other ranges are also possible.

The plurality of voids and/or pores of the PIM may have any of a variety of suitable maximum void and/or pore sizes. In certain embodiments, for example, the plurality of voids and/or pores of the PIM has a maximum characteristic dimension (e.g., a maximum diameter) less than or equal to 2 nanometers, less than or equal to 1.8 nanometers, less than or equal to 1.6 nanometers, less than or equal to 1.4 nanometers, less than or equal to 1.2 nanometers, less than or equal to 1 nanometer, less than or equal to 0.8 nanometers, less than or equal to 0.6 nanometers, less than or equal to 0.4 nanometers, or less than or equal to 0.2 nanometers. In some embodiments, the plurality of voids and/or pores of the PIM has a maximum characteristic dimension (e.g., a maximum diameter) greater than or equal to 0.1 nanometers, greater than or equal to 0.2 nanometers, greater than or equal to 0.4 nanometers, greater than or equal to 0.6 nanometers, greater than or equal to 0.8 nanometers, greater than or equal to 1 nanometer, greater than or equal to 1.2 nanometers, greater than or equal to 1.4 nanometers, greater than or equal to 1.6 nanometers, or greater than or equal to 1.8 nanometers. Combinations of the above recited ranges are possible (e.g., the plurality of voids and/or pores of the PIM has a maximum characteristic dimension less than or equal to 2 nanometers and greater than or equal to 0.1 nanometers, the plurality of voids and/or pores of the PIM has a maximum characteristic dimension less than or equal to 1 nanometer and greater than or equal to 0.8 nanometers). Other ranges are also possible.

The maximum characteristic dimension (e.g., maximum diameter) of the plurality of voids and/or pores of the PIM may be determined by X-ray diffraction (XRD).

The PIM may have any of a variety of suitable fractional free volumes (FFVs). According to certain embodiments, the FFV of the PIM is advantageously high compared to conventional PIMs. In some embodiments, for example, the PIM has a FFV greater than or equal to 0.1, greater than or equal to 0.12, greater than or equal to 0.14, greater than or equal to 0.16, greater than or equal to 0.18, greater than or equal to 0.19, greater than or equal to 0.2, greater than or equal to 0.22, greater than or equal to 0.24, greater than or equal to 0.26, greater than or equal to 0.28, greater than or equal to 0.3, greater than or equal to 0.32, greater than or equal to 0.34, greater than or equal to 0.36, or greater than or equal to 0.38. In certain embodiments, the PIM has a FFV less than or equal to 0.4, less than or equal to 0.38, less than or equal to 0.36, less than or equal to 0.34, less than or equal to 0.32, less than or equal to 0.3, less than or equal to 0.28, less than or equal to 0.26, less than or equal to 0.24, less than or equal to 0.22, less than or equal to 0.2, less than or equal to 0.18, less than or equal to 0.16, less than or equal to 0.14, or less than or equal to 0.12. Combinations of the above recited ranges are possible (e.g., the PIM has a FFV greater than or equal to 0.1 and less than or equal to 0.4, the PIM has a FFV greater than or equal to 0.26 and less than or equal to 0.27). Other ranges are also possible.

The FFV of the PIM may be determined according to Equation 2 (Eq. 2).

$$FFV = \frac{{V}_{f}}{V} = \frac{V - {V}_{OC}}{V} , \qquad ( Eq . 2 )$$

where V_{f} is the free volume (cm³ g⁻¹), Vis the specific volume (cm³ g⁻¹), and V_{OC} is the volume occupied by polymer chains (cm³ g⁻¹). In certain embodiments, V is a measurable quantity equal to the inverse of the polymer film density. In some embodiments, V_{OC} is determined according to Bondi's group contribution method coupled with density measurements.

The PIM may have any of a variety of suitable CO₂ sorption capacities. In some embodiments, for example, the PIM has a CO₂ sorption capacity greater than or equal to 20 cm³/g, greater than or equal to 25 cm³/g, greater than or equal to 30 cm³/g, greater than or equal to 35 cm³/g, greater than or equal to 40 cm³/g, greater than or equal to 45 cm³/g, greater than or equal to 50 cm³/g, or greater than or equal to 55 cm³/g at an absolute pressure greater than or equal to 200 mmHg and less than or equal to 800 mmHg. In certain embodiments, the PIM has a CO₂ sorption capacity less than or equal to 60 cm³/g, less than or equal to 55 cm³/g, less than or equal to 50 cm³/g, less than or equal to 45 cm³/g, less than or equal to 40 cm³/g, less than or equal to 35 cm³/g, less than or equal to 30 cm³/g, or less than or equal to 25 cm³/g at an absolute pressure greater than or equal to 200 mmHg and less than or equal to 800 mmHg. Combinations of the above recited ranges are possible (e.g., the PIM has a CO₂ sorption capacity greater than or equal to 20 cm³/g and less than or equal to 60 cm³/g at an absolute pressure greater than or equal to 200 mmHg and less than or equal to 800 mmHg, the PIM has a CO₂ sorption capacity greater than or equal to 40 cm³/g and less than or equal to 45 cm³/g at an absolute pressure greater than or equal to 200 mmHg and less than or equal to 800 mmHg). Other ranges are also possible.

In certain embodiments, the PIM has a CO₂ sorption capacity greater than or equal to 30 cm³/g, greater than or equal to 32 cm³/g, greater than or equal to 34 cm³/g, greater than or equal to 36 cm³/g, greater than or equal to 38 cm³/g, greater than or equal to 40 cm³/g, greater than or equal to 42 cm³/g, greater than or equal to 44 cm³/g, greater than or equal to 46 cm³/g, greater than or equal to 48 cm³/g, greater than or equal to 50 cm³/g, greater than or equal to 52 cm³/g, greater than or equal to 54 cm³/g, greater than or equal to 56 cm³/g, or greater than or equal to 58 cm³/g at an absolute pressure greater than or equal to 450 mmHg and less than or equal to 800 mmHg. In certain embodiments, the PIM has a CO₂ sorption capacity less than or equal to 60 cm³/g, less than or equal to 58 cm³/g, less than or equal to 56 cm³/g, less than or equal to 54 cm³/g, less than or equal to 52 cm³/g, less than or equal to 50 cm³/g, less than or equal to 48 cm³/g, less than or equal to 46 cm³/g, less than or equal to 44 cm³/g, less than or equal to 42 cm³/g, less than or equal to 40 cm³/g, less than or equal to 38 cm³/g, less than or equal to 36 cm³/g, less than or equal to 34 cm³/g, or less than or equal to 32 cm³/g at an absolute pressure greater than or equal to 450 mmHg and less than or equal to 800 mmHg. Combinations of the above recited ranges are possible (e.g., the PIM has a CO₂ sorption capacity greater than or equal to 30 cm³/g and less than or equal to 60 cm³/g at an absolute pressure greater than or equal to 450 mmHg and less than or equal to 800 mmHg, the PIM has a CO₂ sorption capacity greater than or equal to 50 cm³/g and less than or equal to 52 cm³/g at an absolute pressure greater than or equal to 450 mmHg and less than or equal to 800 mmHg). Other ranges are also possible.

The CO₂ sorption capacity of the PIM may be determined by a physisorption analyzer.

The PIM may have any of a variety of suitable surface areas. In some embodiments, for example, the PIM has a surface area greater than or equal to 70 m²/g, greater than or equal to 80 m²/g, greater than or equal to 90 m²/g, greater than or equal to 100 m²/g, greater than or equal to 110 m²/g, greater than or equal to 120 m²/g, greater than or equal to 130 m²/g, greater than or equal to 140 m²/g, greater than or equal to 150 m²/g, greater than or equal to 160 m²/g, greater than or equal to 170 m²/g, greater than or equal to 180 m²/g, greater than or equal to 190 m²/g, greater than or equal to 200 m²/g, greater than or equal to 210 m²/g, greater than or equal to 220 m²/g, greater than or equal to 230 m²/g, or greater than or equal to 240 m²/g. In certain embodiments, the PIM has a surface area less than or equal to 250 m²/g, less than or equal to 240 m²/g, less than or equal to 230 m²/g, less than or equal to 220 m²/g, less than or equal to 210 m²/g, less than or equal to 200 m²/g, less than or equal to 190 m²/g, less than or equal to 180 m²/g, less than or equal to 170 m²/g, less than or equal to 160 m²/g, less than or equal to 150 m²/g, less than or equal to 140 m²/g, less than or equal to 130 m²/g, less than or equal to 120 m²/g, less than or equal to 110 m²/g, less than or equal to 100 m²/g, less than or equal to 90 m²/g, or less than or equal to 80 m²/g. Combinations of the above recited ranges are possible (e.g., the PIM has a surface area greater than or equal to 70 m²/g and less than or equal to 250 m²/g, the PIM has a surface area greater than or equal to 200 m²/g and less than or equal to 210 m²/g). Other ranges are also possible.

The surface area of the PIM may be determined from CO₂ sorption isotherms at 273 K and calculated using the Langmuir surface area method.

The PIM may have any of a variety of suitable nitrogen (N) to oxygen (O) atomic ratios. Without wishing to be bound by theory, the N:O atomic ratio of the PIM may indicate the degree of crosslinking between the first moiety and the second moiety, wherein a N:O atomic ratio of 1 indicates full crosslinking between the first moiety and the second moiety. According to some embodiments, for example, the PIM has a N:O atomic ratio greater than or equal to 0.5, greater than or equal to 0.6, greater than or equal to 0.7, greater than or equal to 0.8, greater than or equal to 0.9, greater than or equal to 0.95, or greater than or equal to 0.99. In certain embodiments, the PIM has a N:O atomic ratio less than or equal to 1, less than or equal to 0.99, less than or equal to 0.95, less than or equal to 0.9, less than or equal to 0.8, less than or equal to 0.7, or less than or equal to 0.6. Combinations of the above recited ranges are possible (e.g., the PIM has a N:O atomic ratio greater than or equal to 0.5 and less than or equal to 1, the PIM has a N:O atomic ratio greater than or equal to 0.7 and less than or equal to 0.8). Other ranges are also possible.

The N:O ratio of the PIM may be determined by X-ray photoelectron spectroscopy (XPS) elemental analysis.

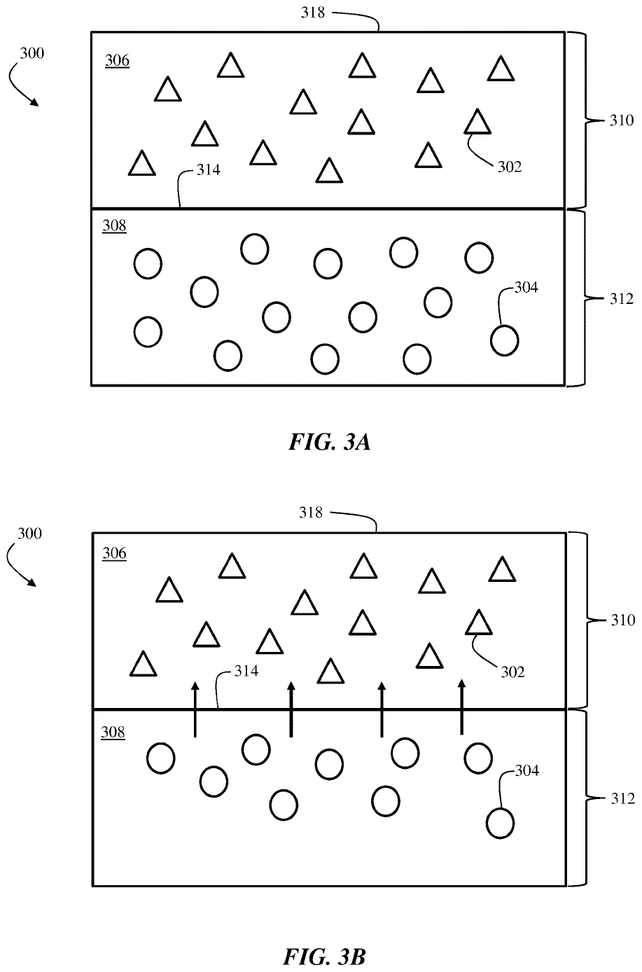

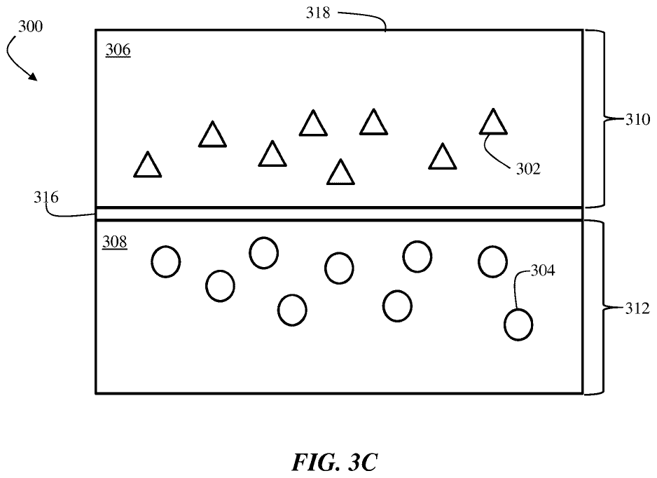

According to some embodiments, a method of synthesizing a PIM is described. FIGS. 3A-3C show, in accordance with certain embodiments, schematic diagrams representing method 300 of synthesizing a PIM. According to certain embodiments, the method of synthesizing the PIM comprises a polymerization reaction. In some embodiments, the method of synthesizing the PIM comprises an interfacial polymerization reaction.

In certain embodiments, the method comprises exposing a first monomer to a second monomer. Referring to FIG. 3A, for example, method 300 comprises exposing first monomer 302 to second monomer 304. According to some embodiments, the first monomer may be exposed to the second monomer in a container (e.g., a reaction vessel). Referring, for example, to FIG. 3A, first monomer 302 is exposed to second monomer 304 in container 318. As described herein in greater detail, the first monomer may be configured to bond with the second monomer. In some embodiments, for example, the first monomer is configured to crosslink with the second monomer. In certain embodiments, the first monomer comprises at least one functional group (e.g., an acyl halide group) that is configured to crosslink with a functional group of the second monomer (e.g., an amine group).

In some embodiments, the first monomer is dissolved and/or suspended in a first solvent, thereby forming a first solution. Referring, for example, to FIG. 3A, first monomer 302 is dissolved and/or suspended in first solvent 306, thereby forming first solution 310. In certain embodiments, the second monomer is dissolved and/or suspended in a second solvent, thereby forming a second solution. For example, referring to FIG. 3A, second monomer 304 is dissolved and/or suspended in second solvent 208, thereby forming second solution 312.

The first monomer may comprise any of a variety of suitable monomers. In certain embodiments, the first monomer comprises a spiro group. In some embodiments, for example, the first monomer comprises a spirobifluorene moiety, a spirobisindane moiety, and/or an analogue or a derivative thereof. Other spiro group-containing moieties are also possible.

In some embodiments, the first monomer comprises the structure shown in (8a):

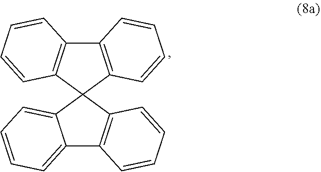

wherein at least one aromatic ring is functionalized with at least one functional group that is configured to crosslink with a functional group of a second monomer.

In some embodiments, one or more positions of one or more aromatic rings in (8a) are independently optionally substituted, for example, with a —C₁-C₁₀ alkyl group, a —C₂-C₁₀ alkenyl group, a —C₃-C₁₀ alkynyl group, an aryl group, a halogen, e.g., a fluorine (F) atom, a chlorine (Cl) atom, a bromine (Br) atom, or the like, an acyl group, an acyl halide, and/or combinations thereof.

According to certain embodiments wherein the first monomer comprises the structure shown in (8a), more than one aromatic ring may be functionalized with at least one functional group that is configured to crosslink with a functional group of a second monomer. In some embodiments, for example, the first monomer comprises the structure shown in (8a), and two aromatic rings are functionalized with at least one functional group, each functional group configured to crosslink with a functional group of a second monomer. In certain other embodiments, the first monomer comprises the structure shown in (8a), and three aromatic rings are functionalized with at least one functional group, each functional group configured to crosslink with a functional group of a second monomer. In yet some other embodiments, the first monomer comprises the structure shown in (8a), and all four aromatic rings are functionalized with at least one functional group, each functional group configured to crosslink with a functional group of a second monomer.

In certain embodiments, the first monomer comprises the structure shown in (8b):

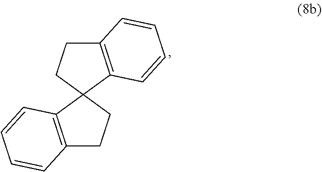

wherein at least one aromatic ring is functionalized with at least functional group that is configured to crosslink with a functional group of a second monomer.

In some embodiments, one or more positions of one or more aromatic rings and/or one or more positions of one or more carbocyclic rings in (8b) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an acyl group, an acyl halide, and/or combinations thereof.

According to certain embodiments wherein the first monomer comprises the structure shown in (8b), more than one aromatic ring may be functionalized with at least one functional group that is configured to crosslink with a functional group of a second monomer. In some embodiments, for example, the first monomer comprises the structure shown in (8b), and both aromatic rings are functionalized with at least one functional group, each functional group configured to crosslink with a functional group of a second monomer.

In some embodiments, as described herein, the first monomer comprises at least one functional group. In certain embodiments, the at least one functional group of the first monomer is configured to crosslink with a functional group of a second monomer. The first monomer may comprise any of a variety of suitable functional groups. In some embodiments, for example, the at least one functional group of the first monomer is an acyl halide group.

In certain embodiments, the first monomer comprises the structure shown in (9a):

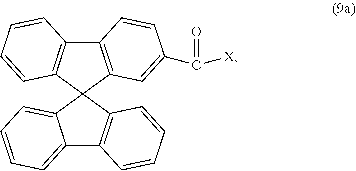

wherein X represents a halogen (e.g., a F atom, a Cl atom, a Br atom, or the like).

In some embodiments, one or more positions of one or more aromatic rings in (9a) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an acyl group, an acyl halide, and/or combinations thereof.

According to some embodiments, the first monomer comprises the structure shown in (9b):

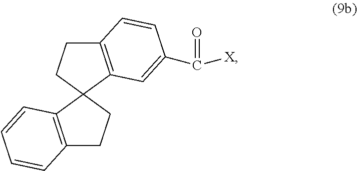

wherein X represents a halogen (e.g., a F atom, a Cl atom, a Br atom, or the like).

In some embodiments, one or more positions of one or more aromatic rings and/or one or more positions of one or more carbocyclic rings in (9b) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an acyl group, an acyl halide, and/or combinations thereof.

In certain embodiments, as described herein, the first monomer comprises more than one functional group (e.g., two functional groups, three functional groups, four functional groups, etc.). According to some embodiments, each of the more than one functional group is configured to crosslink with a functional group of a second monomer. In some embodiments, for example, the first monomer comprises two functional groups, and each functional group is configured to crosslink with a functional group of a second monomer. In certain other embodiments, the first monomer comprises three functional groups, and each functional group is configured to crosslink with a functional group of a second monomer. In yet some other embodiments, the first monomer comprises four functional groups, and each functional group is configured to crosslink with a functional group of a second monomer.

According to some embodiments, the first monomer comprises the structure shown in (9c),

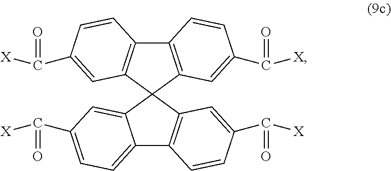

wherein each X represents a halogen (e.g., a F atom, a Cl atom, a Br atom, or the like).

In some embodiments, one or more positions of one or more aromatic rings in (9c) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), and/or combinations thereof.

In certain embodiments, the first monomer comprises the structure shown in (2d):

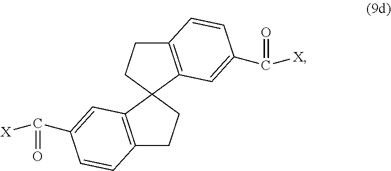

wherein each X represents a halogen (e.g., a F atom, a Cl atom, a Br atom, or the like).

In some embodiments, one or more positions of one or more aromatic rings and/or one or more positions of one or more carbocyclic rings in (9d) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), and/or combinations thereof.

The second monomer may comprise any of a variety of suitable monomers. According to some embodiments, the second monomer comprises a Tröger's base moiety and/or an analogue or a derivative thereof. According to some embodiments, a second monomer comprising a Tröger's base moiety and/or an analogue or a derivative thereof is soluble in water, which advantageously facilitates the interfacial polymerization reaction between the first monomer and the second monomer, as described herein in greater detail.

In some embodiments, the second monomer comprises the structure shown in (10a):

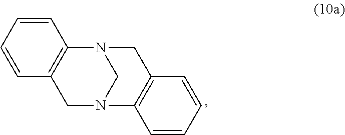 [SMILES: c1ccc2c(c1)CN1CN2Cc2ccccc21]

wherein at least one aromatic ring is functionalized with at least one functional group that is configured to crosslink with a functional group of the first monomer.

In some embodiments, one or more positions of one or more aromatic rings and/or one or more positions of one or more heterocyclic rings in (10a) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an amine group, and/or combinations thereof.

According to certain embodiments wherein the second monomer comprises the structure shown in (10a), more than one aromatic ring may be functionalized with at least one functional group that is configured to crosslink with a functional group of a first monomer. In some embodiments, for example, the second monomer comprises the structure shown in (10a), and both aromatic rings are functionalized with at least one functional group, each functional group configured to crosslink with a functional group of a first monomer.

According to some embodiments, the second monomer comprises the structure shown in (10b):

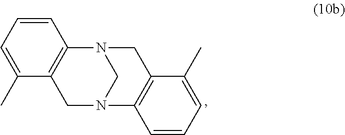 [SMILES: Cc1cccc2c1CN1CN2Cc2c(C)cccc21]

wherein at least one aromatic ring is functionalized with at least one functional group that is configured to crosslink with a functional group of a first monomer.

In some embodiments, one or more positions of one or more aromatic rings and/or one or more positions of one or more heterocyclic rings in (10b) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an amine group, and/or combinations thereof.

According to certain embodiments wherein the second monomer comprises the structure shown in (10b), more than one aromatic ring may be functionalized with at least one functional group that is configured to crosslink with a functional group of a first monomer. In some embodiments, for example, the second monomer comprises the structure shown in (10b), and both aromatic rings are functionalized with at least one functional group, each functional group configured to crosslink with a functional group of a first monomer.

In some embodiments, as described herein, the second monomer comprises at least one functional group. In certain embodiments, the at least one functional group of the second monomer is configured to crosslink with a functional group of a first monomer. The second monomer may comprise any of a variety of suitable functional groups. In some embodiments, for example, the at least one functional group of the second monomer is an amine group.

According to some embodiments, the second monomer comprises the structure shown in (11a):

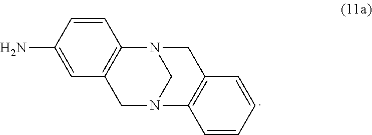 [SMILES: Nc1ccc2c(c1)CN1CN2Cc2ccccc21]

In some embodiments, one or more positions of one or more aromatic rings and/or one or more positions of one or more heterocyclic rings in (11a) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an amine group, and/or combinations thereof.

According to certain embodiments, the second monomer comprises the structure shown in (11b):

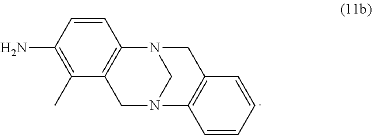 [SMILES: Cc1c(N)ccc2c1CN1CN2Cc2ccccc21]

In some embodiments, one or more positions of one or more aromatic rings and/or one or more positions of one or more heterocyclic rings in (11b) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an amine group, and/or combinations thereof.

In certain embodiments, the second monomer comprises an amine-functionalized aromatic hydrocarbon and/or a nitrogen-containing heterocyclic ring. In certain embodiments, for example, the second monomer comprises the structure shown in (11c):

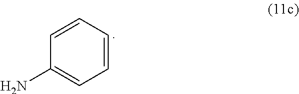

In some embodiments, one or more positions of the aromatic ring in (11c) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an amine group, and/or combinations thereof.

In certain embodiments, the second monomer comprises the structure shown in (11d):

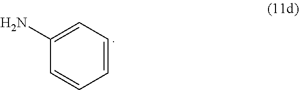

In some embodiments, one or more positions of the aromatic ring in (11d) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an amine group, and/or combinations thereof.

In certain embodiments, as described herein, the second monomer comprises more than one functional group (e.g., two functional groups, etc.). According to some embodiments, each of the more than one functional group is configured to crosslink with a functional group of a first monomer. In some embodiments, for example, the second monomer comprises two functional groups, and each functional group is configured to crosslink with a functional group of a first monomer.

According to some embodiments, the second monomer comprises the structure shown in (12a):

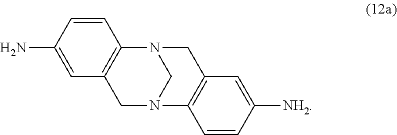 [SMILES: Nc1ccc2c(c1)CN1CN2Cc2cc(N)ccc21]

In some embodiments, one or more positions of one or more aromatic rings and/or one or more positions of one or more heterocyclic rings in (12a) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an amine group, and/or combinations thereof.

In certain embodiments, the second monomer comprises the structure shown in (12b):

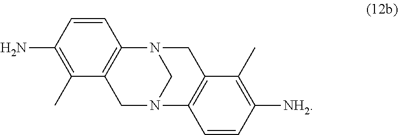 [SMILES: Cc1c(N)ccc2c1CN1CN2Cc2c1ccc(N)c2C]

In some embodiments, one or more positions of one or more aromatic rings and/or one or more positions of one or more heterocyclic rings in (5b) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an amine group, and/or combinations thereof.

In certain embodiments, for example, the second monomer comprises m-phenylenediamine (MPD), shown in (12c):

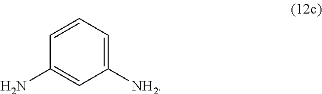

In some embodiments, one or more positions of the aromatic ring in (12c) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an amine group, and/or combinations thereof.

In some embodiments, the second monomer comprises p-phenylenediamine (PPD), shown in (12d):

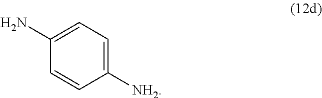

In some embodiments, one or more positions of the aromatic ring in (12d) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an amine group, and/or combinations thereof.

In certain embodiments, the second monomer comprises piperazine (PIP), shown in (12e):

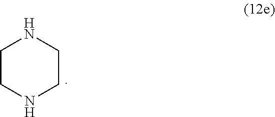

In some embodiments, one or more positions of the heterocyclic ring in (12e) are independently optionally substituted, for example, with a —C₁-C₁₀ alkyl group, a —C₂-C₁₀ alkenyl group, a —C₃-C₁₀ alkynyl group, an aryl group, a halogen (e.g., a F atom, a Cl atom, a Br atom, or the like), an amine group, and/or combinations thereof.

The first solvent may comprise any of a variety of suitable solvents. According to certain embodiments, the first solvent is an organic solvent such that the first solution (e.g., the first monomer dissolved and/or suspended in the first solvent) is an organic phase. Referring, for example, to FIG. 3A, first solvent 306 is an organic solvent such that first solution 310 (e.g., first monomer 302 dissolved and/or suspended in first solvent 306) is an organic phase. Any of a variety of suitable organic solvents are possible. In some embodiments, for example, the organic solvent comprises an aliphatic hydrocarbon (e.g., hexane, heptane, decane, and/or dodecane) an aromatic hydrocarbon (e.g., benzene, toluene, xylene), and/or combinations thereof.

The second solvent may comprise any of a variety of suitable solvents. In some embodiments, the second solvent is water such that the second solution (e.g., the second monomer dissolved and/or suspended in the second solvent) is an aqueous phase. Referring, for example, to FIG. 3A, second solvent 308 is water such that second solution 312 (e.g., second monomer 304 dissolved and/or suspended in second solvent 308) is an aqueous phase.

According to certain embodiments, the method comprises exposing the first solution comprising the first monomer to the second solution comprising the second monomer. For example, referring to FIG. 3A, method 300 comprises exposing first solution 310 comprising first monomer 302 (e.g., dissolved and/or suspended in first solvent 306) to second solution 312 comprising second monomer 304 (e.g., dissolved and/or suspended in second solvent 308).

According to some embodiments, the first solution comprising the first monomer may be exposed to the second solution comprising the second monomer such that an interface forms between the first solution and the second solution. Referring, for example, to FIG. 3A, first solution 310 comprising first monomer 302 (e.g., dissolved and/or suspended in first solvent 306) is exposed to second solution 312 comprising second monomer 304 (e.g., dissolved and/or suspended in second solvent 308) such that interface 314 forms between first solution 310 and second solution 312.

According to some embodiments, the first solution comprising the first monomer may be exposed to the second solution comprising the second monomer such that the second monomer diffuses across the interface between the first solution and the second solution and into the second solution. For example, referring to FIG. 3B, first solution 306 comprising first monomer 302 (e.g., dissolved and/or suspended in first solvent 306) is exposed to second solution 312 comprising second monomer 304 (e.g., dissolved and/or suspended in second solvent 308) such that second monomer 304 diffuses across interface 314 between first solution 310 and second solution 312 and into second solution 312.

In some embodiments, the method comprises polymerizing the first monomer and the second monomer such that a film comprising a PIM is formed at the interface between the first solution and the second solution. Referring, for example, to FIG. 3C, method 300 comprises polymerizing first monomer 302 and second monomer 304 such that film 316 comprising a PIM is formed at the interface (not shown in FIG. 3C) between first solution 310 and second solution 312. According to some embodiments, polymerizing the first monomer and the second monomer comprises crosslinking at least one functional group of the first monomer (e.g., an acyl halide group) with at least one functional group of the second monomer (e.g., an amine group). In certain embodiments, crosslinking at least one functional group of the first monomer with at least one functional group of the second monomer comprises forming an amide bond.

According to certain embodiments, a substrate is positioned at the interface between the first solution and the second solution, and a film comprising a PIM formed from polymerizing the first monomer and the second monomer is deposited on at least one surface of the substrate.

In some embodiments, at least one surface of a substrate is exposed to a first solution comprising the first monomer, followed by exposing the at least one surface of the substrate and the first solution comprising the first monomer to a second solution comprising the second monomer. In some such embodiments, a film comprising a PIM formed from polymerizing the first monomer and the second monomer is deposited on the at least one surface of the substrate.

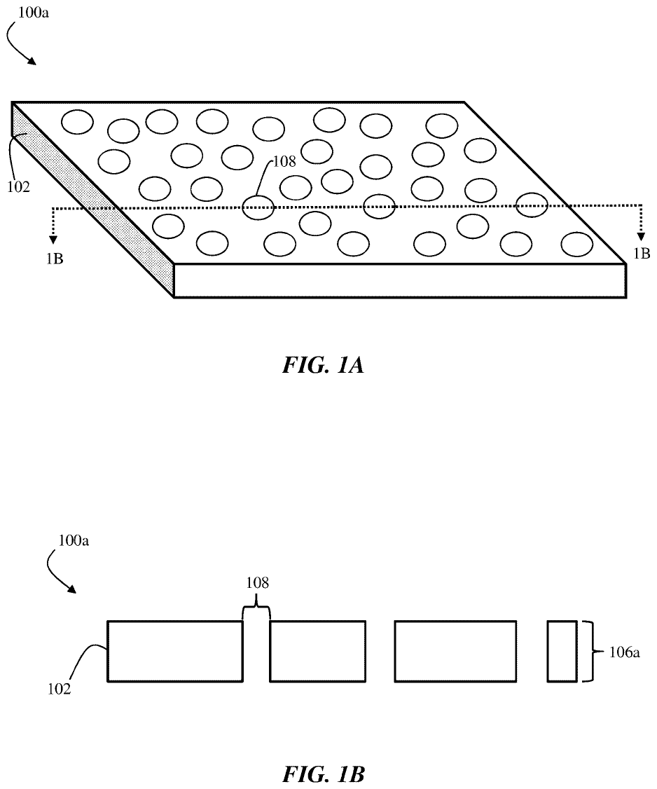

According to certain embodiments, an article is described. In some embodiments, the article comprises a membrane and/or filter comprising a PIM. FIG. 1A shows, in accordance with certain embodiments, a perspective view schematic diagram of article 100a comprising membrane and/or filter 102, wherein membrane and/or filter 102 comprises a PIM. FIG. 1B shows, in accordance with certain embodiments, a cross-sectional view schematic diagram of article 100a, wherein the cross-section is taken along dotted line 1B shown in FIG. 1A.

According to some embodiments, the membrane and/or filter comprising a PIM may be fabricated by interfacial polymerization, as described herein in greater detail.

In certain embodiments, the membrane and/or filter comprises a plurality of voids and/or pores. Referring to FIG. 1A, for example, membrane and/or filter 100a comprises plurality of voids and/or pores 108. According to some embodiments, the plurality of voids and/or pores are intrinsic voids and/or pores due to the micropore-generating units of the PIM.

The plurality of voids and/or pores of the membrane and/or filter may have any of a variety of suitable maximum void and/or pore sizes. In certain embodiments, for example, the plurality of voids and/or pores of the membrane and/or filter has a maximum characteristic dimension (e.g., a maximum diameter) less than or equal to 2 nanometers, less than or equal to 1.8 nanometers, less than or equal to 1.6 nanometers, less than or equal to 1.4 nanometers, less than or equal to 1.2 nanometers, less than or equal to 1 nanometer, less than or equal to 0.8 nanometers, less than or equal to 0.6 nanometers, less than or equal to 0.4 nanometers, or less than or equal to 0.2 nanometers. In some embodiments, the plurality of voids and/or pores of the membrane and/or filter has a maximum characteristic dimension (e.g., a maximum diameter) greater than or equal to 0.1 nanometers, greater than or equal to 0.2 nanometers, greater than or equal to 0.4 nanometers, greater than or equal to 0.6 nanometers, greater than or equal to 0.8 nanometers, greater than or equal to 1 nanometer, greater than or equal to 1.2 nanometers, greater than or equal to 1.4 nanometers, greater than or equal to 1.6 nanometers, or greater than or equal to 1.8 nanometers. Combinations of the above recited ranges are possible (e.g., the plurality of voids and/or pores of the membrane and/or filter has a maximum characteristic dimension less than or equal to 2 nanometers and greater than or equal to 0.1 nanometers, the plurality of voids and/or pores of the membrane and/or filter has a maximum characteristic dimension less than or equal to 1 nanometer and greater than or equal to 0.8 nanometers). Other ranges are also possible.

The maximum characteristic dimension (e.g., maximum diameter) of the plurality of voids and/or pores of the membrane and/or filter may be determined from the maximum characteristic dimension (e.g., maximum diameter) of the plurality of voids and/or pores of the PIM (e.g., as determined by XRD).

The membrane and/or filter may have any of a variety of suitable thicknesses. Referring, for example, to FIG. 1B, membrane and/or filter 102 has thickness (e.g., maximum thickness) 106a. In some embodiments, the membrane and/or filter has a maximum thickness less than or equal to 200 nanometers, less than or equal to 150 nanometers, less than or equal to 100 nanometers, less than or equal to 75 nanometers, less than or equal to 50 nanometers, less than or equal to 25 nanometers, less than or equal to 20 nanometers, less than or equal to 15 nanometers, less than or equal to 10 nanometers, or less than or equal to 5 nanometers. In certain embodiments, the membrane and/or filter has a maximum thickness greater than or equal to 1 nanometer, greater than or equal to 5 nanometers, greater than or equal to 10 nanometers, greater than or equal to 15 nanometers, greater than or equal to 20 nanometers, greater than or equal to 25 nanometers, greater than or equal to 50 nanometers, greater than or equal to 75 nanometers, greater than or equal to 100 nanometers, or greater than or equal to 150 nanometers. Combinations of the above recited ranges are possible (e.g., the membrane and/or filter has a maximum thickness less than or equal to 200 nanometers and greater than or equal to 1 nanometer, the membrane and/or filter has a maximum thickness less than or equal to 15 nanometers and greater than or equal to 10 nanometers). Other ranges are also possible.

The thickness (e.g., maximum thickness) of the membrane and/or filter may be determined by microscopy techniques such as atomic force microscopy (AFM), scanning electron microscopy (SEM), and/or transmission electron microscopy (TEM).

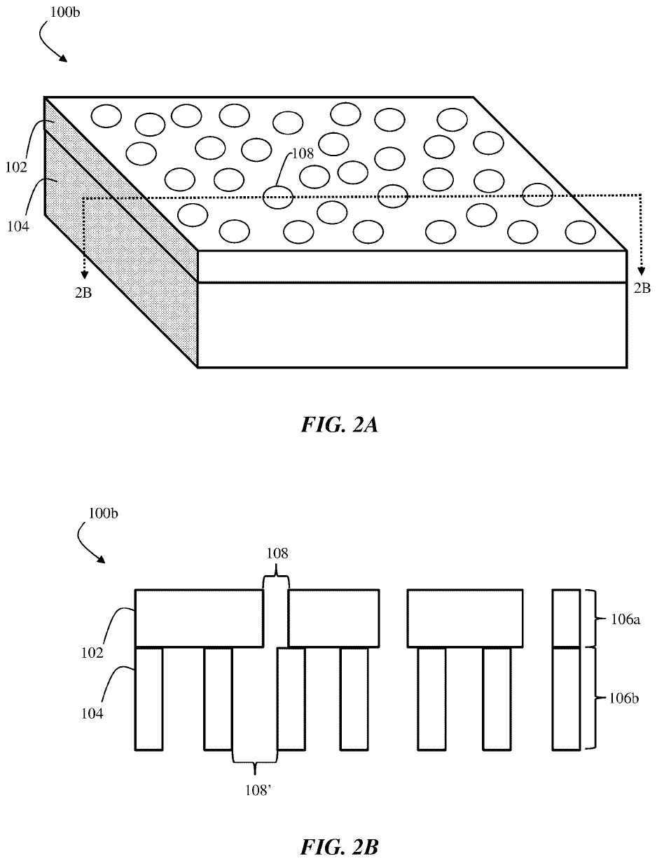

According to certain embodiments, the article further comprises a substrate. FIG. 2A shows, in accordance with certain embodiments, a perspective view schematic diagram of article 100b comprising membrane and/or filter 102 disposed on substrate 104, wherein membrane and/or filter 102 comprises a PIM. FIG. 2B shows, in accordance with certain embodiments, a cross-sectional view schematic diagram of article 100b wherein the cross-section it taken along dotted line 2B shown in FIG. 2A.

In certain embodiments, the membrane and/or filter is disposed on the substrate. According to some embodiments, the substrate advantageously supports the membrane and/or filter, which, as described herein in greater detail, is advantageously thin (e.g., a thickness less than or equal to 25 nanometers). Referring, for example, to FIG. 2A, membrane and/or filter 102 is disposed on substrate 104. According to some embodiments, the membrane and/or filter may be deposited and/or coated on at least one surface of the substrate. In some embodiments, the membrane and/or filter is deposited and/or coated on at least one surface of the substrate during interfacial polymerization, as described herein in greater detail. In other embodiments, the membrane and/or filter is fabricated by interfacial polymerization, as described herein in greater detail, and then transferred to the substrate.

According to some embodiments, the substrate is at least partially porous. In certain embodiments, for example, the substrate comprises a plurality of pores. Referring to FIG. 2B, for example, substrate 104 comprises plurality of pores 108′.

According to some embodiments, a maximum characteristic dimension (e.g., a maximum diameter) of the plurality of pores of the substrate is larger than a maximum characteristic dimension (e.g., a maximum diameter) of the plurality of voids and/or pores of the membrane and/or filter.

The plurality of pores of the substrate may have any of a variety of suitable maximum void and/or pore sizes. In certain embodiments, for example, the plurality of pores of the substrate has a maximum characteristic dimension (e.g., a maximum diameter) less than or equal to 1 micrometer, less than or equal to 0.5 micrometers, less than or equal to 0.1 micrometers, less than or equal to 90 nanometers, less than or equal to 80 nanometers, less than or equal to 70 nanometers, less than or equal to 60 nanometers, less than or equal to 50 nanometers, less than or equal to 40 nanometers, less than or equal to 30 nanometers, or less than or equal to 20 nanometers. In some embodiments, the plurality of pores of the substrate has a maximum characteristic dimension (e.g., a maximum diameter) greater than or equal to 10 nanometers, greater than or equal to 20 nanometers, greater than or equal to 30 nanometers, greater than or equal to 40 nanometers, greater than or equal to 50 nanometers, greater than or equal to 60 nanometers, greater than or equal to 70 nanometers, greater than or equal to 80 nanometers, greater than or equal to 90 nanometers, greater than or equal to 0.1 micrometers, or greater than or equal to 0.5 micrometers. Combinations of the above recited ranges are possible (e.g., the plurality of pores of the substrate has a maximum characteristic dimension less than or equal to 1 micrometer and greater than or equal to 10 nanometers, the plurality of pores of the substrate has a maximum characteristic dimension less than or equal to 70 nanometers and greater than or equal to 60 nanometers). Other ranges are also possible.

The maximum characteristic dimension (e.g., maximum diameter) of the plurality of pores of the substrate may be determined by microscopy techniques such as AFM, SEM, and/or TEM.

The substrate may have any of a variety of suitable thicknesses. Referring, for example, to FIG. 2B, substrate 104 has thickness (e.g., maximum thickness) 106b. In some embodiments, for example, the substrate has a maximum thickness greater than or equal to 1 micrometer, greater than or equal to 10 micrometers, greater than or equal to 50 micrometers, greater than or equal to 100 micrometers, greater than or equal to 500 micrometers, or greater than or equal to 1 millimeter. In certain embodiments, the substrate has a maximum thickness less than or equal to 1 centimeter, less than or equal to 1 millimeter, less than or equal to 500 micrometers, less than or equal to 100 micrometers, less than or equal to 50 micrometers, or less than or equal to 10 micrometers. Combinations of the above recited ranges are possible (e.g., the substrate has a maximum thickness greater than or equal to 1 micrometer and less than or equal to 1 centimeter, the substrate has a maximum thickness greater than or equal to 10 micrometers and less than or equal to 50 micrometers). Other ranges are also possible.

The thickness (e.g., maximum thickness) of the substrate may be determined by microscopy techniques such as AFM, SEM, and/or TEM.

The substrate may comprise any of a variety of suitable materials. In certain embodiments, for example, the substrate comprises polyacrylonitrile (PAN), polysulfone, polyvinylidene fluoride, polyethersulfone, polyethylene, polypropylene, nylon, and/or combinations thereof. Other materials are also possible.

The membrane and/or filter may have any of a variety of suitable molecular weight cutoff (MWCO) values. In certain embodiments, the membrane and/or filter has a MWCO greater than or equal to 200 g/mol, greater than or equal to 300 g/mol, greater than or equal to 400 g/mol, greater than or equal to 500 g/mol, greater than or equal to 600 g/mol, greater than or equal to 700 g/mol, greater than or equal to 800 g/mol, or greater than or equal to 900 g/mol. In some embodiments, the membrane and/or filter has a MWCO less than or equal to 1,000 g/mol, less than or equal to 900 g/mol, less than or equal to 800 g/mol, less than or equal to 700 g/mol, less than or equal to 600 g/mol, less than or equal to 500 g/mol, less than or equal to 400 g/mol, or less than or equal to 300 g/mol. Combinations of the above recited ranges are possible (e.g., the membrane and/or filter has a MWCO greater than or equal to 200 g/mol and less than or equal to 1,000 g/mol, the membrane and/or filter has a MWCO greater than or equal to 600 g/mol and less than or equal to 700 g/mol). Other ranges are also possible.

The MWCO of the membrane and/or filter may be determined by measuring the solute rejection percentage of the membrane and/or filter with solutes of varying molecular weight.

The membrane and/or filter may have any of a variety of suitable solvent permeances. In certain embodiments, for example, the membrane and/or filter has a solvent permeance greater than or equal to 20 LMH/bar, greater than or equal to 30 LMH/bar, greater than or equal to 40 LMH/bar, greater than or equal to 50 LMH/bar, greater than or equal to 60 LMH/bar, greater than or equal to 70 LMH/bar, greater than or equal to 80 LMH/bar, greater than or equal to 90 LMH/bar, greater than or equal to 100 LMH/bar, greater than or equal to 110 LMH/bar, greater than or equal to 120 LMH/bar, greater than or equal to 130 LMH/bar, or greater than or equal to 140 LMH/bar. In some embodiments, the membrane and/or filter has a solvent permeance less than or equal to 150 LMH/bar, less than or equal to 140 LMH/bar, less than or equal to 130 LMH/bar, less than or equal to 120 LMH/bar, less than or equal to 110 LMH/bar, less than or equal to 100 LMH/bar, less than or equal to 90 LMH/bar, less than or equal to 80 LMH/bar, less than or equal to 70 LMH/bar, less than or equal to 60 LMH/bar, less than or equal to 50 LMH/bar, less than or equal to 40 LMH/bar, or less than or equal to 30 LMH/bar. Combinations of the above recited ranges are possible (e.g., the membrane and/or filter has a solvent permeance greater than or equal to 20 LMH/bar and less than or equal to 150 LMH/bar, the membrane and/or filter has a solvent permeance greater than or equal to 80 LMH/bar and less than or equal to 90 LMH/bar) Other ranges are also possible.

The solvent permeance of the membrane and/or filter may be determined using a dead-end filtration cell at room temperature (~23° C.) and calculating the solvent permeance (J, LMH/bar=L m⁻² h⁻¹ bar⁻¹) according to Equation 3 (Eq. 3).

$$J = \frac{Δ V}{A Δ tp} \qquad ( Eq . 3 )$$

where ΔV is the permeated volume at a given time (Δt), A is the effective membrane area, and p is the applied pressure.

The solvent used to determine the solvent permeance of the membrane and/or filter may be any of a variety of suitable solvents. In some embodiments, for example, the solvent comprises water. In certain embodiments, the solvent comprises an organic solvent. For example, in certain embodiments, the organic solvent comprises toluene, methanol, ethanol, acetone, isopropyl alcohol, tetrahydrofuran, dimethylformamide, N-methyl-2-pyrrolidone, chloroform, hexane, heptane, and/or combinations thereof. Other organic solvents are also possible.

The membrane and/or filter may have any of a variety of suitable toluene permeances. In some embodiments, for example, the membrane and/or filter has a toluene permeance greater than or equal to 20 LMH/bar, greater than or equal to 30 LMH/bar, greater than or equal to 40 LMH/bar, greater than or equal to 50 LMH/bar, greater than or equal to 60 LMH/bar, greater than or equal to 70 LMH/bar, greater than or equal to 80 LMH/bar, greater than or equal to 90 LMH/bar, greater than or equal to 100 LMH/bar, greater than or equal to 110 LMH/bar, greater than or equal to 120 LMH/bar, greater than or equal to 130 LMH/bar, or greater than or equal to 140 LMH/bar. In some embodiments, the membrane and/or filter has a toluene permeance less than or equal to 150 LMH/bar, less than or equal to 140 LMH/bar, less than or equal to 130 LMH/bar, less than or equal to 120 LMH/bar, less than or equal to 110 LMH/bar, less than or equal to 100 LMH/bar, less than or equal to 90 LMH/bar, less than or equal to 80 LMH/bar, less than or equal to 70 LMH/bar, less than or equal to 60 LMH/bar, less than or equal to 50 LMH/bar, less than or equal to 40 LMH/bar, or less than or equal to 30 LMH/bar. Combinations of the above recited ranges are possible (e.g., the membrane and/or filter has a toluene permeance greater than or equal to 20 LMH/bar and less than or equal to 150 LMH/bar, the membrane and/or filter has a toluene permeance greater than or equal to 80 LMH/bar and less than or equal to 90 LMH/bar) Other ranges are also possible.

The membrane and/or filter may have any of a variety of suitable methanol permeances. In some embodiments, for example, the membrane and/or filter has a methanol permeance greater than or equal to 50 LMH/bar, greater than or equal to 60 LMH/bar, greater than or equal to 70 LMH/bar, greater than or equal to 80 LMH/bar, greater than or equal to 90 LMH/bar, greater than or equal to 100 LMH/bar, greater than or equal to 110 LMH/bar, greater than or equal to 120 LMH/bar, greater than or equal to 130 LMH/bar, or greater than or equal to 140 LMH/bar. In some embodiments, the membrane and/or filter has a methanol permeance less than or equal to 150 LMH/bar, less than or equal to 140 LMH/bar, less than or equal to 130 LMH/bar, less than or equal to 120 LMH/bar, less than or equal to 110 LMH/bar, less than or equal to 100 LMH/bar, less than or equal to 90 LMH/bar, less than or equal to 80 LMH/bar, less than or equal to 70 LMH/bar, or less than or equal to 60 LMH/bar. Combinations of the above recited ranges are possible (e.g., the membrane and/or filter has a methanol permeance greater than or equal to 50 LMH/bar and less than or equal to 150 LMH/bar, the membrane and/or filter has a methanol permeance greater than or equal to 100 LMH/bar and less than or equal to 110 LMH/bar) Other ranges are also possible.

The membrane and/or filter may have any of a variety of suitable acetone permeances. In some embodiments, for example, the membrane and/or filter has an acetone permeance greater than or equal to 100 LMH/bar, greater than or equal to 110 LMH/bar, greater than or equal to 120 LMH/bar, greater than or equal to 130 LMH/bar, or greater than or equal to 140 LMH/bar. In some embodiments, the membrane and/or filter has an acetone permeance less than or equal to 150 LMH/bar, less than or equal to 140 LMH/bar, less than or equal to 130 LMH/bar, less than or equal to 120 LMH/bar, or less than or equal to 110 LMH/bar. Combinations of the above recited ranges are possible (e.g., the membrane and/or filter has an acetone permeance greater than or equal to 100 LMH/bar and less than or equal to 150 LMH/bar, the membrane and/or filter has a acetone permeance greater than or equal to 120 LMH/bar and less than or equal to 130 LMH/bar) Other ranges are also possible.

The membrane and/or filter may have any of a variety of suitable solute rejection percentages. In certain embodiments, for example, the membrane and/or filter has a solute rejection percentage greater than or equal to 20%, greater than or equal to 30%, greater than or equal to 40%, greater than or equal to 50%, greater than or equal to 60%, greater than or equal to 70%, greater than or equal to 80%, greater than or equal to 90%, greater than or equal to 95%, greater than or equal to 95%, or greater than or equal to 99%. In some embodiments, the membrane and/or filter has a solute rejection percentage less than or equal to 100%, less than or equal to 99%, less than or equal to 95%, less than or equal to 90%, less than or equal to 80%, less than or equal to 70%, less than or equal to 60%, less than or equal to 50%, less than or equal to 40%, or less than or equal to 30%. Combinations of the above recited ranges are possible (e.g., the membrane and/or filter has a solute rejection percentage greater than or equal to 20% and less than or equal to 100%, the membrane and/or filter has a solute rejection percentage greater than or equal to 80% and less than or equal to 90%) Other ranges are also possible.

According to some embodiments, the solute rejection percentage of the membrane and/or filter may be determined by permeating a solute solution through the membrane and/or filter, measuring the solute concentration in the feed (C_{f}) and permeate (Cₚ) using a UV-vis spectrometer, and the calculating the solute rejection percentage (R) according to Equation 4 (Eq. 4):

$$R = ( 1 - \frac{{C}_{p}}{{C}_{f}} ) \times 100 ( \% ) \qquad ( Eq . 4 )$$

In certain embodiments, the solute rejection percentage of the membrane and/or filter depends on the molecular weight of the solute.

The solute may comprise any of a variety of solutes. In some embodiments, for example, the solute comprises a dye, a polymer, an oil, and/or combinations thereof. Other solutes are also possible.

The dye may be any of a variety of suitable dyes. In some embodiments, for example, the dye comprises brilliant blue, acid fuchsin, sudan Black B, methyl orange, chrysoidine G, and/or combinations thereof. Other dyes are also possible.

The polymer may comprise any of a variety of suitable polymers. In some embodiments, for example, the polymer comprises polystyrene and/or an analogue or a derivative thereof. Other polymers are also possible.

The oil may comprise any of a variety of suitable oils. In certain embodiments, for example, the oil comprises lubricant oil. Other oils are also possible.

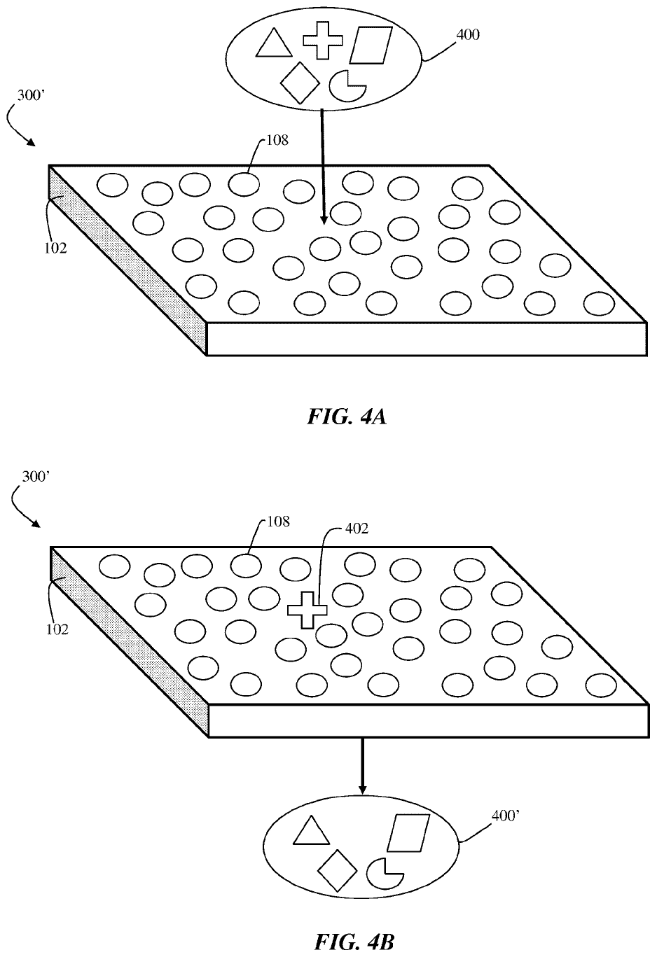

According to some embodiments, a method of separating at least one species from a mixture of species using a membrane and/or filter is described. FIGS. 4A-4B show, in accordance with certain embodiments, schematic diagrams representing method 300′ of separating at least one species 402 from mixture of species 400 using membrane and/or filter 102.

In certain embodiments, the method comprises passing a mixture of species through a membrane and/or filter comprising a PIM. For example, referring to FIG. 4A, method 300′ comprises passing mixture of species 400 through membrane and/or filter 102.

According to some embodiments, the method comprises separating at least one species from the mixture of species. Referring, for example, to FIG. 4B, method 300′ comprises separating at least one species 402 from mixture of species 400′.

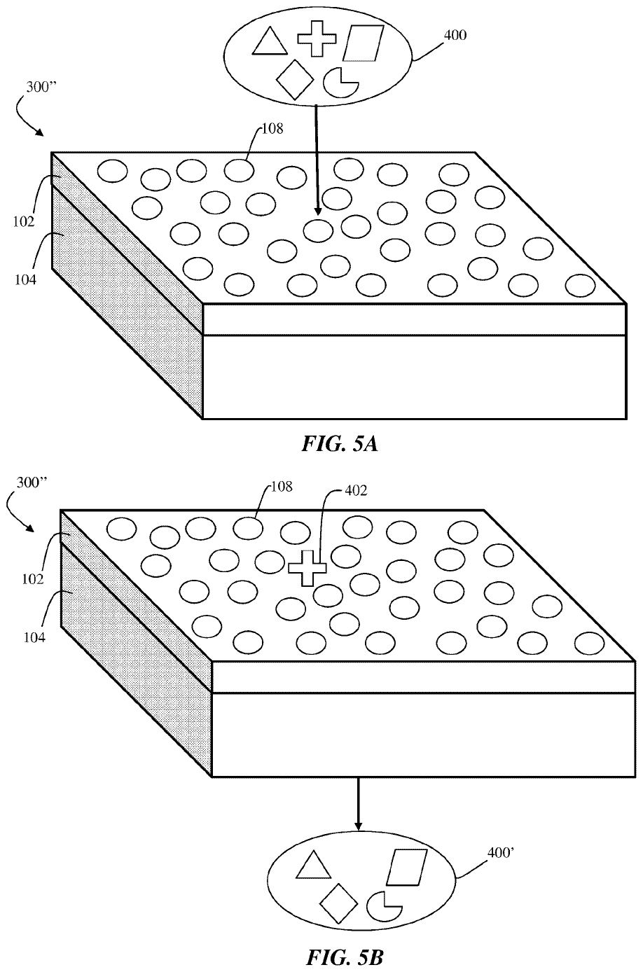

In certain embodiments, a method of separating at least one species from a mixture of species using a membrane and/or filter disposed on a substrate is described. FIGS. 5A-5B show, in accordance with certain embodiments, schematic diagrams representing method 300″ of separating at least one species 402 from mixture of species 400 using membrane and/or filter 102 disposed on substrate 104.

In certain embodiments, the method comprises passing a mixture of species through a membrane and/or filter comprising a PIM, wherein the membrane and/or filter is disposed on a substrate. For example, referring to FIG. 5A, method 300″ comprises passing mixture of species 400 through membrane and/or filter 102, wherein membrane and/or filter 102 is disposed on substrate 104.

According to some embodiments, the method comprises separating at least one species from the mixture of species. Referring, for example, to FIG. 5B, method 300″ comprises separating at least one species 402 from mixture of species 400′.

The mixture of species and the at least one species separated from the mixture of species may comprise any of a variety of species. In certain embodiments, the mixture of species comprises a mixture of solvents (e.g., at least two solvents) and the at least one species separated from the mixture of species comprises at least one solvent. In some embodiments, for example, the mixture of species comprises a mixture of water and/or organic solvents and the at least one species separated from the mixture of species comprises water and/or at least one organic solvent.

The mixture of solvents may comprise any of a variety of suitable solvents. In some embodiments, for example, the mixture of solvents comprises at least two of water, toluene, methanol, ethanol, acetone, isopropyl alcohol, tetrahydrofuran, dimethylformamide, N-methyl-2-pyrrolidone, chloroform, hexane, heptane, and/or combinations thereof. Other solvents are also possible.

In some embodiments, the at least one solvent separated from the mixture of solvents comprises water, toluene, methanol, ethanol, acetone, isopropyl alcohol, tetrahydrofuran, dimethylformamide, N-methyl-2-pyrrolidone, chloroform, hexane, heptane, and/or combinations thereof. Other solvents are also possible.

According to some embodiments, the mixture of species comprises a mixture of at least one solvent and at least one solute and the at least one species separated from the mixture of species comprises at least one solute.

The mixture of at least one solvent and at least one solute may comprise any of a variety of suitable solvents and/or solutes. In some embodiments, the mixture of at least one solvent and at least one solute comprises water, toluene, methanol, ethanol, acetone, isopropyl alcohol, tetrahydrofuran, dimethylformamide, N-methyl-2-pyrrolidone, chloroform, hexane, heptane, and/or combinations thereof. Other solvents are also possible. In certain embodiments, the mixture of at least one solvent and at least one solute comprises a dye, a polymer, an oil, and/or combinations thereof. Other solutes are also possible.

In certain embodiments, the at least one solute separated from the at least one solvent and at least one solute comprises a dye, a polymer, an oil, and/or combinations thereof. Other solutes are also possible.

The dye may be any of a variety of suitable dyes. In some embodiments, for example, the dye comprises brilliant blue, acid fuchsin, sudan Black B, methyl orange, chrysoidine G, and/or combinations thereof. Other dyes are also possible.

The polymer may comprise any of a variety of suitable polymers. In some embodiments, for example, the polymer comprises polystyrene and/or an analogue or a derivative thereof. Other polymers are also possible.

The oil may comprise any of a variety of suitable oils. In certain embodiments, for example, the oil comprises lubricant oil. Other oils are also possible.

According to certain embodiments, the compositions, articles, and methods described herein may be used in any of a variety of suitable applications. In some embodiments, for example, the compositions, articles, and methods described herein may be used in organic solvent nanofiltration (OSN) and/or organic solvent reverse osmosis (OSRO). In certain embodiments, the compositions, articles, and method described herein are used in solvent recovery, desalination, gas separation, fractionation of molecules, separation of catalysts, the purification of active pharmaceutical ingredients (APIs), redox flow batteries, and/or crude oil fractionation. Other applications are also possible.

U.S. Provisional Patent Application No. 63/482,454, filed Jan. 31, 2023, and entitled “Highly Microporous Polymer Nanofilms by Interfacial Polymerization of Rigid Units for Ultrafast Organic Solvent Nanofiltration” is incorporated herein by reference in their entirety for all purposes.

The following example is intended to illustrate certain embodiments of the present invention, but does not exemplify the full scope of the invention.

### Example 1

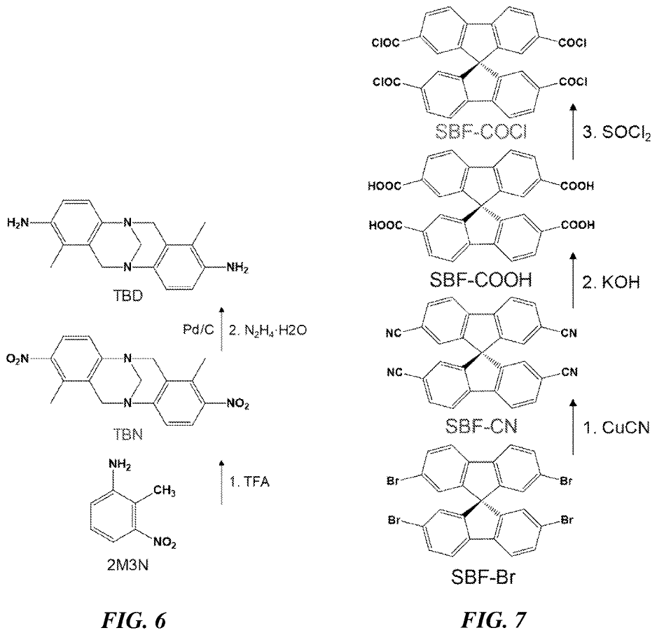

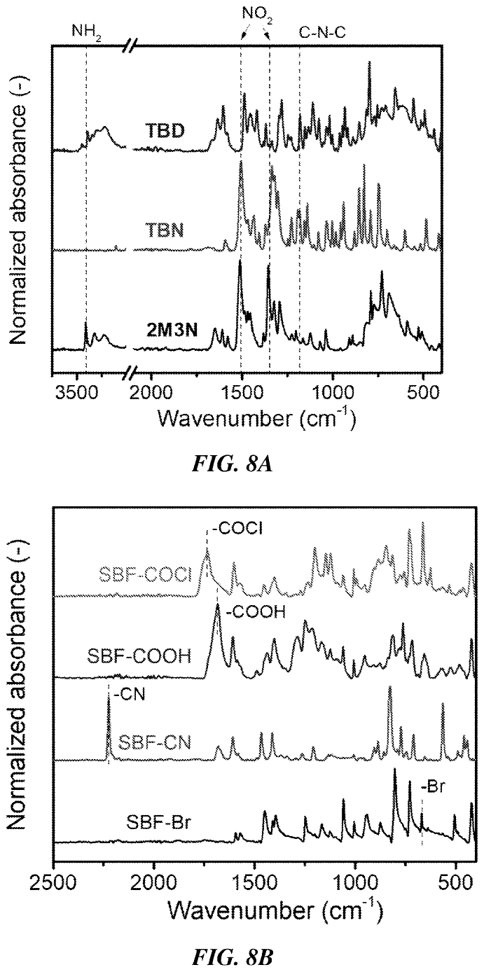

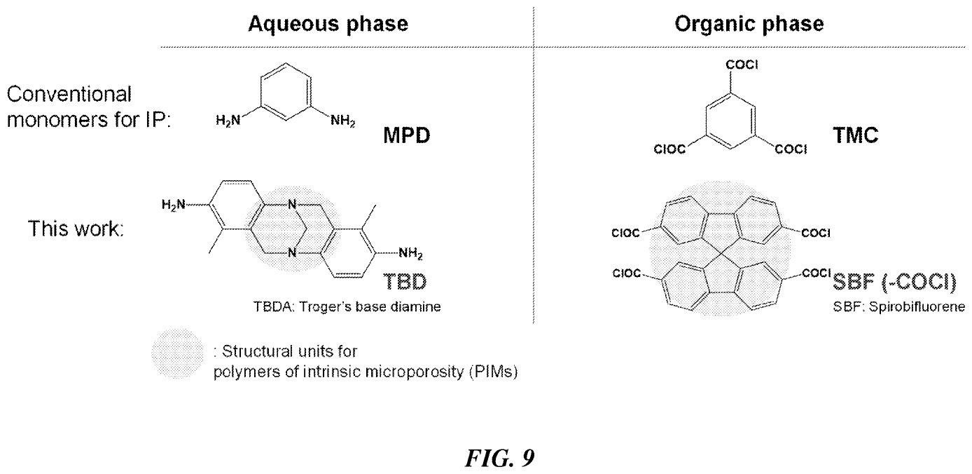

Disclosed herein is a method to develop highly microporous, ultrafast thin-film composite (TFC) organic solvent nanofiltration (OSN) membranes by interfacial polymerization (IP) of rigid units in both aqueous and organic phases. As a proof of concept, two rigid structural units, Tröger's base diamine (TBD) and spirobifluorene acyl chloride (SBF-COCl), were synthesized by following the schemes shown in FIGS. 6-7. Fourier-transform infrared (FT-IR) spectra confirmed the successful synthesis of the molecules (see FIGS. 8A-8B). Four different polyamide TFC membranes were fabricated by IP of four monomer candidates; m-phenylenediamine (MPD)-trimesoyl chloride (TMC), TBD-TMC, MPD-spirobifluorene (SBF), and TBD-SBF (see FIG. 9).

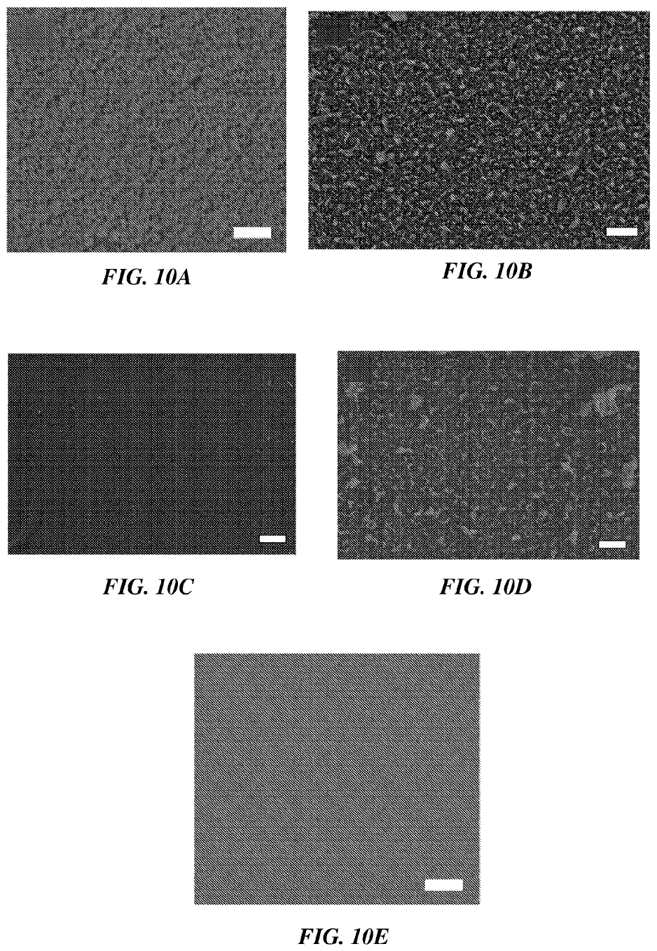

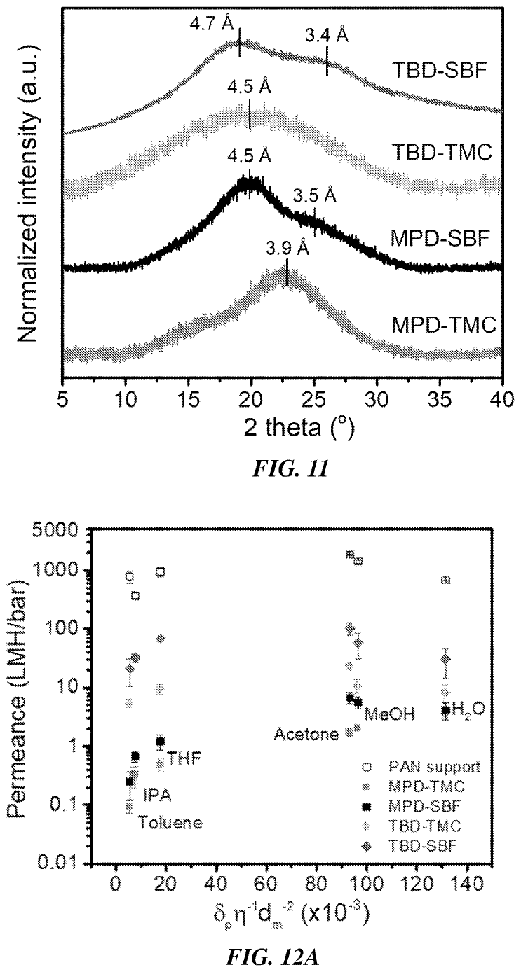

After IP, SEM surface image analyses revealed that the pores of the polyacrylonitrile (PAN) support were fully covered by each coating layer for all polyamide TFC membranes (see FIGS. 10A-10E). A lower surface roughness of the TBD-series than that of the MPD-series is attributed to the lower diffusion rate of the bulkier TBD as compared to MPD molecules. To investigate the average pore sizes of the prepared membranes, X-ray diffraction (XRD) analyses of each polyamide bulk powders were performed (see FIG. 11). Polyamides formed by either TBD or SBF exhibited a larger d-spacing compared to the control MPD-TMC, which indicates their enhanced average micropore sizes. In particular, the polyamide containing only rigid units (i.e., TBD-SBF) showed the largest d-spacing, implying that TBD-SBF possesses the highest microporosity. Of note, the XRD patterns of MPD-SBF and TBD-SBF exhibited two peaks. The peaks at d-spacings of ~3.5 Å for MPD-SBF and TBD-SBF are assigned to π-π stacking between SBF monomers with four aromatic rings. This submicroporosity (<4 Å) is expected to contribute to enhanced selectivity despite the larger pore sizes for MPD-SBF and TBD-SBF.

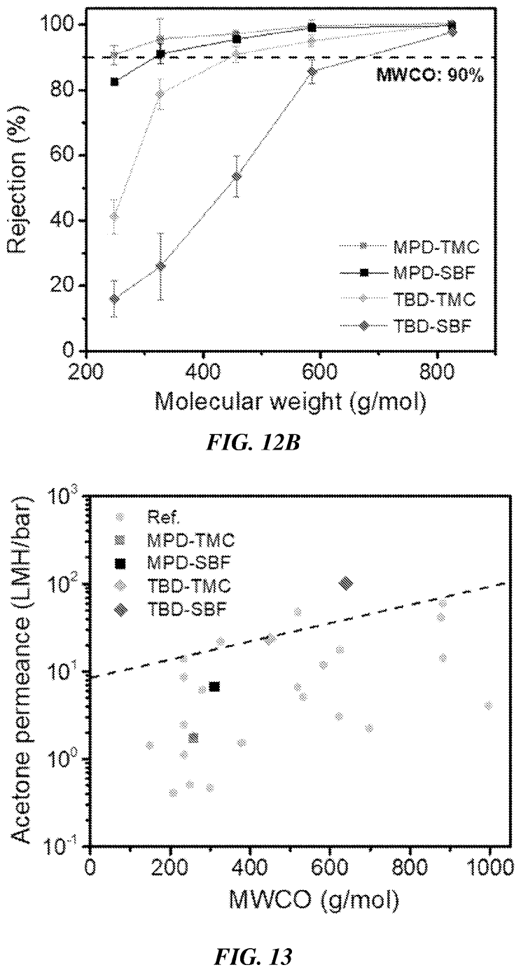

Pure solvent permeances of the prepared TFC membranes were evaluated by a dead-end filtration device at 20 bar and room temperature (see FIG. 12A). Compared to the conventional MPD-TMC membrane, the TFC membranes containing rigid units showed significant improvement in permeance depending on solvent properties. Notably, TBD-SBF showed the highest solvent permeance (e.g., toluene permeance=~21 LMH bar, which is ~300 times higher than that of MPD-TMC (~0.07 LMH/bar)). Dye rejection tests revealed that the MWCO of TBD-SBF is also high (~640 g/mol), which is attributed to its highest average pores size as revealed by XRD analyses (see FIG. 12B). Nevertheless, TBD-SBF outperforms all reported polymer membranes at a similar range of MWCO by showing the highest acetone permeance (~100 LMH/bar) (see FIG. 13). These results successfully demonstrate that preparing polyamide TFC membranes by IP of rigid monomer units can develop ultrafast OSN membranes.

### Example 2

Separation and purification are important in petrochemical, chemical, and pharmaceutical industries, which currently rely on energy-intensive thermal-based processes that account for 10-15% of the US energy consumption. Membrane separations are a promising alternative because of their high energy efficiency, operational simplicity, and small footprint. Recently, research on membrane-based molecular separations has grown rapidly in response to the discovery of opportunities in organic solvent nanofiltration (OSN, 200 to 1000 g mol⁻¹) and organic solvent reverse osmosis (OSRO, <200 g mol⁻¹), including solvent exchange, purification of active pharmaceutical ingredients, catalyst recovery, and crude oil separation. However, the emergence of these applications also comes with the need for materials with high permeance at a targeted molecular weight cut-off (MWCO), long-term stability, and high scalability.

Microporous materials are of particular interest to the field owing to their abundant micropores of less than 2 nm that provide the capability of separating closely sized molecules. Metal-organic frameworks (MOFs), covalent organic frameworks (COFs), porous organic cages (POCs), and conjugated microporous polymers (CMPs) are examples that have shown significant potential in precise molecular sieving, especially for organic solvent separations. However, up-scaling these materials remains a challenge. Solution-processable microporous polymers such as polymers of intrinsic microporosity (PIMs) can be easily manufactured into a large-area membrane by roll-to-roll coating. As the archetypal PIM, PIM-1 contains a contorted spirobisindane (SBI) unit that generates high free volume, which is responsible for the relatively high solvent permeability of PIM-1 membranes compared to the conventional crosslinked polyimide membranes. Nevertheless, the high solution processibility of PIM-1 is linked to poor solvent stability (i.e., swelling and dissolution), which has limited the application of PIM-1 in OSN/OSRO. Moreover, attempts at further enhancing the solvent permeance of PIM-1 by forming thin films that are less than 100 nm thick have led to a reduction in permeance due to the accelerated structural relaxation in polymer thin films.

Inspired by the industrial success in water purification, thin-film composite (TFC) membranes prepared by in situ interfacial polymerization have been explored for OSN/OSRO applications to leverage solvent resistance from the crosslinked structure along with good scalability. However, conventional polyamide chemistry has limited solvent permeance perhaps due to its hydrophilic nature and tight free-volume architecture. To address this issue, microporous polyarylate membranes containing rigid and contorted units (e.g., SBI) were previously prepared by interfacial polymerization, which exhibited excellent liquid and gas separation performance in terms of both permeance and selectivity. Other previous studies have exploited triptycene, biphenol, and macrocycles as novel monomers for interfacial polymerization to enhance the microporosity in the resultant polymer nanofilms. Nevertheless, these membranes are often limited by the trade-off relationship between solvent permeance and solute rejection, hence they are overshadowed by state-of-the-art membrane materials with crystalline and well-defined micropores.

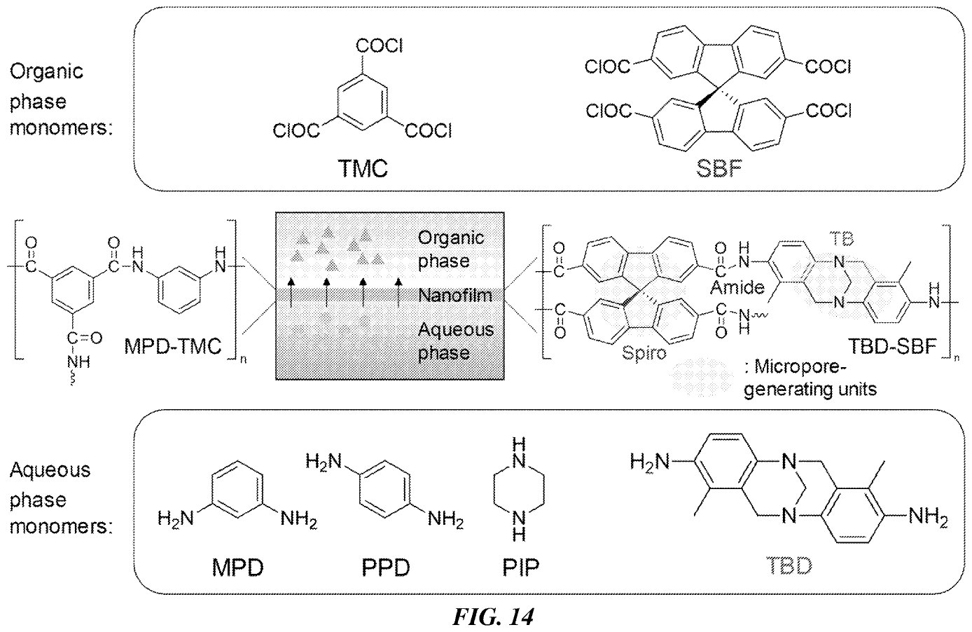

To overcome the current limits of polymeric membranes for organic solvent separations, proposed herein is a dual-phase molecular engineering strategy to prepare highly microporous polymer membranes through interfacial polymerization. This strategy includes two distinct approaches based, for example, on the monomer library shown in FIG. 14: (i) incorporating micropore-generating units (i.e., PIM units) in both aqueous and organic phases; and (ii) exploiting the isomeric effects of aqueous phase monomers to maximize the microporosity of polymer nanofilms. Each approach enabled the development of advanced TFC membranes with ultrahigh solvent permeance for OSN and OSRO applications, respectively, as supported by experimental characterization and molecular simulations.

### Monomer Design

PIM units are generally hydrophobic and insoluble in water since they are mostly comprised of aromatic rings, which is the main challenge in the concept of dual-phase microporous polymers through interfacial polymerization. To tackle this issue, an aqueous diamine monomer inspired by Tröger's base chemistry was designed. Tröger's base is a V-shaped bridged bicyclic linking group, which shows a higher rigidity compared to the SBI unit in PIM-1. More importantly, the nitrogen groups in Tröger's base can be protonated under acidic conditions, which may promote its solubility in water. Tröger's base diamine (TBD) was synthesized and confirmed for its high solubility in acidic water of more than 2 w/v % as expected (see Methods, below, and FIGS. 6, 8A, and 19). The high solubility of TBD in water allowed for the preparation of TBD-based polyamide by reacting the TBD unit in the aqueous phase with the organic phase monomers via interfacial polymerization.

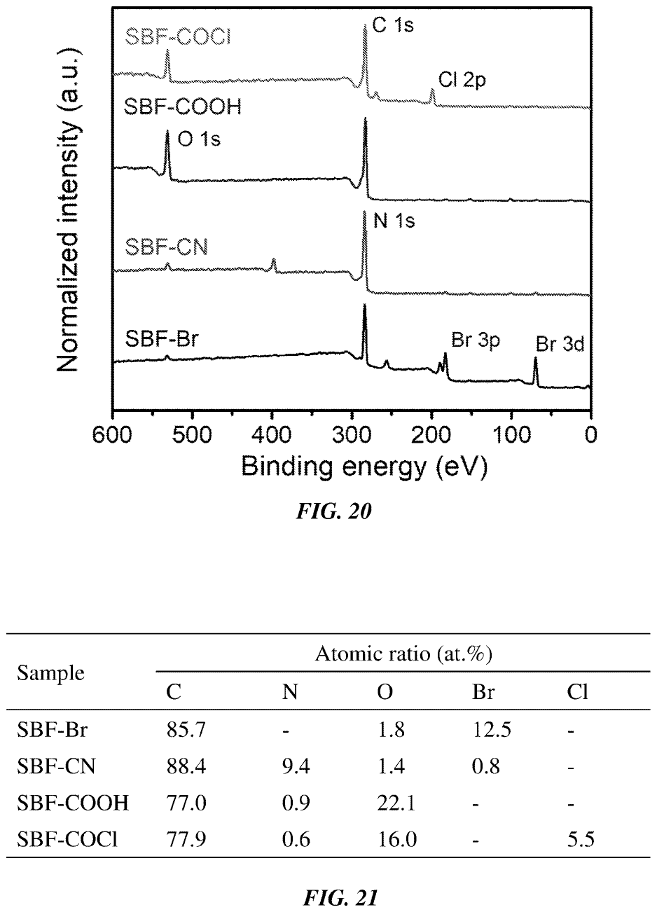

Spirobifluorene (SBF) is a spiro-fused π-conjugated-system, which has also been used as a building block to design PIMs. As with Tröger's base, it has higher rigidity than the SBI unit constituting PIM-1. A resultant PIM-SBF membrane exhibited ultrahigh gas permeabilities with enhanced molecular sieving properties compared to PIM-1. In addition, the abundant aromatic rings in the SBF unit can allow them to be self-assembled by π-π stacking. For example, N-aryl-linked spirocyclic polymers (e.g., SBAD-1) containing SBF units were previously reported to have improved swelling resistance compared to PIM-1 because of the more efficient chain packing and non-interconnected micropores. This motivated the adoption of the SBF chemistry as an organic phase monomer to form crosslinked polyamides. The SBF monomer functionalized with acyl chloride (—COCl) was synthesized from a commercially available tetrabromo-SBF, and the product was confirmed by ¹H/¹³C nuclear magnetic resonance (NMR) spectroscopy, Fourier-transform infrared (FT-IR) analyses, and x-ray photoelectron spectroscopy (XPS) (see Methods, below, and FIGS. 7, 8B, and 20-21).

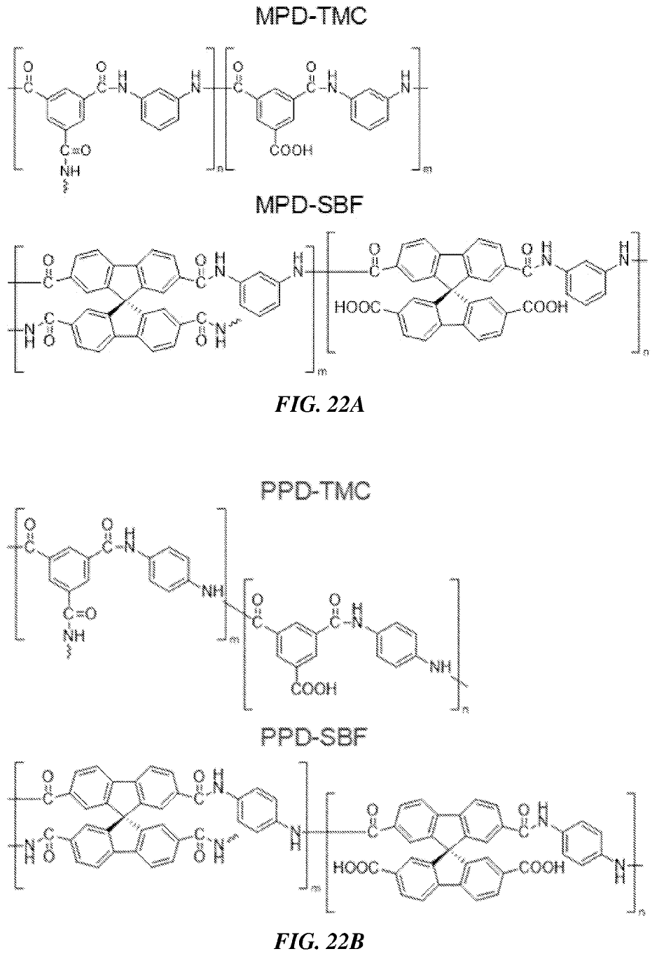

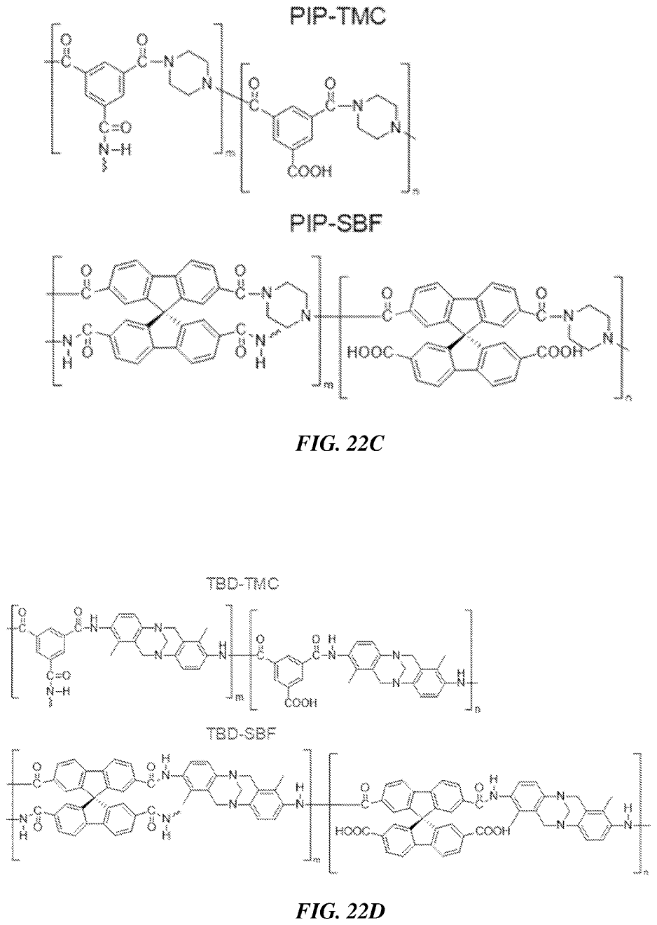

In addition to those two PIM units selected herein (i.e., TBD and SBF), m-phenylenediamine (MPD), p-phenylenediamine (PPD), piperazine (PIP), and trimesoyl chloride (TMC) were also selected as diamine and acyl chloride monomers, and each polyamide was named by the monomers dissolved in each aqueous and organic phase (e.g., MPD-TMC and TBD-SBF, see FIGS. 14 and 22A-22D).

### Unprecedentedly High Microporosity of TBD-SBF Polyamide

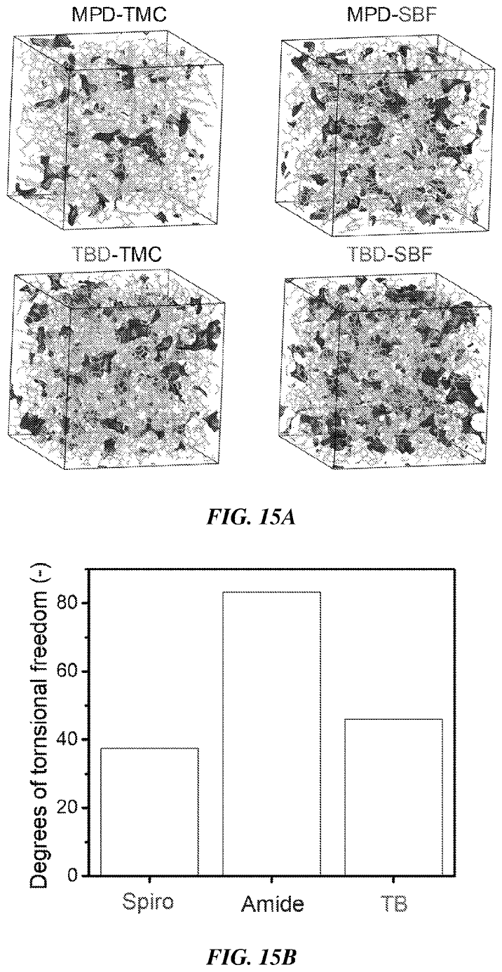

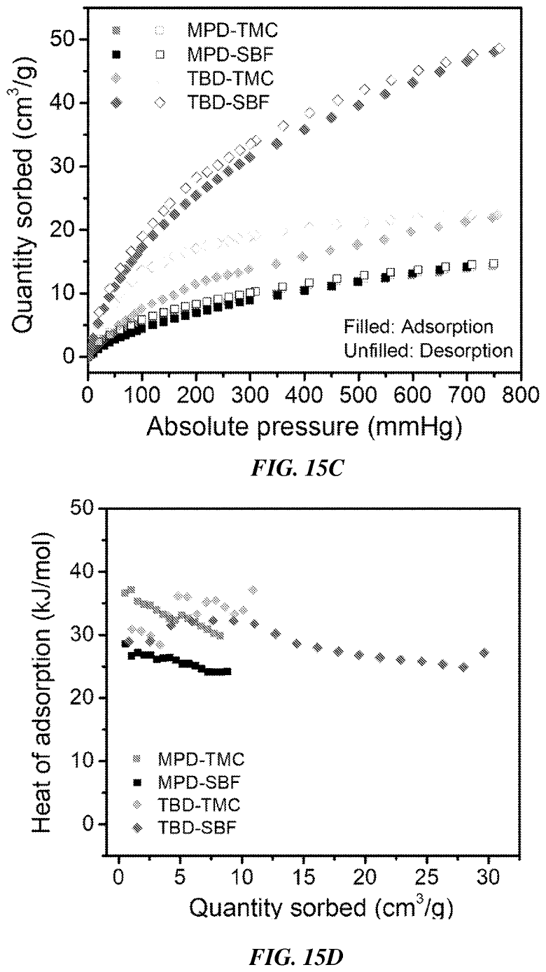

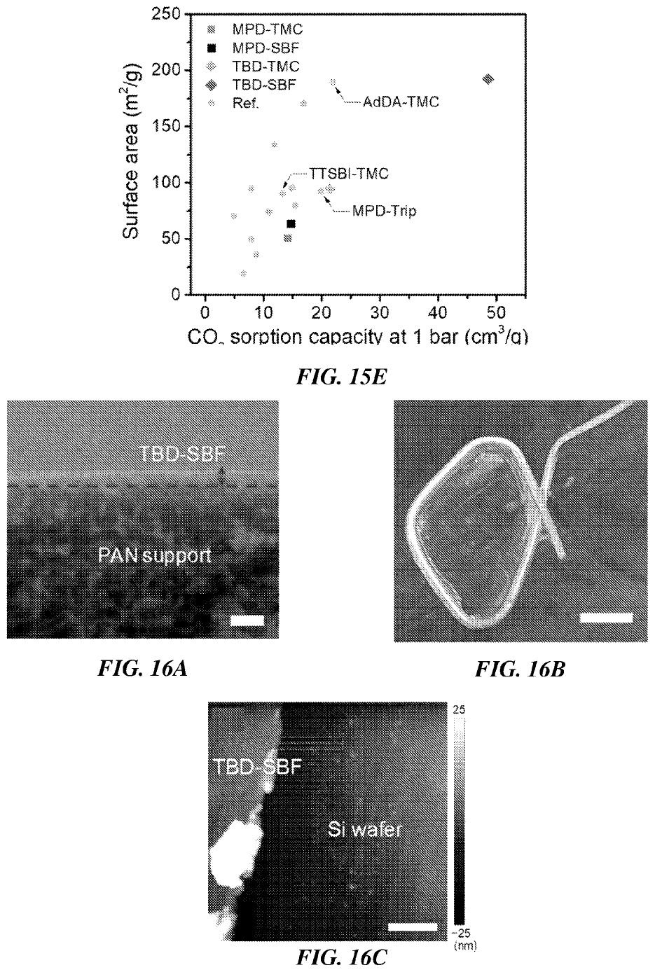

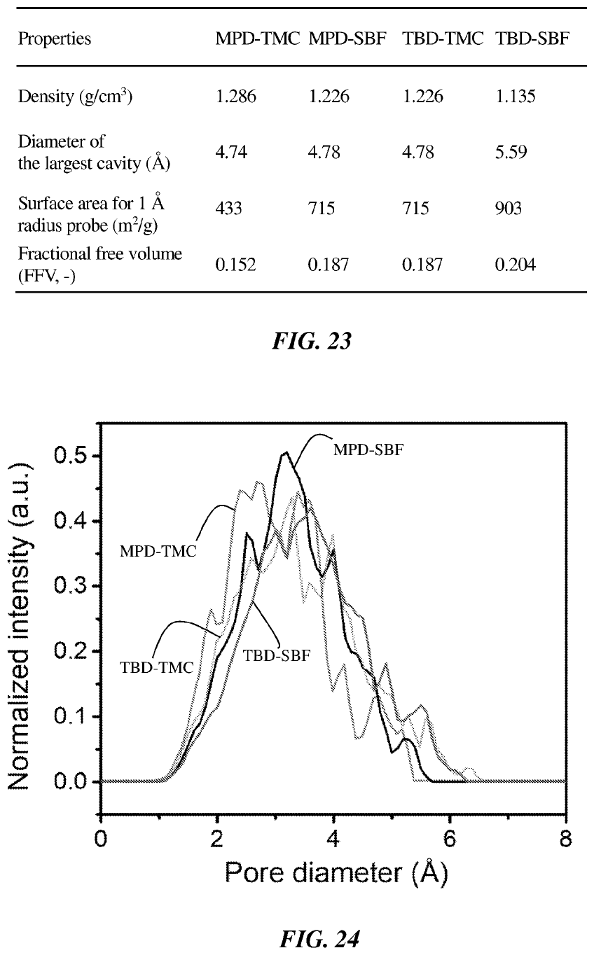

Starting with the first approach, molecular simulations of the polyamides were performed by all-atomistic methods to gain insight into the impact of the PIM units on the polyamide packing structure (see Methods, below). As a control, the structural properties of the polyamides with conventional chemistry (i.e., MPD-TMC) were simulated and each MPD and TMC monomer was sequentially replaced with TBD and SBF monomer, respectively. The results revealed that the PIM unit could significantly improve the fractional free volume (FFV) and the pore size of the polyamides (see FIGS. 15A and 23). Notably, these effects were maximized in TBD-SBF polyamide by featuring the highest FFV (0.204) and the largest pore size (5.59 Å) among the investigated polyamides, while the control MPD-TMC polyamide showed the lowest FFV (0.152) and the smallest pore size (4.74 Å). Simulated pore size distributions support these findings and suggest an overall shift in the free volume distribution curves to larger average pore size for polyamides consisting of either TBD or SBF unit (see FIG. 24). These enhancement effects in microporosity are ascribed to the high rigidity of both SBF and TBD units compared to the relatively flexible amide linkages (see FIG. 15B).

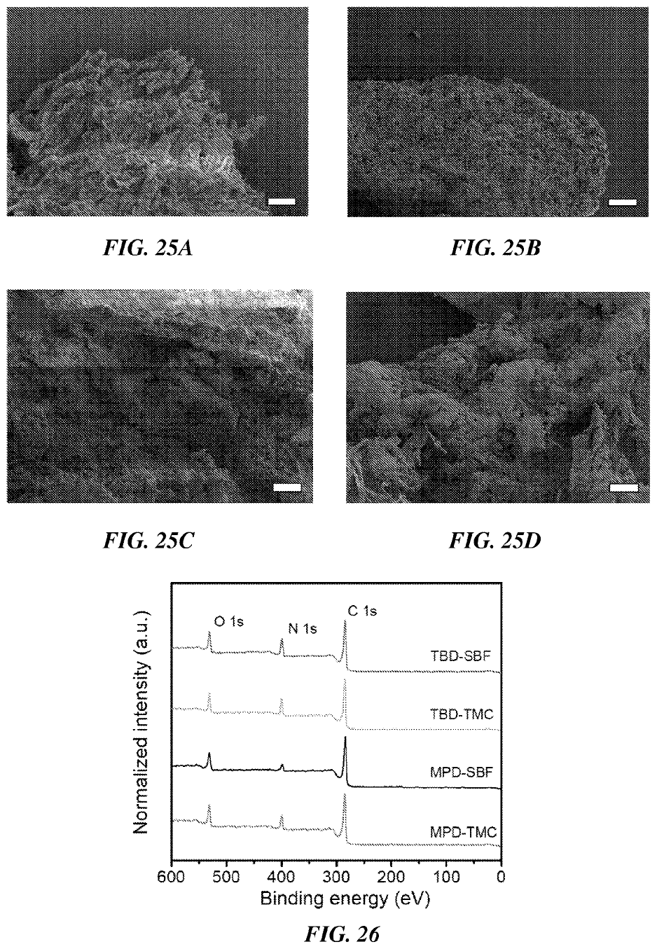

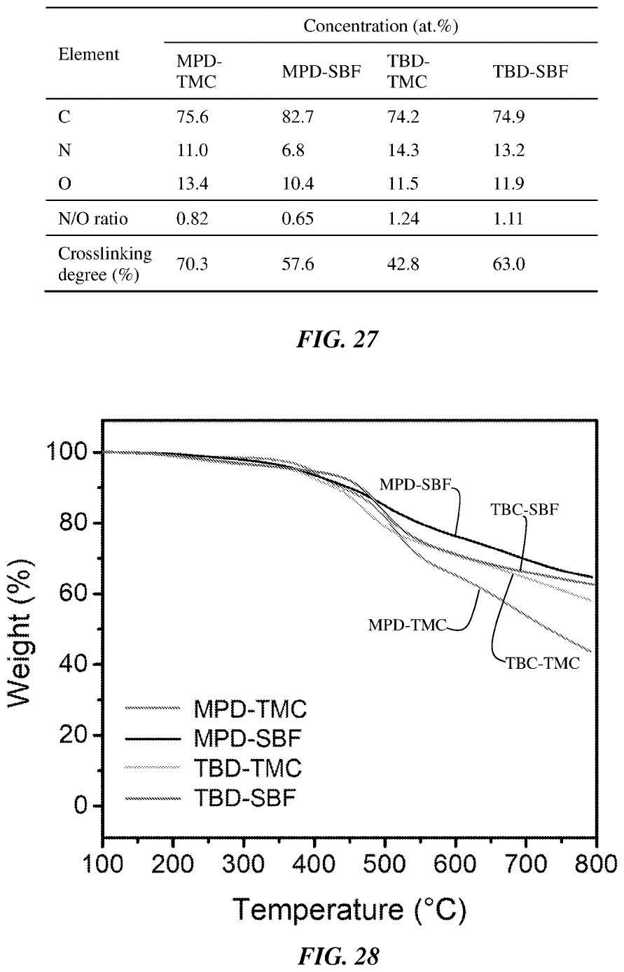

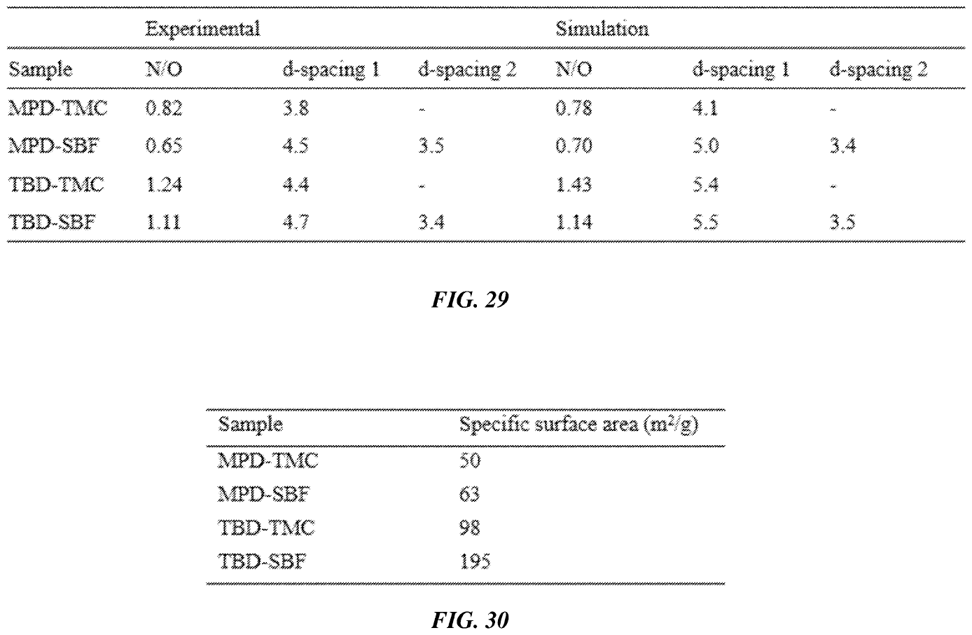

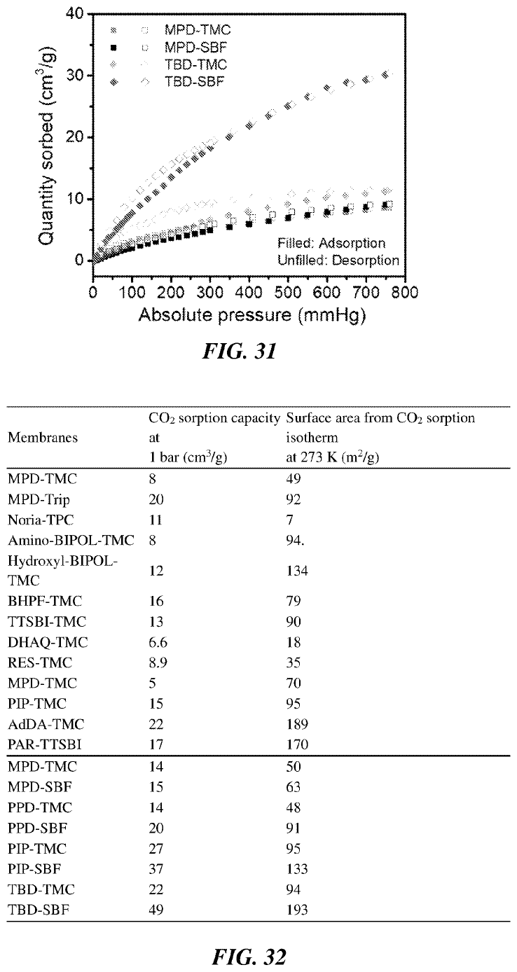

To experimentally investigate the microstructures, polyamide powders were synthesized by interfacial polymerization in a reactor with rigorous stirring. The prepared powders exhibited excellent thermal stability up to ~400° C. and a crosslinking degree comparable with that used for simulations (see Methods, below, and FIGS. 25A-27). The average pore sizes of the polyamides were determined from the d-spacing of their x-ray diffraction (XRD) peaks (see FIG. 11). Starting from MPD-TMC (3.9 Å), substituting MPD to TBD or TMC to SBF showed a significant increase in the average pore size (TBD-TMC and MPD-SBF, 4.5 Å), and substituting both monomers to TBD and SBF increased the pore size even more (TBD-SBF, 4.7 Å). Of note, a new XRD peak at 2θ of ~25.5° was observed for MPD-SBF and TBD-SBF polyamides, which is assigned to the distance between the π-π stacking of aromatic rings (~3.5 Å). The peak positions are consistent with the XRD data obtained by molecular simulation (see FIG. 29).

The surface areas of polyamides were calculated from their CO₂ sorption isotherms at 273 K using the Langmuir model (see FIGS. 15C and 30). The similar range of isosteric heat of adsorption (~30-40 KJ/mol) safely excludes the effects of specific interactions between the polyamide and the CO₂ probes (see FIG. 15D). In accordance with the FFV and XRD results, the PIM units could significantly enhance the surface area of the polyamides. Although different assumptions and models make it difficult to directly compare the surface area (see Methods, below), TBD-SBF showed the highest CO₂ sorption capacity at 1 bar and 273 K (49 cm³/g) with an ultrahigh surface area (195 m²/g) among the polymers prepared by interfacial polymerization including this work and reported data which investigated the effects of PIM units in only single-phase based on MPD-TMC chemistry (e.g., MPD-Trip, TTSBI-TMC, and AdDA-TMC, see FIG. 32), proving its unprecedentedly high microporosity (see FIG. 15E). Clearly, the above results demonstrate that the concept of dual-phase PIM units can maximize the microporosity of interfacially polymerized membranes.

### Ultrafast Molecular Separation Through TBD-SBF Membrane

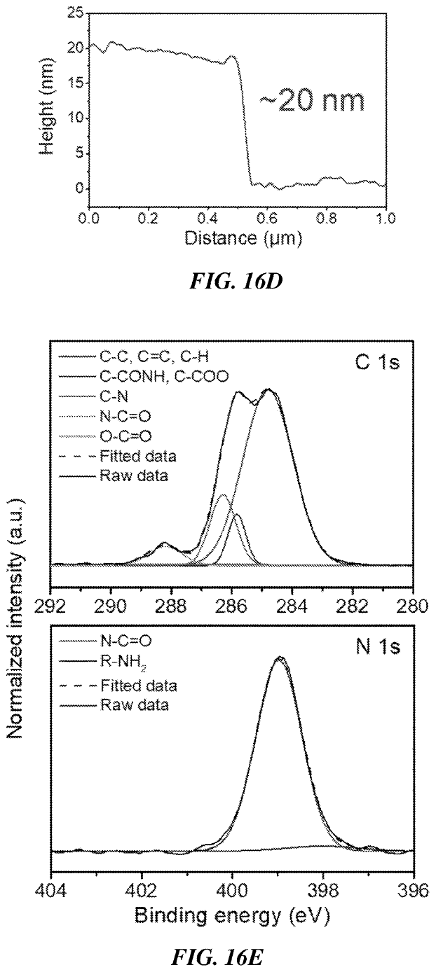

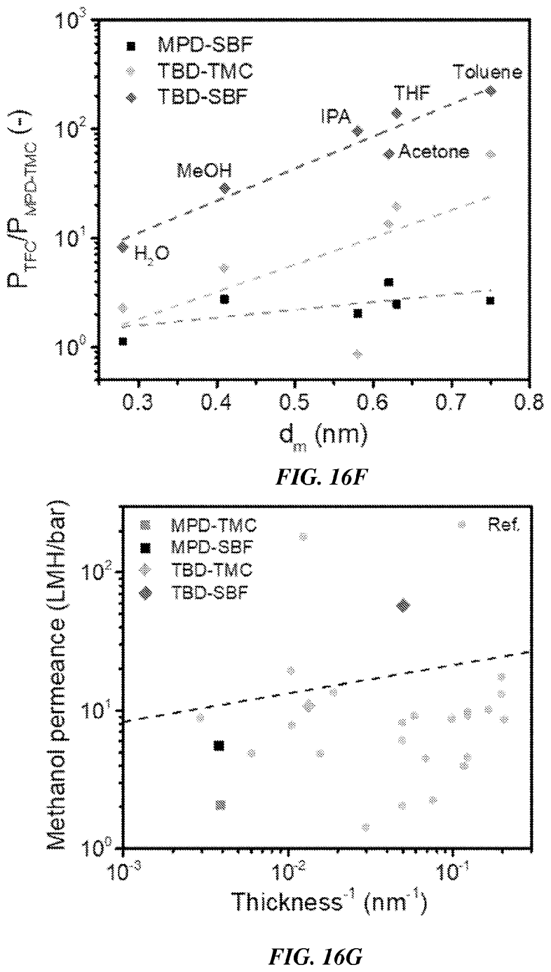

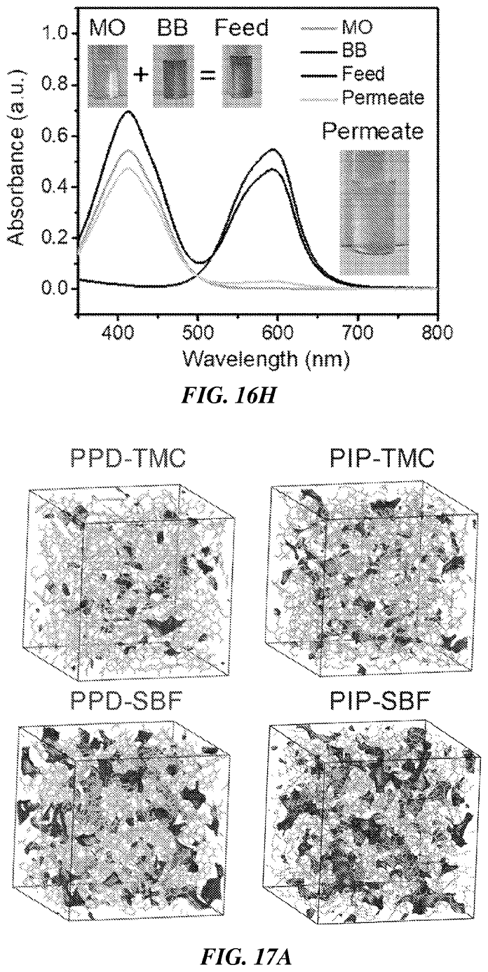

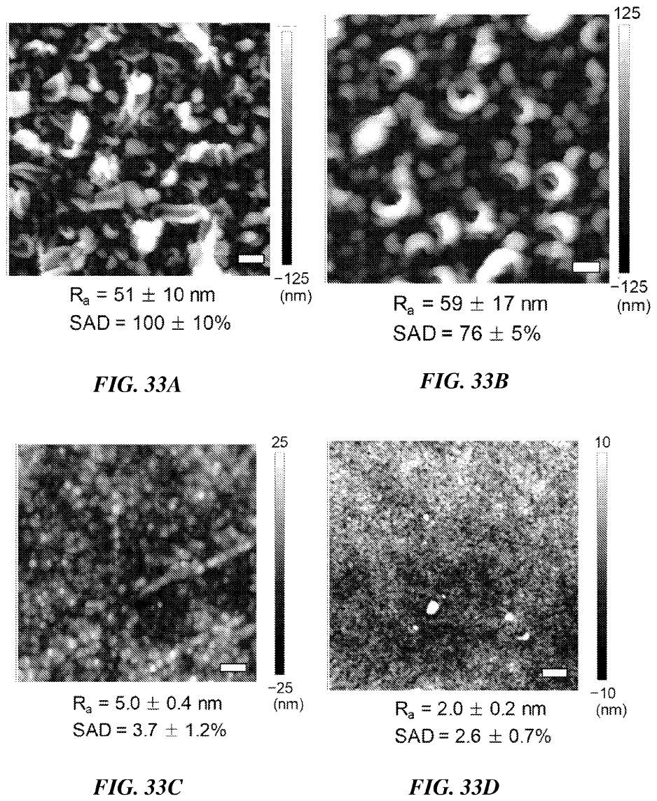

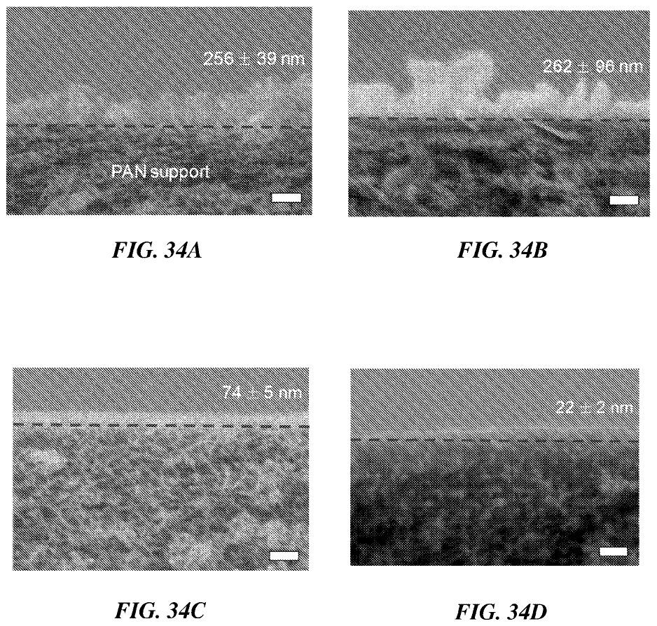

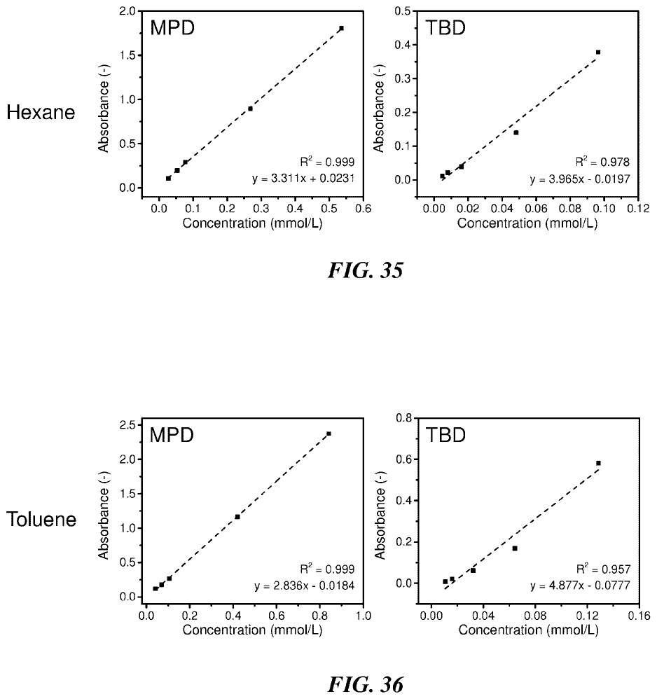

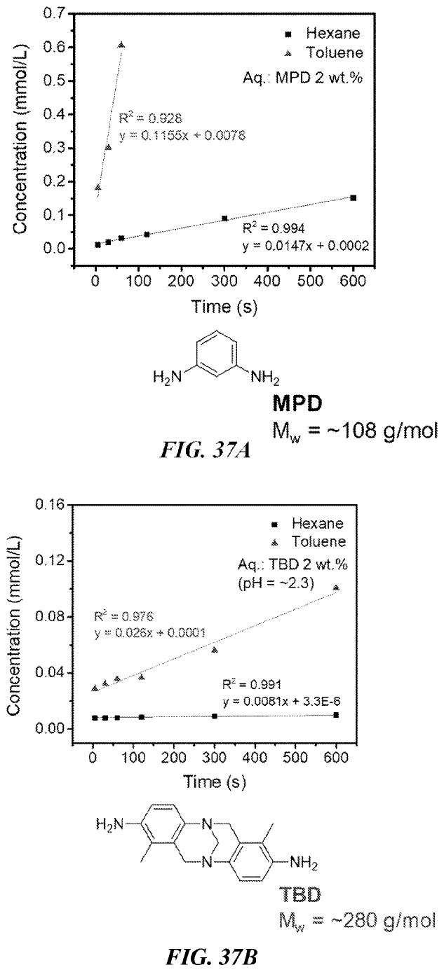

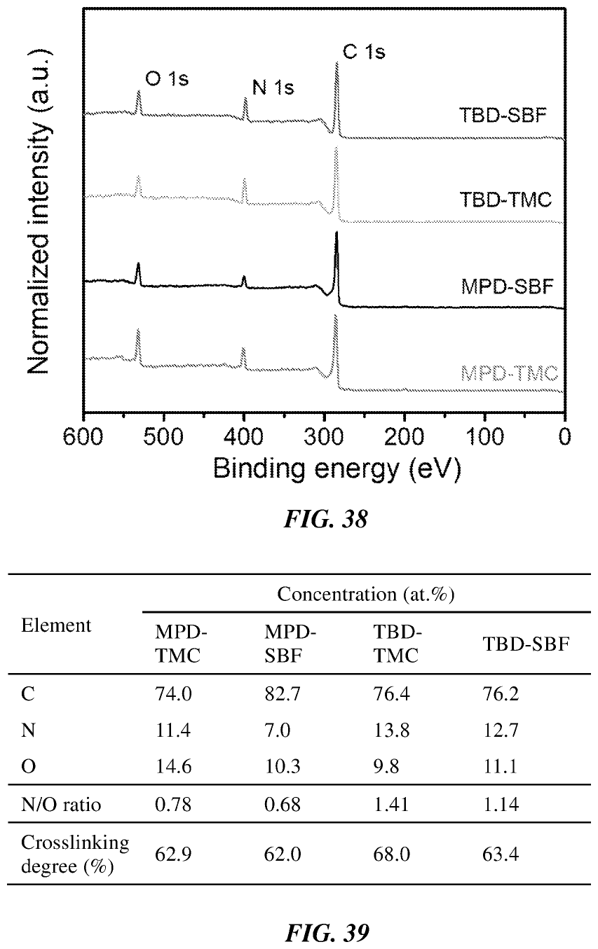

Polyamide TFC membranes were prepared by in situ interfacial polymerization of diamine and acyl chloride monomers onto a porous polyacrylonitrile (PAN) support, confirmed by microscopy images (see FIGS. 10A-10E, 16A, and 33A-34D). The nanofilm was mechanically robust enough to transfer onto a Si wafer by a wire loop (see FIG. 16B). Atomic force microscopy (AFM) analysis reveals the thickness of the film is ~20 nm (see FIGS. 16C-16D), consistent with the cross-sectional scanning electron microscope (SEM) image. The ultrathin thickness of TBD-based TFC membranes may originate from the lower diffusion rate of bulkier TBD molecules than MPD (see Methods, below, and FIGS. 35-37B). The crosslinking degree of TBD-TMC and TBD-SBF was 68.0% and 63.4% (estimated by XPS elemental analysis), respectively, which is comparable with that of MPD-TMC and MPD-SBF (see FIG. 39). High-resolution XPS spectra also confirmed the crosslinked TBD-SBF structure by revealing amide bonds (N—C═O), unreacted carbonyl groups (O—C═O), and a subtle portion of unreacted amine (R—NH₂) (see FIG. 16E).

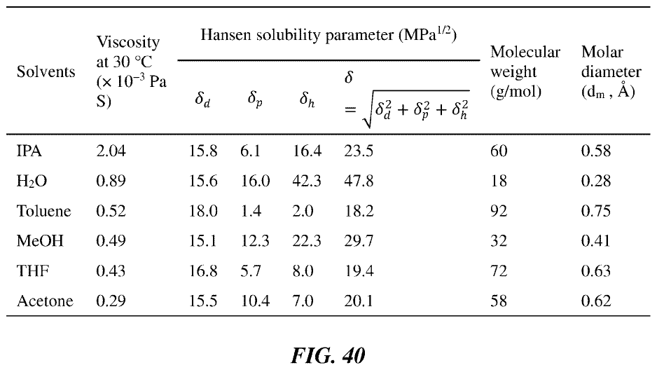

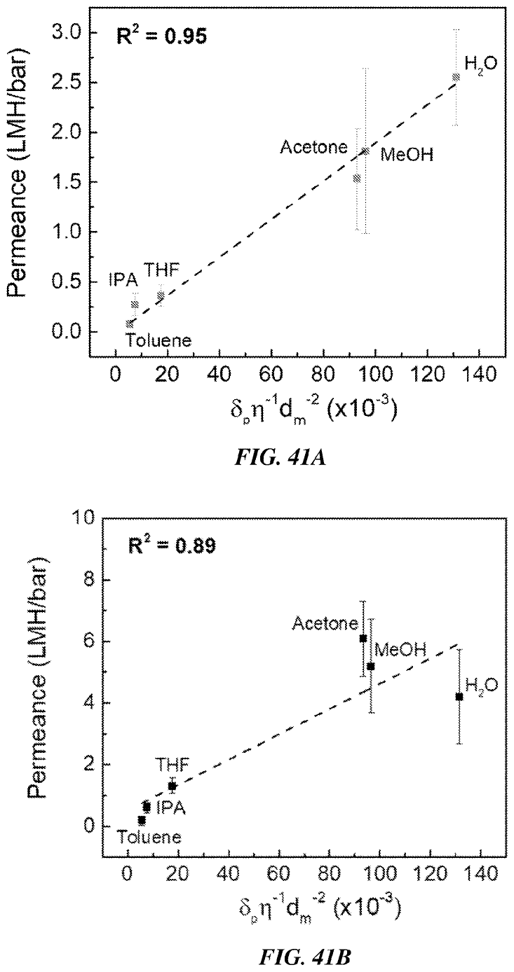

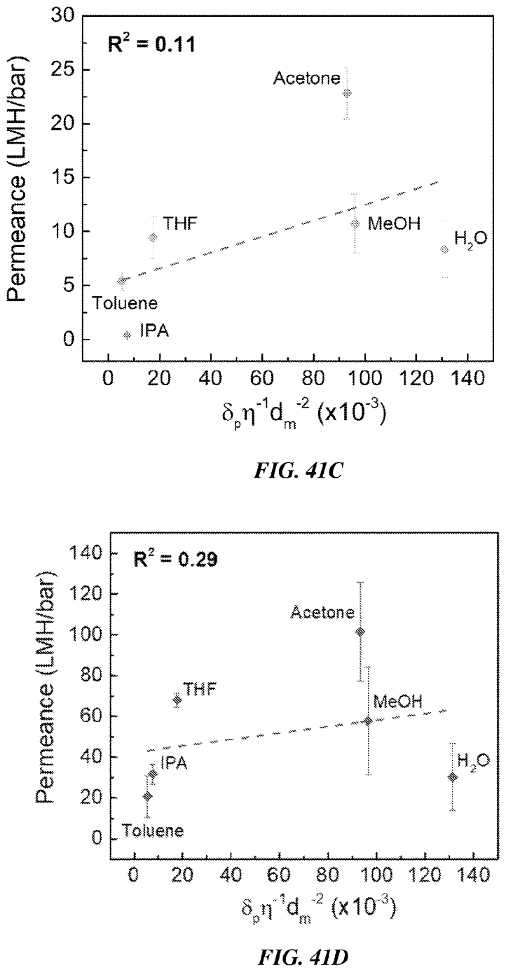

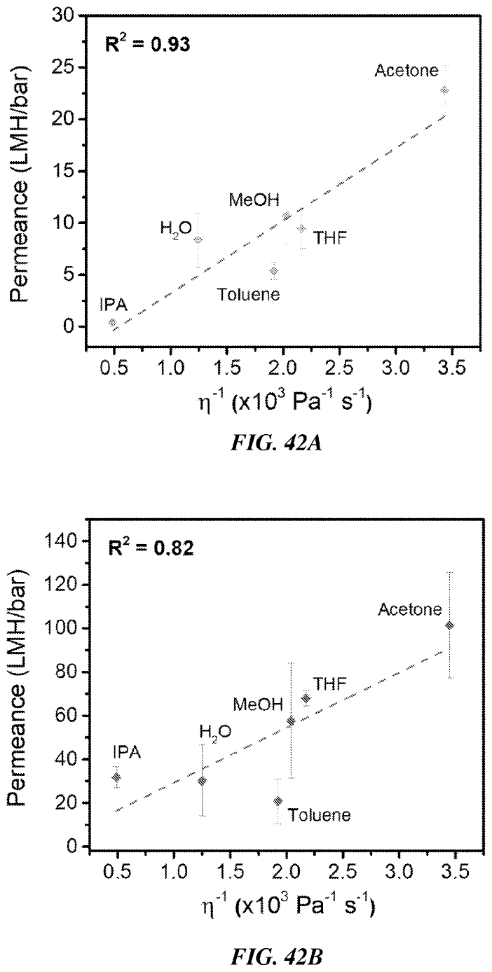

Permeation tests were performed for the prepared TFC membranes using six different solvents that have a range of viscosity, solubility parameters, and molar diameters (see FIG. 40). Introducing PIM units in either the aqueous or organic phases significantly improved the solvent permeance of the polyamide TFC membranes, whose effect was most pronounced when both PIM units were used (i.e., TBD-SBF; see FIG. 16F). The combined parameters of viscosity (η), molar diameter (dₘ), and solubility parameter (δₚ) were previously proposed to empirically explain the solvent permeance in polyamide TFC membranes. This approach presents a good correlation for the conventional chemistry (i.e., MPD-TMC) while failing to predict the permeance of TFC membranes containing PIM units, especially for TBD ones (see FIGS. 41A-41D). A better correlation was observed for TBD-TMC and TBD-SBF when fitted with the inverse viscosity of solvents (see FIGS. 42A-42B). This hints that sorption or diffusion behaviors through the membranes may rely on the monomers constituting the polyamides. Interestingly, the permeance enhancement relative to MPD-TMC (P_{TFC}/P_{MPD-TMC}) correlated very well with molar diameters of solvents. For example, a ~220 times enhancement in toluene permeance was found for TBD-SBF (0.09 to 20.8 L m⁻² h⁻¹ bar⁻¹ (LMH/bar); see FIG. 16F). This behavior supports that a diffusion-driven solvent transport mechanism is dominant in the TFC membranes containing PIM units, resulting from their enhanced free volume/microporosity.

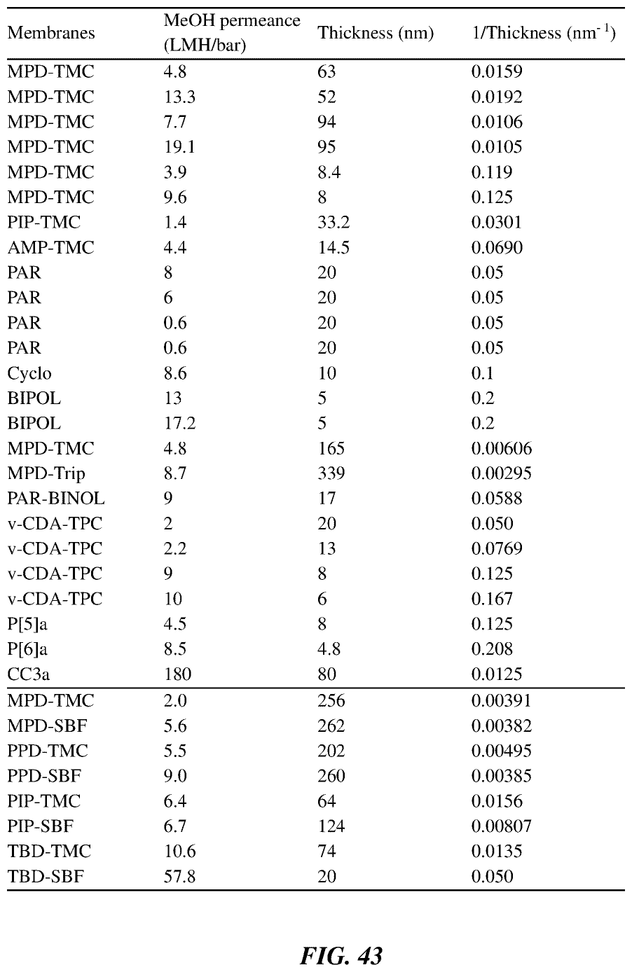

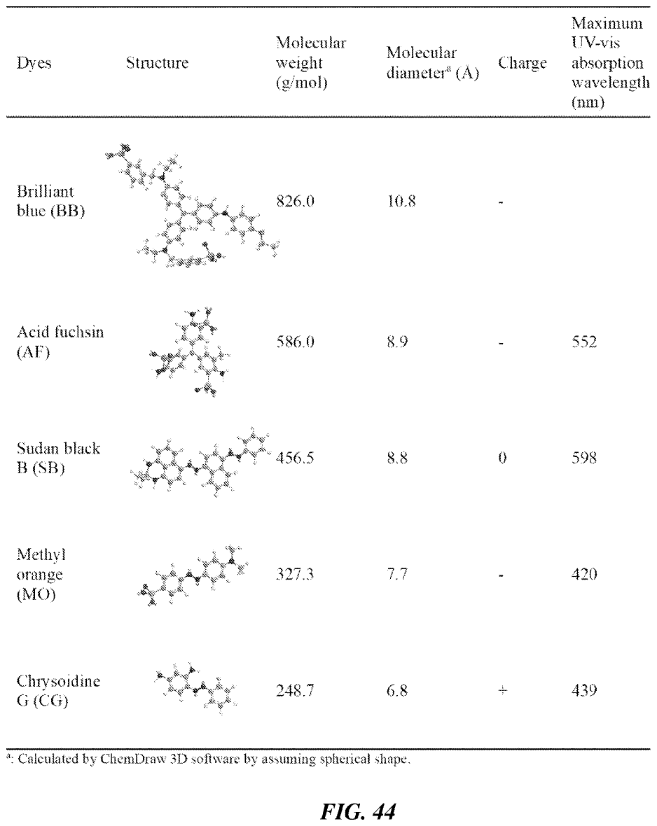

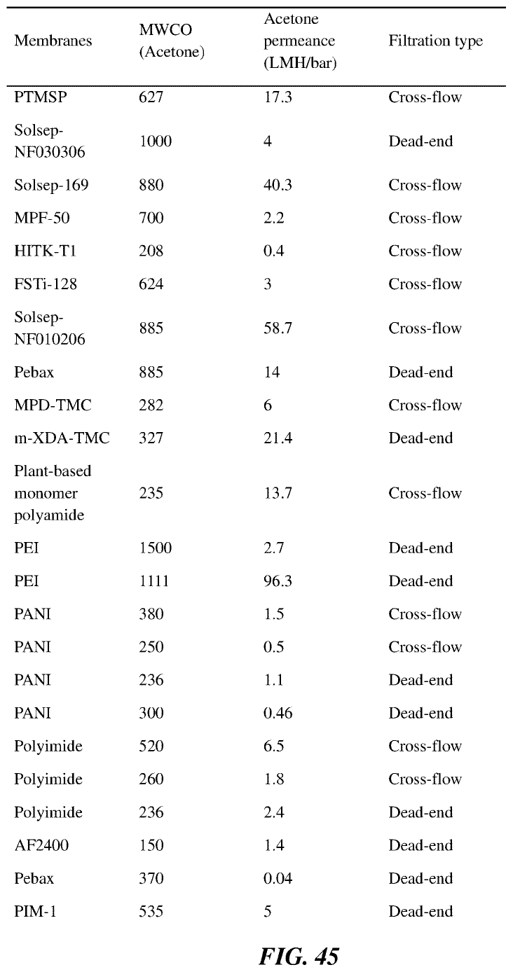

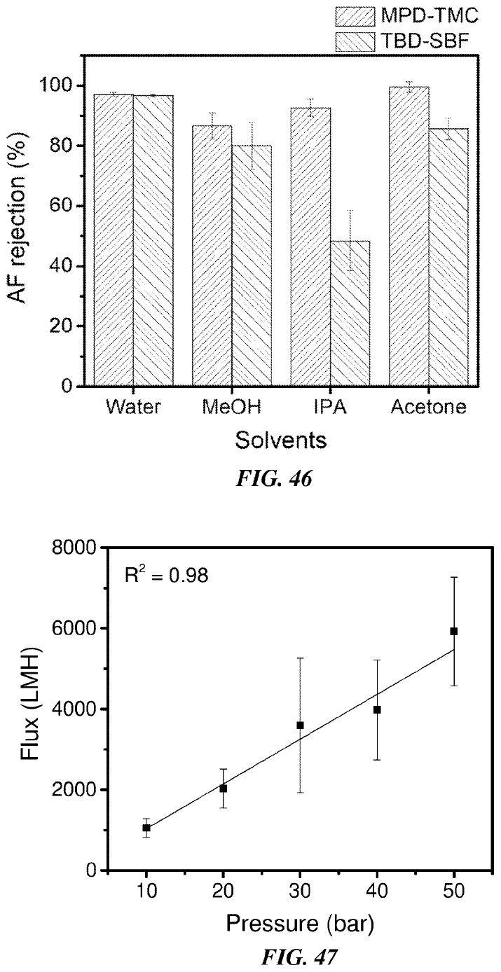

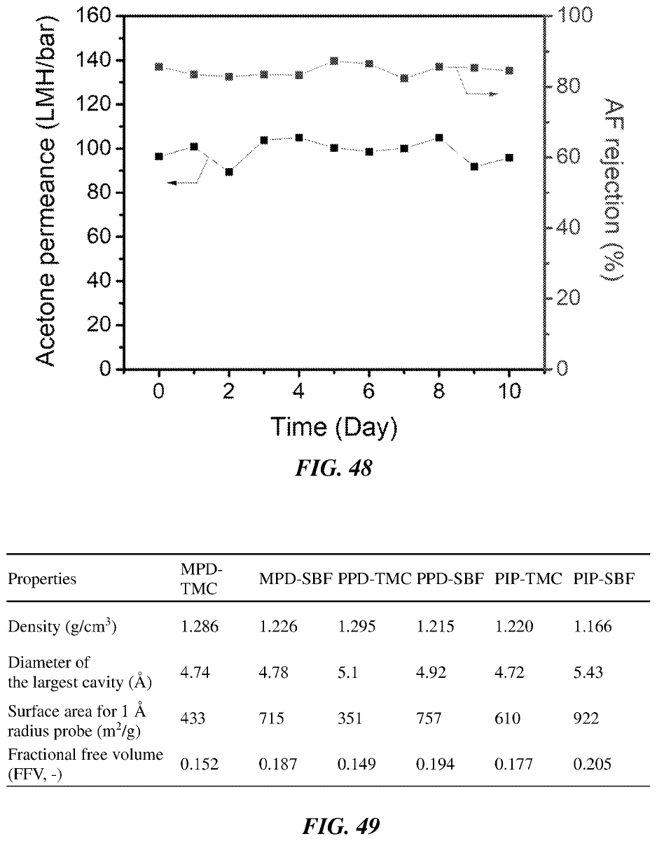

Ultimately, the methanol permeance of TBD-SBF (57.8 LMH/bar) markedly surpasses that of the reported TFC membranes consisting of a thinner selective layer (<20 nm) prepared by interfacial polymerization (see FIGS. 16G and 43), which highlights the impact of the extremely high microporosity of TBD-SBF in ultrafast molecular transport. Rejection profiles of the TFC membranes follow the molecular weight of solutes regardless of their charge, which indicates that solute rejection is mainly governed by molecular sieving (see FIG. 12B). Taken together with the rejection data, TBD-SBF membrane outperforms reported polymeric membranes by showing a moderate MWCO of ~640 g mol⁻¹ and extremely high acetone permeance of 101 LMH/bar (see FIG. 13). The TBD-SBF membrane also featured tunable solute rejection in different solvents, pressure stability up to 50 bar, and long-term stability for a 10-day continuous test (see FIGS. 46-48). Besides, the TBD-SBF membrane showed a capability to precisely separate binary solute mixtures with distinct molecular weights slightly below and above its MWCO (see FIG. 16H). Therefore, in addition to having increased microporosity, these samples have a tight micropore size distribution, highlighting the benefit for applying this strategy for molecular separations.

### Enhanced Hydrocarbon Separations by Isomeric Effects

The above results highlight that rational matching of monomer pairs in the dual phase is crucial to improve both the microporosity and the separation performances of the resultant polyamides. This inspired the further investigation of the effects of monomer geometry in microporous polyamides as the second approach. MPD, PPD, and PIP are the diamine monomers that have been investigated to tune the desalination performance of the polyamide membranes. In addition to these diamines, for the organic phase monomer, SBF was fixed as the micropore-generating unit while TMC was used as a control.

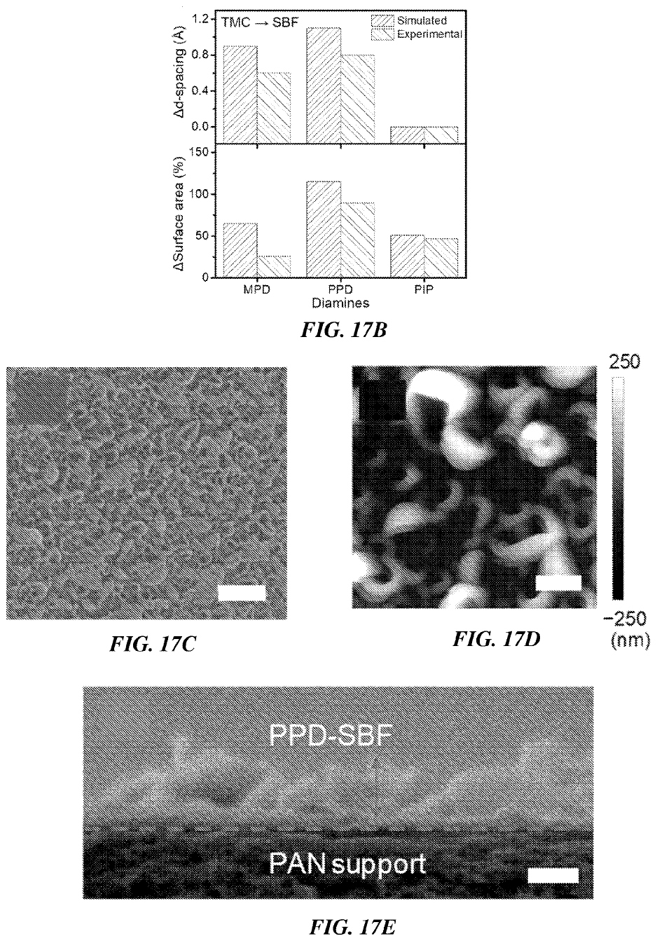

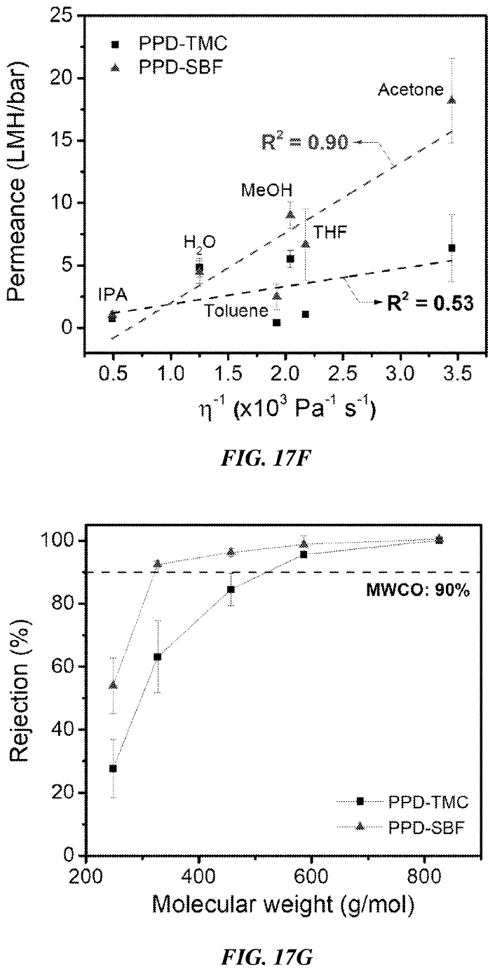

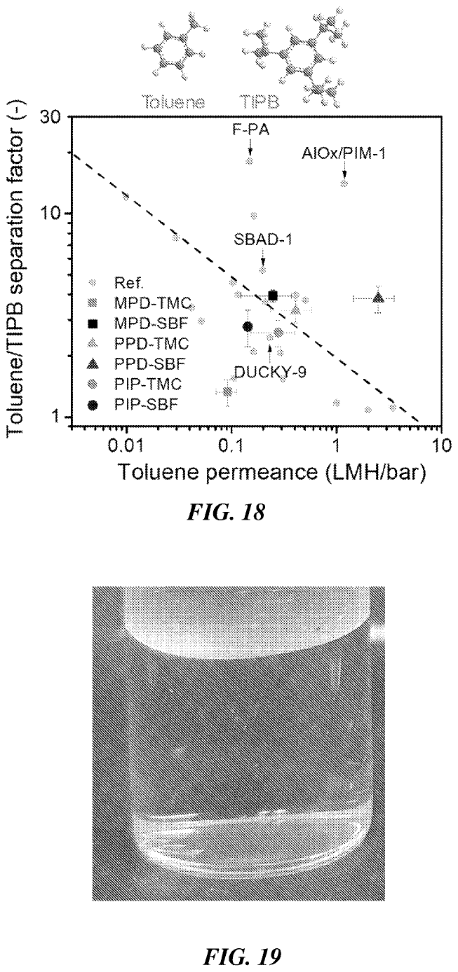

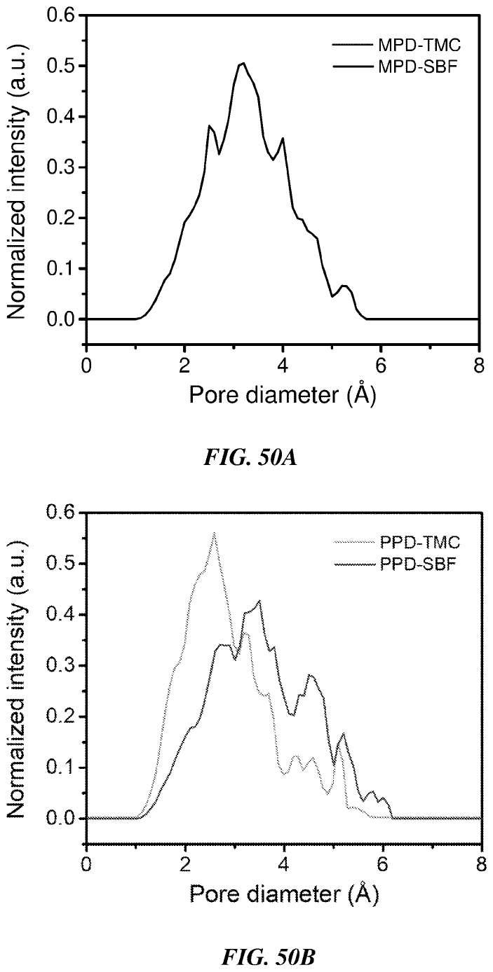

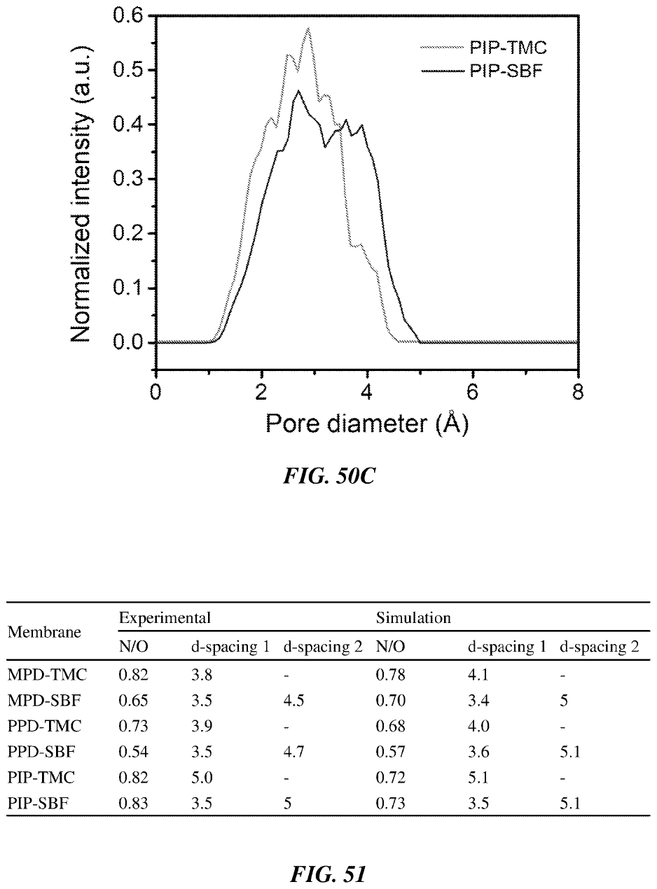

The structural properties of TMC-based polyamides were simulated first, and results followed a similar trend to findings previously reported; namely, fractional free volume (FFV) decreased in the following order: PIP-TMC (0.177)>MPD-TMC (0.152)>PPD-TMC (0.149) (see FIG. 49). Notably, all SBF-based polyamides exhibited significantly increased FFV and surface area compared to the TMC-based controls (cf., see FIGS. 15A and 17A). For example, by replacing the organic phase monomer from TMC to SBF, the FFV increased in each polyamide in the order of PPD (30%)>MPD (23%)>PIP (16%). Simulated pore size distributions (see FIGS. 50A-50C) support these findings.

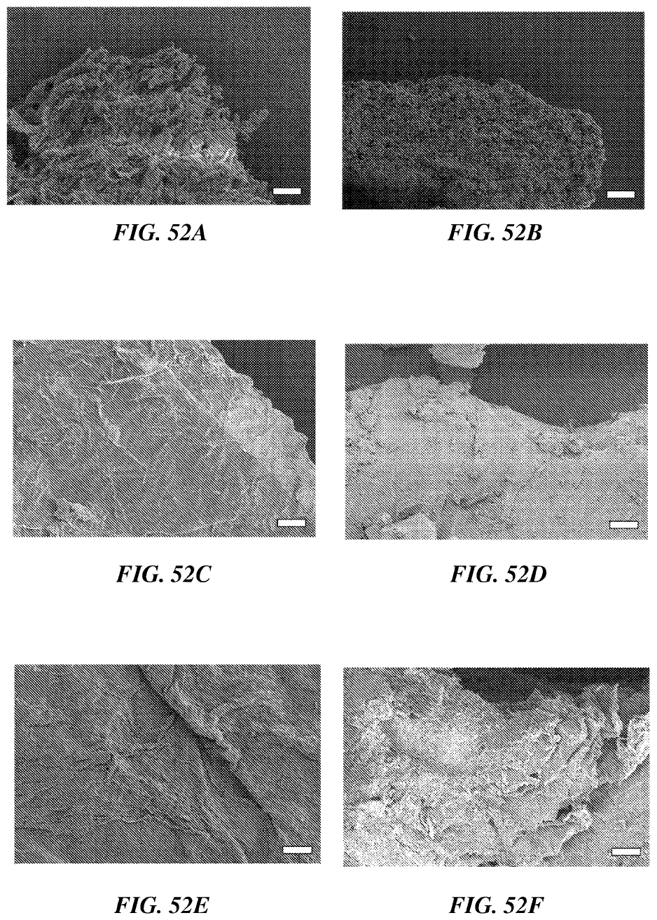

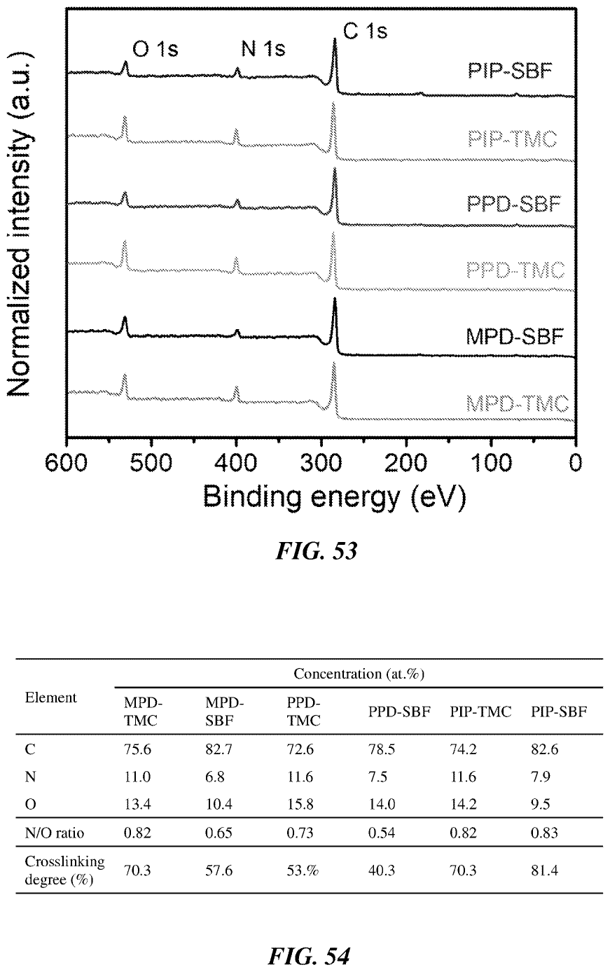

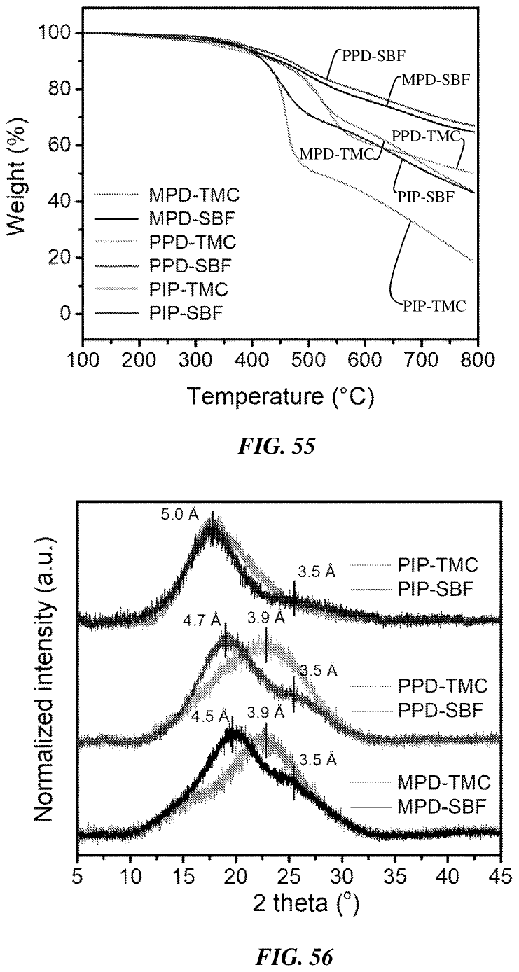

TMC and SBF-based polyamide powders were prepared for bulk characterizations (see FIGS. 52A-52F, 53, and 55). The average d-spacing determined from XRD analyses (see FIG. 56) revealed that the increase in pore size from TMC-based to SBF-based polyamides agrees with the calculated FFVs by simulations (i.e., PPD>MPD>PIP; see FIG. 17B). For MPD and PPD-based polyamides, the observations above are attributed to the isomeric effect of diamine monomers coupled with the pore-generating effect of the SBF unit. In general, meta-linked polymers have less rotational mobility in polymer backbone than para-linked ones due to higher packing efficiency. That is, PPD is more prone to facilitating the pore generation by the SBF unit than by MPD, resulting in the highest boost in porosity and pore size in PPD-SBF compared with the others. The same metalpara effect has also been observed in other microporous materials such as thermally rearranged (TR) polymers. On the other hand, the FFV of PIP-TMC is already high relative to MPD-TMC and PPD-TMC, so the effect of both para-linkage and SBF unit in PIP-SBF only led to minimal enhancement.

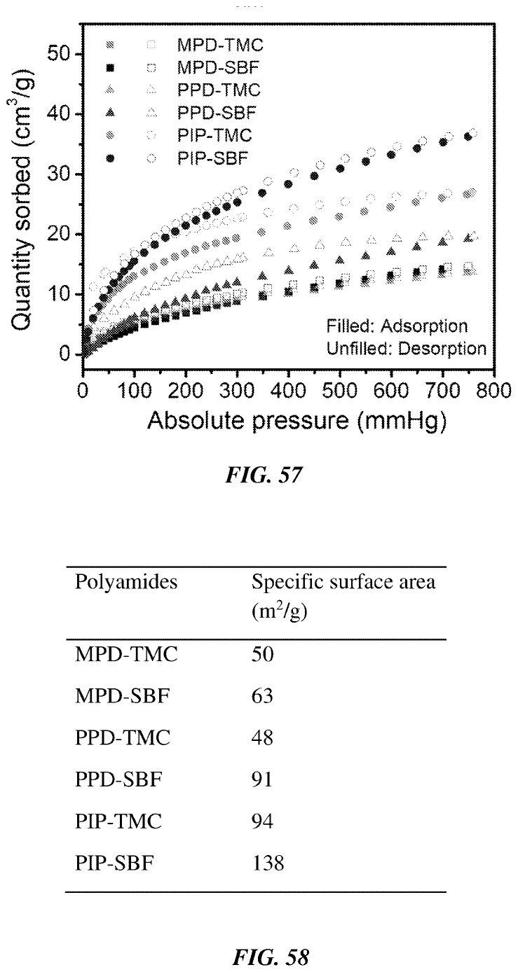

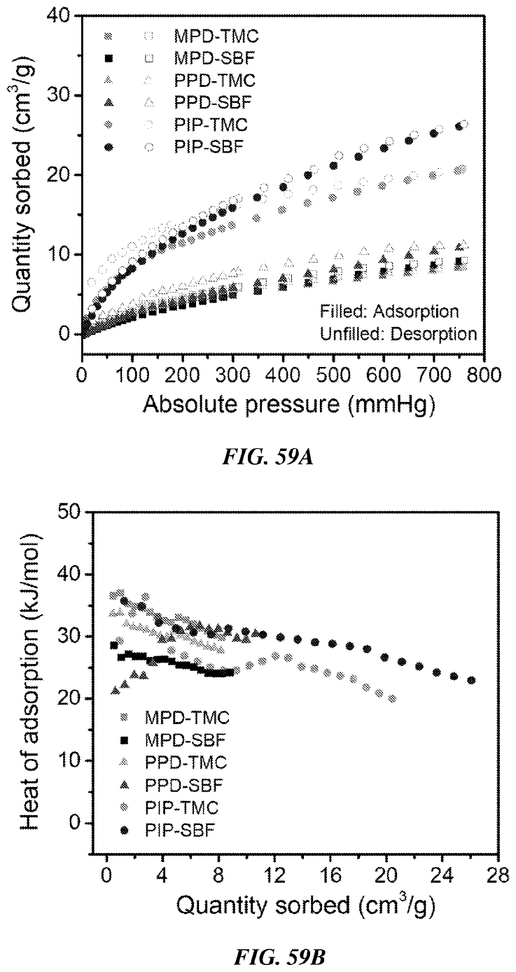

In addition, SBF-based polyamides exhibited a remarkably improved CO₂ sorption capacity compared to TMC-based counterparts while no significant variation in the isosteric heat of adsorption was observed (see FIGS. 57-59B). In accordance with the simulated results in microporosity and the experimental XRD analyses, PPD-SBF showed a 90% improvement in surface area (from 48 to 91 m² g⁻¹) when compared with its TMC counterpart, which is much higher than the increases in surface area of MPD-SBF (26%) and PIP-SBF (47%) (see FIG. 17B).

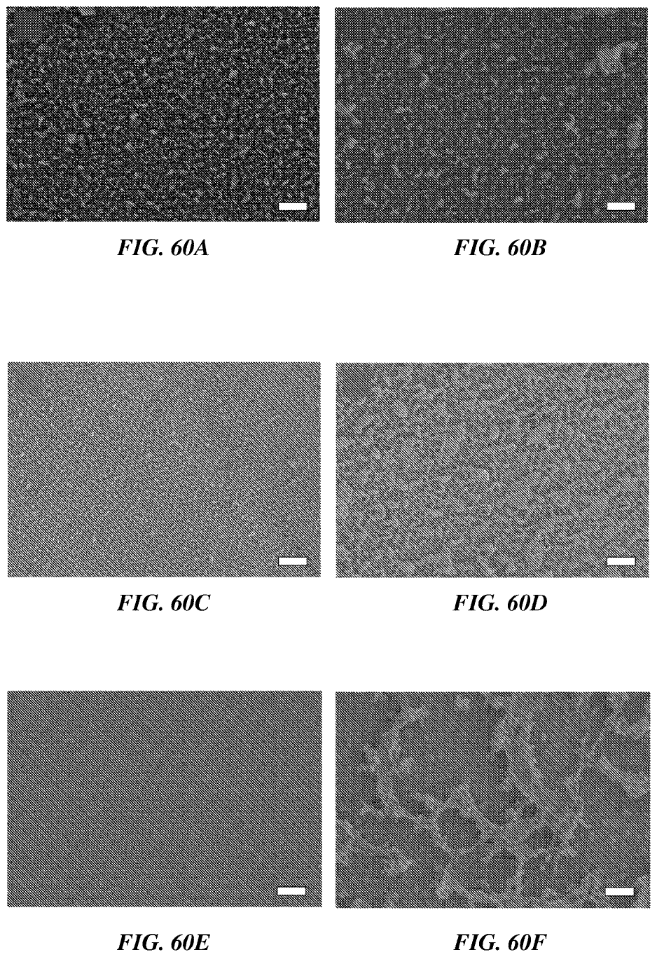

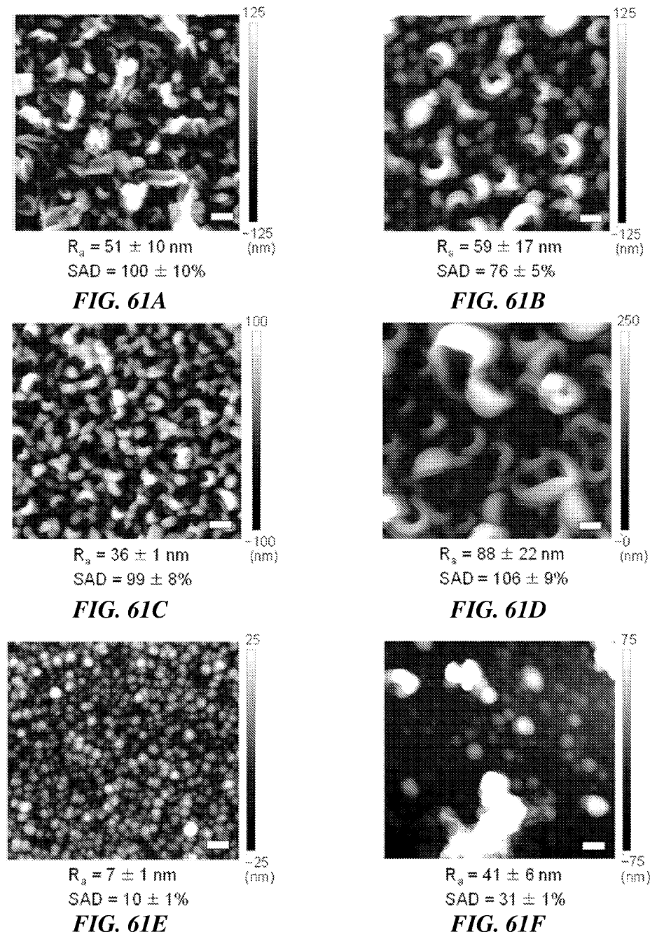

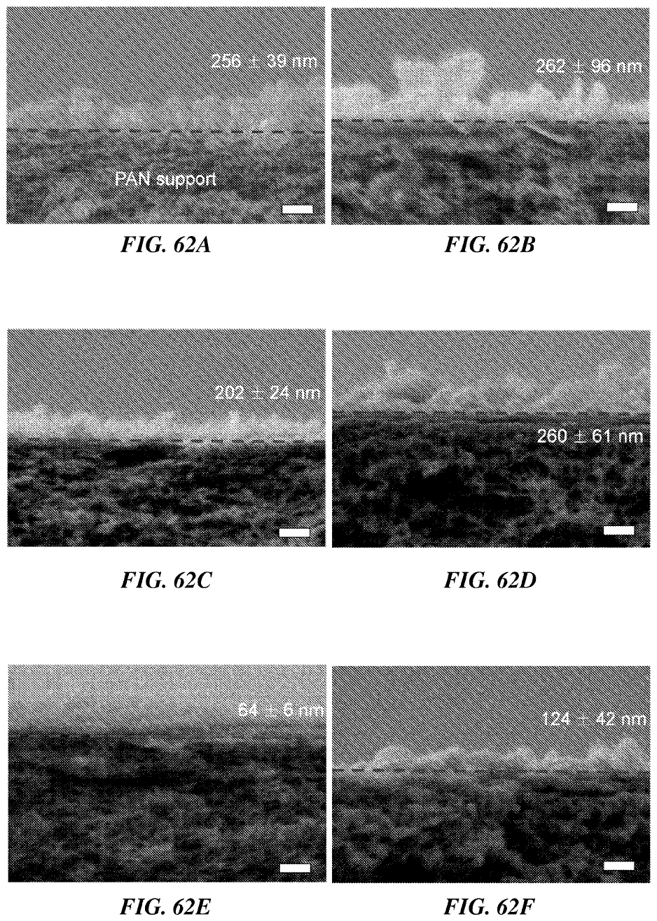

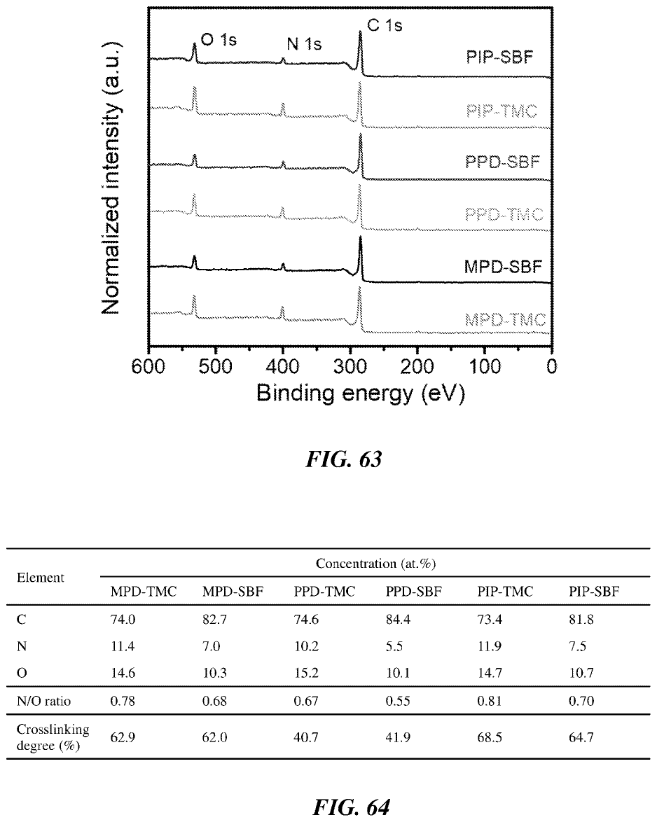

SEM and AFM images confirmed the successful fabrication of polyamide TFC membranes by interfacial polymerization between the chosen diamine and acyl chloride monomers onto porous PAN support (see FIGS. 17C-17E and 60A-62F). SBF-based TFC membranes possess a rougher surface morphology compared to TMC-based ones, which is ascribed to the higher miscibility of SBF-toluene with water than that of TMC-hexane. Substituting the organic phase monomer from TMC to SBF led to only a subtle change in the crosslinking degree of the TFC membranes, as calculated from XPS elemental analysis (see FIG. 64). It is believed that the different reaction conditions used for TMC-based and SBF-based polyamides such as different reaction times and solvents resulted in leveraging the reaction kinetics in interfacial polymerization which is largely affected by monomer diffusivity, reaction time, and solvent miscibility.

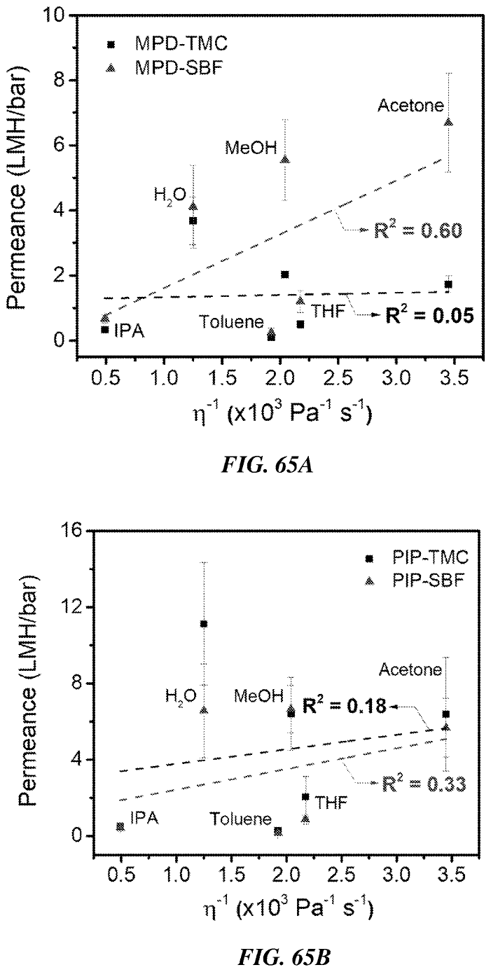

For all solvents, a significant increase in permeance was observed for MPD-SBF and PPD-SBF membranes compared to the TMC counterparts (see FIGS. 17F and 65A-65B). For example, PPD-SBF exhibited a 184% increase in acetone permeance relative to PPD-TMC, having a permeance of 18.2 L m⁻² h⁻¹ bar⁻¹ (LMH/bar). Considering that the thickness and crosslinking degree are almost identical for each MPD- and PPD-based polyamide pair, the increase in solvent permeance in TFC membranes containing the SBF unit is mainly attributed to the enhanced microporosity induced by the SBF unit. The improved correlation coefficients (R²) between permeance and reciprocal viscosity for SBF-based polyamides also imply that the solvent transport through the micropores is more pronounced in these TFC membranes. One exception for the permeance enhancement effect was observed in the PIP pair. This finding is likely attributed to the thicker polyamide layer of PIP-SBF (124 nm) compared to that of PIP-TMC (64 nm).

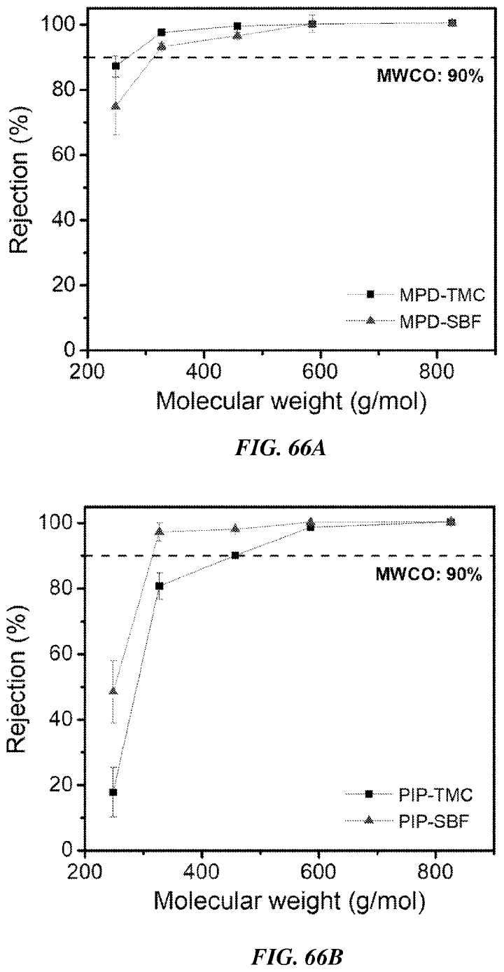

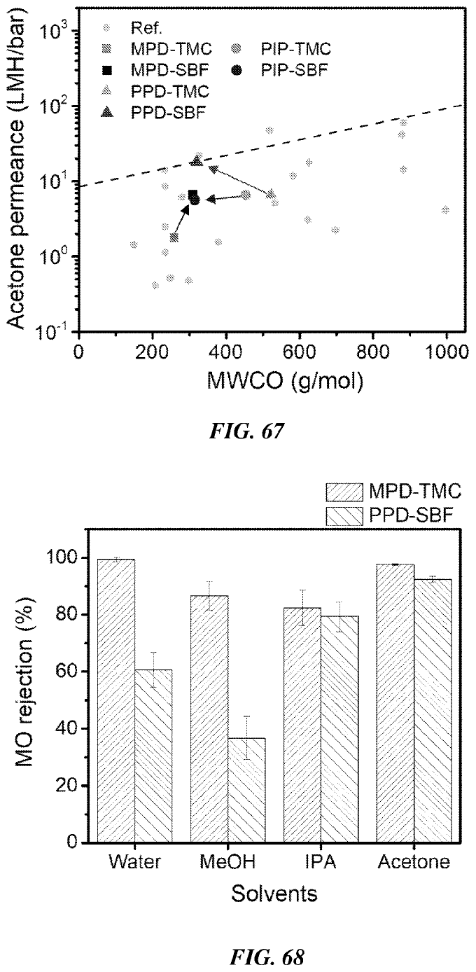

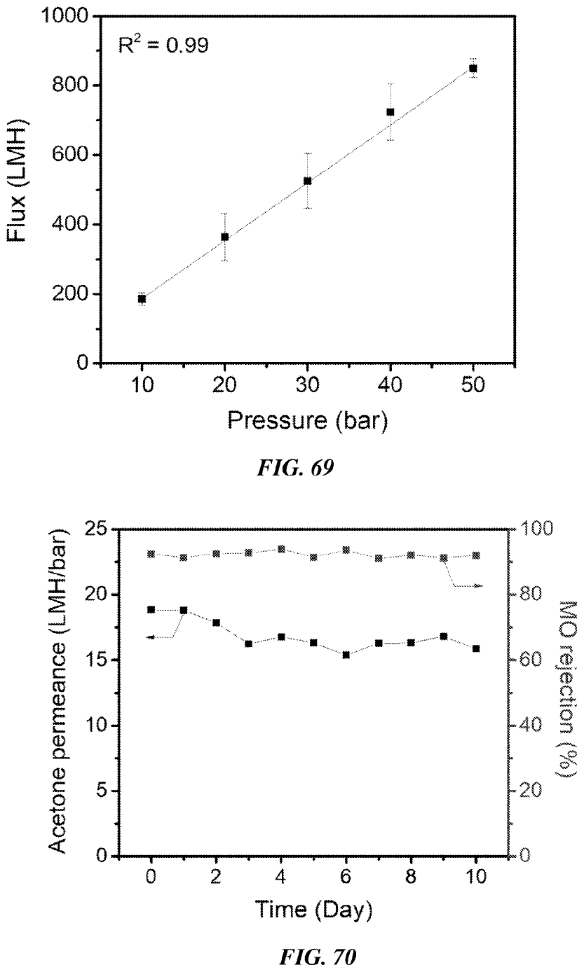

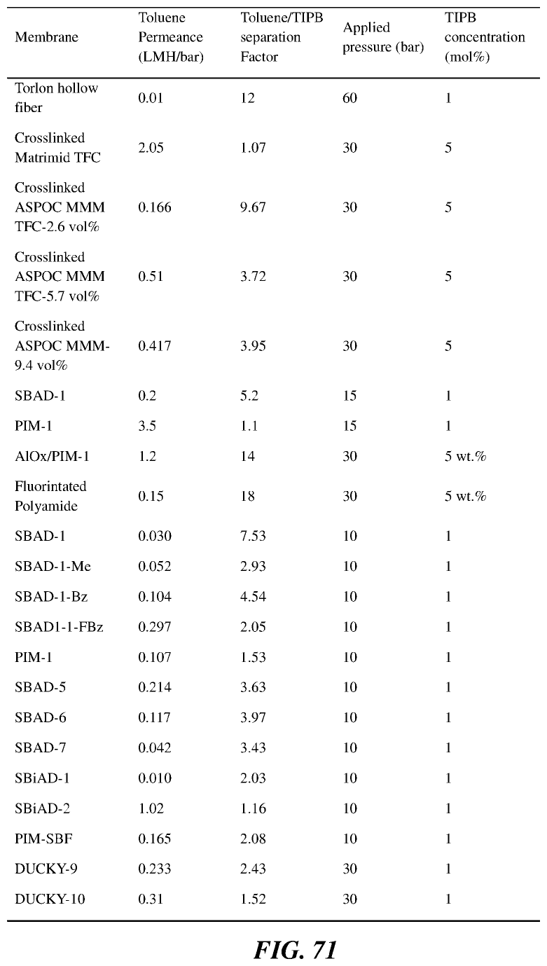

Even with these improvements in permeance, PPD-SBF and PIP-SBF exhibited a concomitant improvement in rejection for all solutes compared to the TMC counterparts (see FIGS. 17G and 66A-66B), which can be explained by the enhanced chain packing in SBF-based polyamides by π-π stacking, while an opposite trend was observed for MPD-SBF. MPD-TMC possesses the densest structure among the prepared polyamides, and thus the enlarged pore size by the SBF unit may have compromised the π-π stacking effect, resulting in a reduced rejection in MPD-SBF. To summarize, the SBF-based molecular design allowed for the tuning of the OSN performance of TFC membranes with conventional polyamide chemistry (see FIG. 67) together with excellent solvent, pressure, and long-term stabilities (see FIGS. 68-70).

Hydrocarbon separations by OSRO is one potential application of the membranes within a relatively low MWCO range (<400 g mol⁻¹). The OSRO performance of the polyamide TFC membranes was evaluated using toluene (kinetic diameter, dₖ=5.9 Å) and 1,3,5-triisopropylbenzene (TIPB, dₖ=9.0 Å) mixture as probe molecules. All SBF-based polyamides displayed a higher toluene/TIPB separation factor than that of TMC-based ones. This emphasizes the role of the SBF unit in regulating the pore size and porosity at the nanoscale for OSRO applications, which is consistent with the findings reported for SBAD-1 polymer. Moreover, PPD-SBF membrane remarkably surpasses the experimental OSRO upper bound for toluene/TIPB separation by showing a significant boost (500%) in toluene permeance (2.5 LMH/bar) compared to that of PPD-TMC. This finding agrees with the most pronounced increase in FFV and surface area for PPD-SBF among the SBF-based polyamides. Note that the unexpectedly low separation factor (1.3) of MPD-TMC is perhaps due to its excessively dense structure which may not allow the permeation of both species as evidenced by the low toluene permeance (0.09 LMH/bar). Overall, the results demonstrate that the solvent separation abilities of the interfacially polymerized membranes could be substantially improved by integrating the isomeric effects and the micropore-generating unit in dual phase.

### DISCUSSION

The development of TFC membranes by interfacial polymerization has revolutionized the water purification industry, whereas extending the same concept to organic solvents is still challenging. This work has demonstrated a dual-phase molecular engineering approach by using TBD and SBF chemistries to develop advanced microporous polymer membranes through interfacial polymerization. As the first approach, the dual-phase microporous polyamide (i.e., TBD-SBF) showed an unparalleled surface area among the interfacially polymerized TFC membranes reported to date. Also, the exceptionally high solvent permeance of the resultant TBD-SBF membrane showcases the promising potential of the strategy to combine multiple PIM units by interfacial polymerization for ultrafast molecular separations. Moreover, both experimental and simulation studies confirm that fine-tuning the microporosity in polyamide nanofilms is achievable by integrating the SBF unit and the isomer effects in conventional chemistry, which significantly improves the separation performances of the polyamide TFC membranes for OSRO applications. It is believed the proposed approaches to tune the microporosity in scalable TFC membranes will contribute to other fields that demand fast and selective separations of small molecules, such as desalination, gas separation, redox flow batteries, and crude oil fractionation.

### Methods

Materials: m-Phenylenediamine (MPD, 99%), p-phenylenediamine (PPD, 98%), piperazine (PIP, 99%), trimesoyl chloride (TMC, 98%), 2-methyl-3-nitroaniline (2M3N, 97%), trifluoroacetic acid (TFA, 99%), palladium on carbon (Pd/C, 10 wt. % loading), hydrazine monohydrate (N₂H₄·H₂O, 98%), acetone (99.5%), ethanol (99.5%), methanol (MeOH, 99.8%), tetrahydrofuran (THF, 99%), isopropyl alcohol (IPA, 99.5%), toluene (99.9%), 1,3,5-triisopropylbenzene (TIPB, 95%), hexane (99%), ethyl acetate (99.5%), petroleum ether, dimethylformamide (DMF, 99.8%), paraformaldehyde (95%), sodium hydroxide (NaOH, 98%), hydrochloric acid (HCl, 37%), copper (I) cyanide (CuCN, 99%), magnesium sulfate (MgSO₄, 99.5%), potassium hydroxide (KOH, 90%), and thionyl chloride (SOCl₂, 99%) were purchased from Sigma Aldrich (USA). Dyes and solvents used for filtration tests were also purchased from Sigma Aldrich. 2,2′,7,7′-Tetrabromo-9,9′-spirobi[9H-fluorene] (SBF-Br, 98%) was purchased from TCI America (USA). Polyacrylonitrile (PAN) membranes with a molecular weight cut-off (MWCO) of 10 kDa (product number: 010104) were purchased from Solsep BV (Netherlands). Deionized (DI) water was obtained from a Milli-Q water purification system (Millipore, USA).

Synthesis of SBF and TBD monomers: Spirobifluorene (SBF) monomer functionalized with acyl chloride (SBF-COCl) was synthesized by modification of a previous study. Detailed reaction schemes and conditions are shown in FIG. 7 and described below. Tröger's base diamine (TBD) monomer was synthesized by a reported procedure. Detailed reaction schemes and conditions are shown in FIG. 6 and described below.

Preparation of polyamide powders: For TMC-based polyamide powders, 1 w/v % of aqueous solution (100 ml) containing each diamine monomer (MPD, PPD, PIP, and TBD; pH was controlled to be 2.2-2.4 for TBD) and 0.1 w/v % of TMC solution (300 ml in hexane) were prepared separately and poured into a beaker to initiate the polycondensation reaction. The mixture was vigorously stirred with a magnetic bar at 300 rpm for 30 minutes. After the reaction, the polymer was filtered and washed with 500 ml of toluene, ethanol, and water three times, respectively. The powder was collected and dried in a vacuum oven at 120° C. for 24 hours. For SBF-based polyamide powders, the procedure was the same except that the organic phase solvent was replaced from hexane to toluene to prepare the SBF solution which was filtered through a 5 micrometer syringe.

Preparation of thin-film composite (TFC) membranes: TMC-based polyamide TFC membranes were prepared by in situ interfacial polymerization on a porous PAN support. Briefly, a 5×5 cm²-sized PAN support was immersed in IPA for 1 minute and washed with DI water. The pretreated PAN support was fixed on a glass plate with a Teflon frame and aqueous solution containing each diamine monomer (MPD (2 w/v %), PPD (1 w/v %), PIP (1 w/v %), and TBD (2 w/v %); pH was controlled to be 2.2-2.4 for TBD) was poured onto the support. After 2 minutes, the diamine solution was removed and the residual water droplets were removed using a rubber roller. Subsequently, 0.1 w/v % of TMC solution was poured onto the diamine-soaked PAN support, and the reaction proceeded for 1 minute at room temperature. After the reaction, the excess TMC solution was washed with hexane. The prepared TFC membranes were subsequently washed with DI water several times and stored in an IPA bath before permeation tests. For SBF-based polyamide TFC membranes, the procedure was the same except that the organic phase solvent was replaced from hexane to toluene to prepare the SBF solution which was filtered through a 5 micrometer syringe, and a longer reaction time (5 minutes) was used to ensure defect-free membranes.

Characterization: A scanning electron microscope (SEM, Zeiss Merlin High-resolution SEM, Zeiss, Germany) and an atomic force microscope (AFM, Dimension Icon AFM, Bruker, USA) were used to observe the morphologies of polyamide powders and membranes. Fourier transform infrared (FT-IR) spectra were obtained using an Alpha spectrometer (Bruker, USA). ¹H and ¹³C nuclear magnetic resonance (NMR) spectra were acquired using a 400 MHz Avance III HD spectrometer (Bruker, USA). The elemental compositions of samples were investigated using an X-ray photoelectron spectroscopy instrument (PHI VersaProbe II X-ray Photoelectron Spectrometer, Physical Electronics, USA). The crystalline structure of polyamide powders was explored using an X-ray diffractometer (XRD, SmartLab, Rigaku, Japan) with focused monochromatized Cu Kα radiation (λ=1.5406 Å) at a scan rate of 5°/minute. The thermal stability of polyamide powders was examined using a thermal gravimetric analyzer (TGA, TGA550, TA Instruments, USA) under continuous flow of N₂. The surface area and isosteric heat of adsorption of polyamide powders were evaluated by CO₂ sorption isotherms at 273 and 298 K using a physisorption analyzer (3Flex, Micromeritics, USA). Langmuir surface area was calculated based on the absolute pressure range of 50-300 mmHg as the default option provided by software (Flex Version 6.01). Samples were degassed at 120° C. for 12 h before the sorption measurements.

Molecular simulation: The molecular simulations conducted herein utilized all-atomistic methods. Detailed methodology can be found below.

Permeation tests: Solvent permeance (J, LMH/bar=L m⁻² h⁻¹ bar⁻¹) of the membranes was evaluated by a dead-end filtration cell (HP4750 Stirred Cell, Sterlitech Corporation, USA) at room temperature (~23° C.) as follows:

$$J = \frac{Δ V}{A Δ tp}$$

where ΔV is the permeated volume at a given time (Δt) and A is the effective membrane area (4.9 cm²). An applied pressure (p) of 20 bar was used unless specified.

Solute rejection was determined by permeating a dye solution (20 mg/L) through the membranes. Brilliant blue (BB, 826 g/mol), acid fuchsin (AF, 586 g/mol), sudan black B (SB, 457 g/mol), methyl orange (MO, 327 g/mol), and chrysoidine G (CG, 249 g/mol) were used as solutes. Dye concentration in the feed (C_{f}) and permeate (Cₚ) was measured using a UV-vis spectrometer (Cary 60, Agilent Technologies, USA) and the rejection (R) was calculated as follows:

$$R = ( 1 - \frac{{C}_{p}}{{C}_{f}} ) \times 100 ( \% )$$

The separation factor of toluene/1,3,5-triisopropylbenzene (TIPB) mixture (S_{Toluene/TIPB}) was determined by measuring the TIPB concentrations in the feed (C_{TIPB,f}) and permeate (C_{TIPB,p}) using gas chromatography equipped with a mass spectrometer detector (GC/MS, Agilent 7890B/Agilent 5997B, Agilent Technologies, USA) from the permeation tests with a feed solution containing 2 mol % of TIPB in toluene, as follows:

$${S}_{\frac{Toluene}{TIPB}} = \frac{( \frac{{C}_{Toluene , p}}{{C}_{TIPB , p}} )}{( \frac{{C}_{Toluene , f}}{{C}_{TIPB , f}} )}$$

### Synthesis of Tröger's Base Diamine (TBD) Monomer:

(1) Synthesis of Tröger's base containing nitro groups (TBN): In an ice bath, a solution was prepared by dissolving 12 g of 2-methyl-3-nitroaniline (referred to as 2M3N) and 4.98 g of paraformaldehyde in 150 mL of trifluoroacetic acid (TFA), resulting in a dark-brown colored mixture. This mixture was stirred for a duration of 48 hours under a nitrogen atmosphere at room temperature. Subsequently, it was poured into 200 mL of pure water with continuous stirring, leading to the formation of a yellow precipitate. To adjust the pH to a range of 8.5 to 9.0, approximately 340 mL of 6 M sodium hydroxide (NaOH) was gradually added to the suspension. The precipitate was separated by filtration and then subjected to reflux in 300 mL of acetone for 1 hour. After cooling and storing the mixture at −20° C. overnight, a yellow product was obtained by filtration. Finally, the TBN powder was collected by filtration and dried in a vacuum oven at 50° C. for 24 hours.
(2) Synthesis of Tröger's base diamine (TBD): In a nitrogen atmosphere, 5 g of TBDN was dispersed in 100 mL of ethanol. This mixture was then combined with 0.5 g of Pd/C (10 wt. % Pd) and heated to the point of reflux. Subsequently, 10 mL of N₂H₄H₂O was added drop by drop to the hot solution. After maintaining reflux conditions for 8 hours, the resulting solid was separated via filtration. The solution obtained was then concentrated to half of its original volume under reduced pressure at 40° C. The product was obtained by introducing 100 ml of water and recovering it through filtration. The product was dried under reduced pressure at 50° C., resulting in the formation of a white powder. Finally, the TBD powder was collected by filtration and dried in a vacuum oven at 50° C. for 24 hours.
   Synthesis of Spirobifluorene Monomer Functionalized with Acyl Chloride (SBF-COCl):
(1) Synthesis of 9,9′-spirobifluorene-2,2′,7,7′-tetracarbonitrile (SBF-CN): 2,2′,7,7′-Tetrabromo-9,9′-spirobi[9H-fluorene] (0.93 g) and CuCN (0.58 g) were dissolved in DMF (10 mL) and the mixture was heated to 145° C. for 18 hours under nitrogen purge.

After cooling, 0.2 M HCl (100 mL) was added to the reaction mixture. The diluted mixture was extracted with ethyl acetate (80 ml) and water (50 ml) three times. Anhydrous MgSO₄ was added to the extracted solution in ethyl acetate and the mixture was filtered to remove residual water. Ethyl acetate was removed from the mixture using a rotary evaporator until precipitates were observed. Finally, the solution was poured into a water/methanol (50/50 mL) mixture to precipitate SBF-CN. The SBF-CN powder was collected by filtration and dried in a vacuum oven at 50° C. for 24 hours.
(2) Synthesis of 9,9′-spirobifluorene-2,2′,7,7′-tetracarboxylic acid (SBF-COOH): 0.624 g of SBF-CN was dispersed in a water/ethanol (10/10 mL) mixed solvent. 1.74 g of KOH was added to this solution and the mixture was refluxed at 95° C. for 18 hours. After cooling, the mixture was filtrated to remove insoluble solids. Subsequently, 6 M HCl was added to the solution to adjust the pH to 1-2, and a large quantity of white precipitate was formed. The SBF-COOH powder was collected by filtration and dried in a vacuum oven at 50° C. for 24 hours.
(3) Synthesis of 9,9′-spirobifluorene-2,2′,7,7′-tetracarbonyl chloride (SBF-COCl): 0.35 g of SBF-COOH was dispersed in 2.5 mL of SOCl₂ and 3 drops of DMF was added to the mixture. The solution was stirred for 2 holurs at 60° C. After cooling, the solution was precipitated in petroleum ether. The SBF-COCl powder was collected by filtration and dried in a vacuum oven at 50° C. for 24 hours.

Molecular simulation methodology: The molecular simulations conducted herein utilized all-atomistic methods. Generalized Amber force field (GAFF) was employed in the modeling of the polymers, along with the utilization of partial charges obtained through Density Functional Theory (DFT) calculations. The DFT calculations were carried out using Gaussian software, employing the B3LYP functional with a 6-31G(d,p) basis set.

The polymerization for the polyamides was executed using the LAMMPS software, with initial structures generated by Materials Studio (BIOVIA, 2021). Initial simulation cells containing repeat units were generated without any excess concentrations, keeping the reactive sites unsaturated. A bonding scheme was applied, bonding two reactive sites together when they were within a distance of 3 Å. To allow for a gradual equilibration of the newly formed bonds, a timestep of 0.1 fs was employed during the polymerization simulations. The duration of the polymerization simulation was adjusted to achieve a chemical composition for the crosslinked polyamide that matched the compositions reported in x-ray photoelectron spectroscopy (XPS) analysis, after removing the unreacted monomers and saturation of unreacted sites with OH and H. Once the crosslinked polyamides were obtained, a 21-step compression-relaxation procedure was applied to obtain equilibrated polyamide structures. The equilibrated structures underwent structural analysis using Zeo++ software, and 3D images and iso-surface representations were generated using iRaspa software. Hydrogen bonding analysis was performed in VMD software.

Degree of torsional freedoms were acquired from 5 ns NPT-MD runs of equilibrated structures using the LAMMPS software. Torsional angles were recorded during the simulations and the range of possible angle degrees of each torsion contributed to the total degree of torsional freedom accordingly.

Calculation of crosslinking degree of polyamides: Based on the proposed molecular structures in FIGS. 22A-22D, the crosslinking degree (m) of polyamide powders or TFCs was calculated by the atomic ratio of nitrogen to oxygen (N/O) from XPS elemental analyses as follows:

If n is the portion of linear polyamides:

$$m + n = 1$$

### For MPD-TMC, PPD-TMC, and PIP-TMC:

$$N / 0 = \frac{3 m + 2 n}{3 m + 4 n}$$

### For MPD-SBF, PPD-SBF, and PIP-SBF:

$$N / 0 = \frac{4 m + 2 n}{4 m + 6 n}$$

### For TBD-TMC:

$$N / 0 = \frac{5 m + 4 n}{3 m + 4 n}$$

### F or TBD-SBF:

$$\frac{N}{O} = \frac{6 m + 4 n}{4 m + 6 n}$$

The rationale behind the use of Langmuir surface area rather than BET surface area: Brunauer-Emmett-Teller (BET) theory is a common method to calculate the surface areas of microporous materials from the linearized BET equation to their adsorption isotherms at a specific temperature as follows:

$$\frac{P / {P}_{0}}{{V}_{a} ( 1 - P / {P}_{0} )} = \frac{C - 1}{{V}_{m} C} ( P / {P}_{0} ) + \frac{1}{{V}_{m} C}$$

where P and P₀ are the equilibrium and saturation pressure of the adsorbate, respectively, Vₐ is the amount of gas adsorbed, Vₘ is the amount of gas required to form a monolayer on the adsorbents, and C is the dimensionless BET constant.

The initial step in the procedure involves inputting the adsorption data into a graph displaying

$$\frac{P / {P}_{0}}{{V}_{a} ( 1 - P / {P}_{0} )} vs P / {P}_{0} .$$

Subsequently, a linear segment within this graph is displaying identified and subject to fitting. It is worth noting that multiple linear segments may be present, and selecting different segments can occasionally result in substantially different BET surface area values. Consequently, it becomes crucial to select the appropriate range. To address this issue, the BET consistency criteria have been proposed as follows:
(1) Pressure must be constrained within a range in which Vₐ(1−P/P₀) consistently shows an upward trend relative to the relative pressure.
(2) The relative pressure (P/P₀) at which the monolayer forms, calculated through the fitting process as

$$( \frac{1}{\sqrt{C + 1}} )$$

should fall within the specified range for relative pressure (P/P₀) range.
(3) The value of C, as determined from the fitting process, must be a positive number.

The above criteria have been supported by many studies using N₂ adsorption isotherms at 77 K. However, it was found that the second criterion could not be satisfied for CO₂ adsorption isotherms at 273 K since the relative pressure range is very small (less than 0.030) compared to that of N₂ adsorption isotherms at 77 K (up to 1.0). Hence, it was decided to calculate the surface area using the Micromeritics software based on the Langmuir theory since the determination of Langmuir surface area is much less constrained by such criteria.

In situ monitoring of the diffusion rate of diamine monomers from the aqueous phase to the organic phase: The concentrations of MPD and TBD monomers were first calibrated in hexane and toluene using UV-vis spectroscopy. After that, 2 wt. % of each diamine solution was placed in a UV cuvette while the volume of the diamine solution was adjusted to approximately 1 mm below the incidence UV beam. Once the organic solvent was injected, the UV spectra were measured by the elapsed time. A steeper slope for toluene was observed compared to that for hexane, which is attributed to the higher water miscibility of toluene than hexane. On the other hand, the slopes for TBD were lower than that for MPD in both hexane and toluene cases, which confirms the lower diffusion rate of the bulkier TBD molecules compared to MPD.

It should be understood that the subject matter defined in the appended claims is not necessarily limited to the specific implementations described above. The specific implementations described above are disclosed as examples only. While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A composition, comprising:
a polymer of intrinsic microporosity (PIM), wherein the PIM comprises a polyamide comprising:
a first moiety comprising a spiro group; and
a second moiety comprising a Tröger's base moiety.

2. The composition of claim 1, wherein the first moiety comprises a spirobifluorene moiety and/or a spirobisindane moiety.

3. The composition of claim 1, wherein the first moiety comprises at least one functional group crosslinked with a functional group of the second moiety.

4. The composition of claim 3, wherein the at least one functional group of the first moiety is an acyl group.

5. The composition of claim 3, wherein the functional group of the second moiety is an amine group.

6. The composition of claim 1, wherein the first moiety and the second moiety are crosslinked via an amide bond.

7. The composition of claim 1, wherein the first moiety comprises more than one functional group, and wherein each functional group of the first moiety is crosslinked with the functional group of a plurality of second moieties.

8. The composition of claim 1, wherein the first moiety comprises four functional groups, and wherein each functional group of the first moiety is crosslinked with the functional group of four second moieties.

9. The composition of claim 7, wherein the first moiety and each of the second moieties are crosslinked via an amide bond.

10. The composition of claim 1, wherein the PIM has a fractional free volume greater than or equal to 0.18.

11. The composition of claim 1, wherein the PIM has a fractional free volume greater than or equal to 0.2.

12. The composition of claim 1, wherein the PIM has a CO₂ sorption capacity greater than or equal to 25 cm³/g at an absolute pressure greater than or equal to 200 mmHg and less than or equal to 800 mmHg.

13. The composition of claim 1, wherein the CO₂ sorption capacity of the PIM is greater than or equal to 40 cm³/g at an absolute pressure greater than or equal to 450 mmHg and less than or equal to 800 mmHg.

14. The composition of claim 1, wherein the PIM has a surface area greater than or equal to 150 m²/g.

15. The composition of claim 1, wherein the PIM has a nitrogen (N) to oxygen (O) ratio greater than or equal to 0.5 and less than or equal to 1.

16. The composition of claim 1, wherein the PIM is prepared via interfacial polymerization of a first monomer and a second monomer.

17. The composition of claim 16, wherein the first monomer comprises at least one acyl halide group.

18. The composition of claim 16, wherein the first monomer is dissolved in an organic phase.

19. The composition of claim 16, wherein the second monomer comprises at least one amine group.

20. The composition of claim 16, wherein the second monomer is dissolved in an aqueous phase.

21-22. (canceled)

23. An article, comprising:
a membrane and/or filter comprising the composition of claim 1.

24-33. (canceled)

34. A method, comprising:
passing a mixture of species through a membrane and/or filter, wherein the membrane and/or filter comprises a polymer comprising a first moiety and a second moiety crosslinked via an amide bond, wherein the first moiety comprises a spiro group and the second moiety comprises a Tröger's base moiety; and
separating at least one species from the mixture of species.

35-64. (canceled)
